(19) United States
(12) Patent Application Publication
(10) Pub. No.: US 2024/0386211 A1
(43) Pub. Date: Nov. 21, 2024

(54) INFORMATION PROCESSING SYSTEM AND VIRTUAL HUMAN RESOURCE

(71) Applicant: pluszero, Inc., Tokyo (JP)

(72) Inventors: Yoshiyuki OJIRO, Tokyo (JP); Motoki NAGATA, Tokyo (JP)

(21) Appl. No.: 18/284,196

(22) PCT Filed: Oct. 11, 2021
(86) PCT No.: PCT/JP2021/037517

§ 371 Date: Aug. 7, 2024

(30) Foreign Application Priority Data
Mar. 29, 2021 (JP) 2021-055158

(51) Int. Cl. G06F 40/35

(52) U.S. Cl. CPC G06F 40/35

(57) ABSTRACT

There is provided a virtual human resource capable of executing communication with high mutual understanding or efficient PDCA. Data represented in a “semantically normalized format” or a format convertible thereto, the data including at least the personalization summarization logic, data represented in a “semantically normalized format” or a format convertible thereto, and data including at least a plurality of internal models PM is acquired, as dispatcher information, from among information to be provided from a dispatcher P. A virtual human resource O is produced using the dispatcher information. Thereby, the above problem can be solved.

### TECHNICAL FIELD

The present invention relates to an information processing system and a virtual human resource.

### BACKGROUND ART

There has conventionally been proposed a technology of a speech assistant to be implemented as a speech interface for a smartphone or the like (for example, see Patent Document 1). Furthermore, there has been proposed a technology of a robot capable of communicating through speech (for example, see Patent Document 2). Combining these technologies enables production of a virtual human resource capable of executing a task as communication.

### CITATION LIST

### Patent Document

Patent Document 1: Japanese Unexamined Patent Application, Publication No. 2016-4270
Patent Document 2: Japanese Unexamined Patent Application, Publication No. 2018-126209

### DISCLOSURE OF THE INVENTION

### Problems to be Solved by the Invention

However, although there is required a virtual human resource capable of achieving at least one of communication with high mutual understanding and efficient PDCA, with only the conventional technologies including the technologies disclosed in Patent Documents 1 and 2 as described above, it has not been possible to meet such a requirement.

The present invention has been made in view of such a circumstance, and an objective of the present invention is to provide a virtual human resource capable of executing communication with high mutual understanding or efficient PDCA.

### Means for Solving the Problems

In order to achieve the above-described objective, an information processing system of one aspect of the present invention is an information processing system that produces a virtual human resource to be dispatched from a dispatcher to a client, the system comprising an acquisition unit configured to acquire, as dispatcher information, data including at least a personalization summarization logic from among information to be provided from the dispatcher, and a virtual human resource production unit configured to produce a virtual human resource using the dispatcher information.

An information processing system of one aspect of the present invention is an information processing system that produces a virtual human resource to be dispatched from a dispatcher to a client, the system comprising an acquisition unit configured to acquire, as dispatcher information, data represented in a “semantically normalized format” or a format convertible thereto from among information to be provided from the dispatcher, and a virtual human resource production unit configured to produce a virtual human resource using the dispatcher information.

An information processing system of one aspect of the present invention is an information processing system that produces a virtual human resource to be dispatched from a dispatcher to a client, the system comprising an acquisition unit configured to acquire, as dispatcher information, data represented in a “semantically normalized format” or a format convertible thereto, the data including at least a personalization summarization logic from among information to be provided from the dispatcher, and a virtual human resource production unit configured to produce a virtual human resource using the dispatcher information.

An information processing system of one aspect of the present invention is an information processing system that produces a virtual human resource to be dispatched from a dispatcher to a client, the system comprising an acquisition unit configured to acquire, as dispatcher information, data including at least a single or a plurality of internal models, from among information to be provided from the dispatcher, and a virtual human resource production unit configured to produce a virtual human resource using the dispatcher information, wherein each of the plurality of internal models is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship.

The single or the plurality of internal models comprise, as the model produced based on the first aspect, a first model that retains human internal information including psychology, emotions, and values, in which the relationship of the information is organized to be modeled in a “semantically normalized format” or a format convertible thereto, comprise as the model produced based on the second aspect, a second model that retains human internal intellectual activity and information including knowledge and thought, in which the relationship of the intellectual activity and information is organized to be modeled in a “semantically normalized format” or a format convertible thereto, and comprise, as the model produced based on the third aspect, a third model in which the purpose or goal including KGI and KPI with a human individual or an organization to which the human belongs serving as a unit, and its internal relationship are organized to be modeled in a “semantically normalized format” or a format convertible thereto.

In order to achieve the above-described objective, a virtual human resource of one aspect of the present invention is a virtual human resource to be dispatched from a dispatcher to a client that is produced using, as dispatcher information, data including at least a personalization summarization logic among information to be provided from the dispatcher, the virtual human resource comprising a task execution unit configured to use the plurality of internal models to enable a task instruction to be issued in a form of a message readable by a human, thereby executing a predetermined task while interacting with the human.

A virtual human resource of one aspect of the present invention is a virtual human resource to be dispatched from a dispatcher to a client that is produced using, as dispatcher information, data represented in a “semantically normalized format” or a format convertible thereto among information to be provided from the dispatcher, the virtual human resource comprising a task execution unit configured to use the plurality of internal models to enable a task instruction to be issued in a form of a message readable by a human, thereby executing a predetermined task while interacting with the human.

A virtual human resource of one aspect of the present invention is a virtual human resource to be dispatched from a dispatcher to a client that is produced using, as dispatcher information, data represented in a “semantically normalized format” or a format convertible thereto, the data including at least a personalization summarization logic among information to be provided from the dispatcher, the virtual human resource comprising a task execution unit configured to use the plurality of internal models to enable a task instruction to be issued in a form of a message readable by a human, thereby executing a predetermined task while interacting with the human.

A virtual human resource of one aspect of the present invention is a virtual human resource to be dispatched from a dispatcher to a client that is produced using, as dispatcher information, data including at least a plurality of internal models among information to be provided from the dispatcher, wherein each of the single or the plurality of internal models is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship, in which the virtual human resource comprises a task execution unit configured to set up a plan using a model produced based on the third aspect while involving self-recognition and partner recognition using models produced based on the first aspect and the second aspect, execute a predetermined task while interacting with a human to achieve the plan, evaluate the result of the execution, and perform improvement based on the result of the evaluation.

Furthermore, the plurality of internal models comprise, as the model produced based on the first aspect, a first model that retains human internal information including psychology, emotions, and values, in which the relationship of the information is organized to be modeled in a “semantically normalized format” or a format convertible thereto, comprise, as the model produced based on the second aspect, a second model that retains human internal intellectual activity and information including knowledge and thought, in which the relationship of the intellectual activity and information is organized to be modeled in a “semantically normalized format” or a format convertible thereto, and comprise, as the model produced based on the third aspect, a third model, in which the purpose or goal including KGI and KPI with a human individual or an organization to which the human belongs serving as a unit, and its internal relationship are organized to be modeled in a “semantically normalized format” or a format convertible thereto.

### Effects of the Invention

The present invention makes it possible to provide a virtual human resource capable of executing communication with high mutual understanding or efficient PDCA.

### BRIEF DESCRIPTION OF THE DRAWINGS

FIG. 1 is a diagram illustrating an overview of a present service targeted for application of one embodiment of an information processing system of the present invention;

FIG. 2 is a diagram illustrating more detailed description of the present service illustrated in FIG. 1;

FIG. 3A is a split view of the diagram illustrating more detailed description of the present service illustrated in FIG. 2;

FIG. 3B is a split view of the diagram illustrating more detailed description of the present service illustrated in FIG. 2;

FIG. 3C is a split view of the diagram illustrating more detailed description of the present service illustrated in FIG. 2;

FIG. 4 is a table illustrating applicable works of the virtual human resource of the present service in FIG. 1;

FIG. 5A is a split view of a table illustrating an applicable works of the virtual human resource of the present service illustrated in FIG. 4;

FIG. 5B is a split view of a table illustrating an applicable works of the virtual human resource of the present service illustrated in FIG. 4;

FIG. 6 is a diagram illustrating an example of the configuration according to an embodiment of the information processing system to which the present service in FIG. 1 is applied, i.e., the information processing system of the present invention;

FIG. 7 is a block diagram illustrating a hardware configuration of the server in the information processing system in FIG. 6;

FIG. 8 is a diagram illustrating an example of a functional configuration that functions when the virtual human resource production or updating processing is executed, among the functional configurations of the server in the information processing system in FIG. 7;

FIG. 9 is a diagram illustrating an example of a functional configuration that functions when the human resource dispatch processing is executed, among the functional configurations of the server in the information processing system in FIG. 7;

FIG. 10 is a diagram illustrating an overview of a task to be executed by the virtual human resource of the present service in FIG. 1;

FIG. 11A is a split view of the diagram illustrating an overview of a task to be executed by the virtual human resource of the present service illustrated in FIG. 10;

FIG. 11B is a split view of the diagram illustrating an overview of a task to be executed by the virtual human resource of the present service illustrated in FIG. 10;

FIG. 11C is a split view of the diagram illustrating an overview of a task to be executed by the virtual human resource of the present service illustrated in FIG. 10;

FIG. 12 is a diagram illustrating various sensors of the virtual human resource of the present service in FIG. 1 and an overview of an information input flow to the virtual human resource,

FIG. 13 is a diagram illustrating a correspondence between each step of the overall processing and each figure;

FIG. 14 is a flowchart illustrating a flow of the overall processing to be executed by the server;

FIG. 15 is a flowchart illustrating an example of the details of the preliminary preparation processing of human resource dispatch of step S1 in the overall processing in FIG. 14;

FIG. 16 is a flowchart illustrating an example of the details of the human resource dispatcher-specific virtual human resource management processing of step S11 in the preliminary preparation processing of human resource dispatch in FIG. 15;

FIG. 17 is a flowchart illustrating an example of the details of the basic element management processing of step S111 in the human resource dispatcher-specific virtual human resource management processing in FIG. 16;

FIG. 18 is a flowchart illustrating an example of the details of the registration processing of a task execution unit of step S112 in the human resource dispatcher-specific virtual human resource management processing in FIG. 16;

FIG. 19 is a flowchart illustrating an example of the details of the human resource dispatcher-specific information registration processing of step S12 in the preliminary preparation processing of human resource dispatch in FIG. 15;

FIG. 20 is a flowchart illustrating an example of the details of the registration processing for preferred human resource dispatch destination of step S2 in the overall processing in FIG. 14;

FIG. 21 is a flowchart illustrating an example of the details of the initial learning processing of step S3 in the overall processing in FIG. 14;

FIG. 22 is a flowchart illustrating an example of the details of the learning processing of step S32 in the initial learning processing in FIG. 21;

FIG. 23 is a flowchart illustrating an example of the details of the generation processing of an internal model in step S321 of the learning processing in FIG. 22;

FIG. 24 is a flowchart illustrating an example of the details of the psychology, emotions, and values generation processing of step S3211 of the generation processing of an internal model in FIG. 23;

FIG. 25 is a flowchart illustrating an example of the details of the knowledge and thought generation processing of step S3212 in the generation processing of an internal model in FIG. 23;

FIG. 26 is a flowchart illustrating an example of the details of the reading processing of various kinds of logic data of step S32123 in the knowledge and thought generation processing in FIG. 25;

FIG. 27 is a flowchart illustrating an example of the details of the goal generation processing of step S3213 in the generation processing of an internal model in FIG. 23;

FIG. 28 is a flowchart illustrating an example of the details of the data reading processing of step S322 in the learning processing in FIG. 22;

FIG. 29 is a flowchart illustrating an example of the details of the reading processing of the integrated curriculum data PDC of step S3222 in the data reading processing in FIG. 28;

FIG. 30 is a flowchart illustrating an example of the details of the internal model updating processing of step S323 in the learning processing in FIG. 22;

FIG. 31 is a flowchart illustrating an example of the details of the recognition formation processing of step S3232 in the internal model updating processing in FIG. 30;

FIG. 32 is a flowchart illustrating an example of the human resource production processing of step S4 in the overall processing in FIG. 14;

FIG. 33 is a flowchart illustrating an example of the work start preparation processing of step S5 in the overall processing in FIG. 14;

FIG. 34 is a flowchart illustrating an example of the human resource dispatch processing of step S6 in the overall processing in FIG. 14;

FIG. 35 is a flowchart illustrating an example of the task execution processing of step S61 in the human resource dispatch processing in FIG. 34;

FIG. 36 is a flowchart illustrating an example of the objective interpretation processing of step S614 in the task execution processing in FIG. 35;

FIG. 37 is a flowchart illustrating an example of the subjective interpretation processing of step S615 in the task execution processing in FIG. 35;

FIG. 38 is a flowchart illustrating an example of the utterance contents examination and generation processing of step S616 in the task execution processing in FIG. 35;

FIG. 39 is a flowchart illustrating an example of the utterance and task instruction processing of step S617 in the task execution processing in FIG. 35;

FIG. 40 is a diagram illustrating an overview of fundamental technologies necessary to achieve the virtual human resource;

FIG. 41 is a diagram illustrating (1) normalized representation of all definition information;

FIG. 42A is a split view of the diagram illustrating (1) normalized representation of all definition information illustrated in FIG. 41;

FIG. 42B is a split view of the diagram illustrating (1) normalized representation of all definition information illustrated in FIG. 41;

FIG. 43 is a diagram illustrating (2) sensor-based semantic decomposition;

FIG. 44 is a diagram illustrating (3) context association;

FIG. 45 is a split view of the diagram illustrating (3) context association illustrated in FIG. 44;

FIG. 46 is a diagram illustrating an application example of context association for word sense disambiguation;

FIG. 47 is a diagram illustrating an application example of the context association for symbol grounding;

FIG. 48 is a diagram illustrating an application example of the context association for axiomatic extraction;

FIG. 49 is a diagram illustrating an application example of the context association for grouping of concepts and axioms;

FIG. 50 is a diagram illustrating an application example of the context association for estimation of missing elements;

FIG. 51 is a diagram illustrating (4) a recognition formation from an episodic memory;

FIG. 52A is a split view of the diagram illustrating (4) a recognition formation from an episodic memory;

FIG. 52B is a split view of the diagram illustrating (4) a recognition formation from an episodic memory;

FIG. 52C is a split view of the diagram illustrating (4) a recognition formation from an episodic memory;

FIG. 53 is a diagram illustrating a specific example of the data represented in a “semantically normalized format” or a format convertible thereto, i.e., N4;

FIG. 54A is a split view of the diagram illustrating the data represented in a “semantically normalized format” or a format convertible thereto, i.e., N4 illustrated in FIG. 53;

FIG. 54B is a split view of the diagram illustrating the data represented in a “semantically normalized format” or a format convertible thereto, i.e., N4 illustrated in FIG. 53;

FIG. 55 is a diagram illustrating a configuration example of PSF data PDP of a “dispersed and dynamic generation type”;

FIG. 56 is a diagram illustrating a configuration of PSF data PDP of a “centralized and existing type”;

FIG. 57 is a diagram illustrating an overview of processing steps of the personalization summarization;

FIG. 58 is a split view of the diagram illustrating an overview of processing steps of the personalization summarization illustrated in FIG. 57;

FIG. 59 is a diagram illustrating an effect of the personalization summarization;

FIG. 60 is a diagram illustrating the comprehension level achieved by the personalization summarization and the automation level of communication in the virtual human resource O;

FIG. 61 is a diagram illustrating an overview of an internal model;

FIG. 62A is a split view of the diagram illustrating an overview of an internal model illustrated in FIG. 61;

FIG. 62B is a split view of the diagram illustrating an overview of an internal model illustrated in FIG. 61;

FIG. 63 is a diagram illustrating a purpose of the internal model; and

FIG. 64 is a split view of the diagram illustrating a purpose of the internal model illustrated in FIG. 63.

### PREFERRED MODE FOR CARRYING OUT THE INVENTION

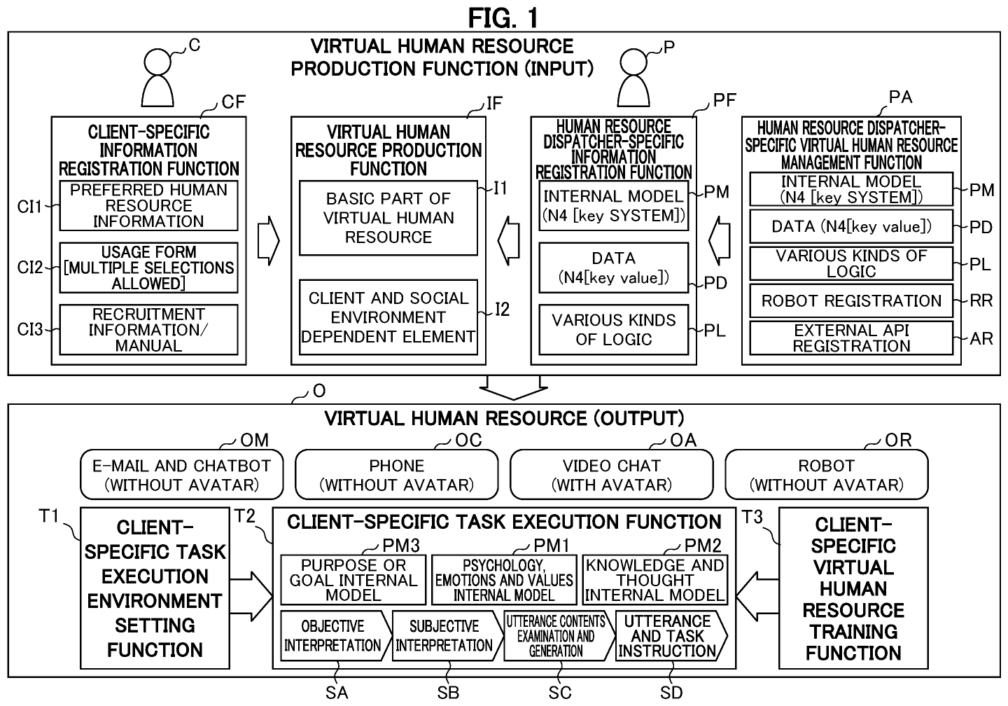

FIG. 1 is a diagram illustrating an overview of a service (hereinafter referred to as a “present service”) targeted for application of one embodiment of an information processing system of the present invention. That is, the present service refers to a service for dispatching a virtual human resource O produced based on information (hereinafter referred to as “client information”) provided from a client C and information (hereinafter referred to as “dispatcher information”) provided from a human resource dispatcher P, from the human resource dispatcher P to the client C.

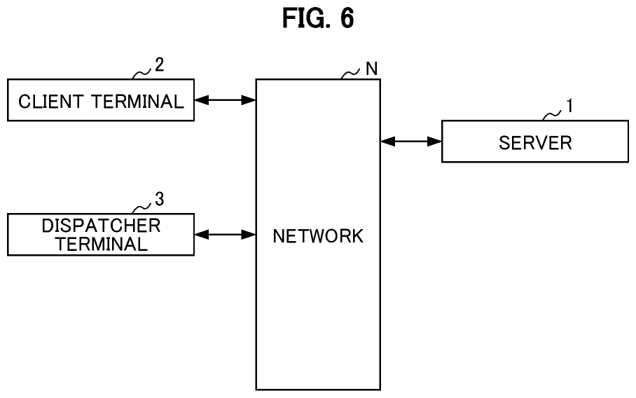

The client C operates a client terminal (e.g., a client terminal 2 in FIG. 6, which will be described later) to allow a client-specific information registration function CF to be enabled, and registers the client information. A registration destination is not limited to particular registration destinations, but for the convenience of the following description, the registration destination is assumed to be a server (e.g., a server 1 in FIG. 6) to be managed by a provider of the present service. Here, the client information includes, for example, preferred human resource information CI1, a usage form CI2, human resource recruitment information/manual CI3, and the like. Note that the client information will be described later in detail in conjunction with the description of the client-specific information registration function CF. The client C accepts the dispatch of the virtual human resource O produced based on the client information provided by the client C itself and the dispatcher information, which will be described later, provided by the human resource dispatcher P. That is, the client C is a business entity, an individual or the like which performs an act such as a work to achieve a predetermined purpose, and accepts the virtual human resource O that can execute various tasks, to ask the virtual human resource O to assist in the act such as a work.

The human resource dispatcher P operates a dispatcher terminal (e.g., a dispatcher terminal 3 in FIG. 6, which will be described later) to allow a human resource dispatcher-specific virtual human resource management function PA and a human resource dispatcher-specific information registration function PF to be enabled. For example, the human resource dispatcher P allows the human resource dispatcher-specific information registration function PF to be enabled, thereby registering the dispatcher information. A registration destination is not limited to particular registration destinations, but for the convenience of the following description, the registration destination is assumed to be a server (e.g., the server 1 in FIG. 6) to be managed by a provider of the present service. Here, the dispatcher information includes, for example, an internal model PM, linguistic resource data PD, logics PL, and the like. Note that the dispatcher information will be described in detail later in conjunction with the description of the human resource dispatcher-specific information registration function PF. The human resource dispatcher P dispatches, to the client C, the virtual human resource O produced based on the client information provided by the client C and the dispatcher information provided by the human resource dispatcher P itself.

Here, the virtual human resource generally refers to an information system which communicates with a human using words as an interface, and contributes to achieving a specific purpose. The virtual human resource O to be dispatched to the client C through the present service refers to at least the following virtual human resource among the generalized virtual human resources as described above.

That is, the virtual human resource O to be dispatched from the human resource dispatcher P to the client C is produced using, as the dispatcher information, data including at least a personalization summarization logic among the information to be provided from the human resource dispatcher P. The virtual human resource O uses a plurality of internal models, which will be described later, to enable a task instruction to be issued in a form of a message readable by a human, thereby executing a predetermined task while interacting with the human. Here, the personalization summarization logic, although will be described later in detail, refers to an information system that may paraphrase the contents depending on the partner. There have conventionally existed paraphrasing based on a parallel corpus, study cases of a dictionary for simplifying Japanese vocabulary, and the like, but these are so-to-speak close to such translation that vocabulary to be paraphrased is fixed and learning itself is batch processing. In contrast, the virtual human resource O applying the personalization summarization logic can change available vocabularies flexibly depending on the partner in real time.

The virtual human resource O to be dispatched from the human resource dispatcher P to the client C is produced using, as the dispatcher information, data represented in a “semantically normalized format” or a format convertible thereto among the information to be provided from the human resource dispatcher P. The virtual human resource O uses a plurality of internal models, which will be described later, to enable a task instruction to be issued in a form of a message readable by a human, thereby executing a predetermined task while interacting with the human. Here, the “semantically normalized format”, although will be described later in detail, refers to a semantic expression form with high machine readability so that the same sense is expressed by the same form, including natural language and programming language.

The virtual human resource O to be dispatched from the human resource dispatcher P to the client C is produced using, as the dispatcher information, data represented in a “semantically normalized format” or a format convertible thereto, the data including at least the personalization summarization logic, among the information to be provided from the human resource dispatcher P. The virtual human resource O uses a plurality of internal models, which will be described later, to enable a task instruction to be issued in a form of a message readable by a human, thereby executing a predetermined task while interacting with the human.

The virtual human resource O to be dispatched from the human resource dispatcher P to the client C is produced using, as the dispatcher information, data including at least a single or a plurality of internal models, which will be described later, among the information to be provided from the human resource dispatcher P. Each of the plurality of internal models is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship. The virtual human resource O sets up a plan using a model produced based on the third aspect while involving self-recognition and partner recognition using models produced based on the first aspect and the second aspect, executes a predetermined task while interacting with a human to achieve the plan, evaluates the result of the execution, and performs improvement based on the result of the evaluation.

Here, the single or the plurality of internal models include, as the model produced based on the first aspect, a first model (e.g., a psychology, emotions, and values internal model PM1, which will be described later) that retains human internal information including psychology, emotions, and values, in which the relationship of the information is organized to be modeled in a “semantically normalized format” or a format convertible thereto. The plurality of internal models include, as the model produced based on the second aspect, a second model (e.g., a knowledge and thought internal model PM2, which will be described later) that retains human internal intellectual activity and information including knowledge and thought, in which the relationship of the intellectual activity and information is organized to be modeled in a “semantically normalized format” or a format convertible thereto. The single or the plurality of internal models include, as the model produced based on the third aspect, a third model (e.g., a purpose or goal internal model PM3, which will be described later), in which the purpose or goal including KGI and KPI with a human individual or an organization to which the human belongs serving as a unit, and its internal relationship are organized to be modeled in a “semantically normalized format” or a format convertible thereto.

Here, the virtual human resource O to be dispatched to the client C through the present service is compared with the conventional technologies. In the conventional technologies, there exist a speech assistant such as Siri (registered trademark) and a robot such as Pepper (registered trademark) capable of communicating through speech.

Overall, the common features on the definition of terms between the virtual human resource O and the conventional speech assistant and robot are described as follows. That is, in the virtual human resource O and the conventional speech assistant and robot, a “skill” exists as a management unit of what to do in response to the utterance of the partner. The virtual human resource O and the conventional speech assistant and robot are common in that a function executable in the “skill” is referred to as an “intent”, and an argument in the intent is referred to as a “slot”, and furthermore, an “interface” is provided to finally activate an external function.

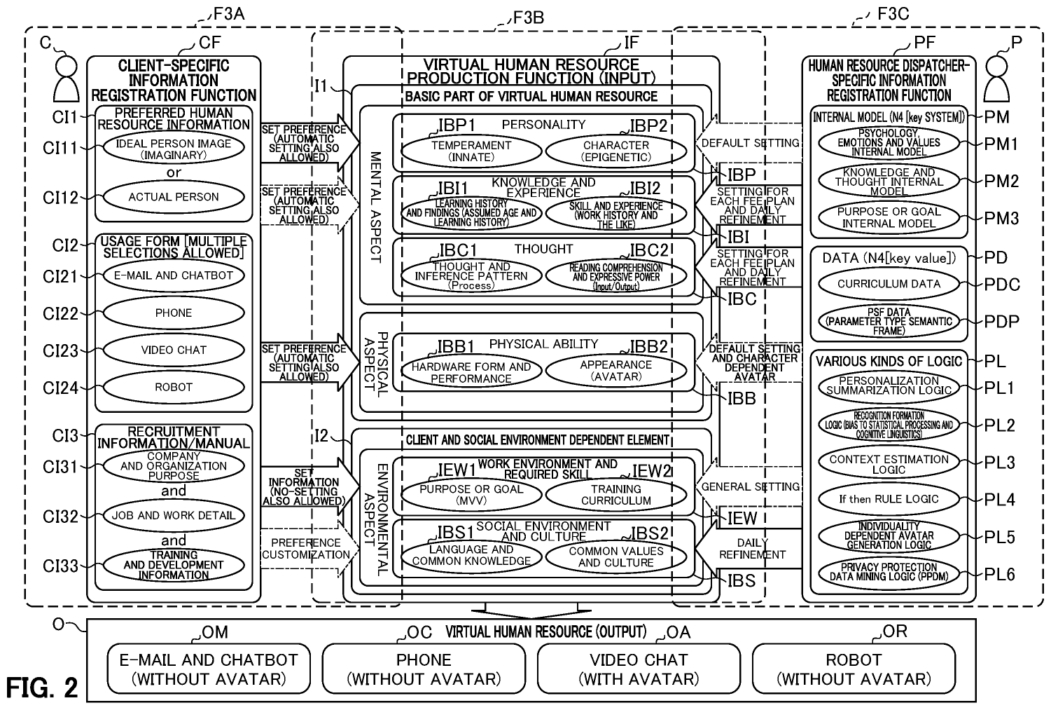

In contrast, the different features on the definition of terms between the virtual human resource O and the conventional speech assistant and robot are described as follows. That is, the virtual human resource O is different from the conventional technologies in the “skill” as an If then rule logic PL4 in FIG. 2, particularly in terms of the accuracy of recognition and estimation of a context which is included in the section of “condition” of If then. However, the If then rule logic PL4 is not equal to the skill, but includes executable tasks such as inference in addition to the skill. In contrast, the speech assistant is different in that the external function to be activated such as a Web application is referred to as a “skill service”. The robot is different in that the “skill” is referred to as an “agent”, and the executable external function is referred to as an “event”.

The processing of the virtual human resource O flows from input to output through process. Of these, a key point as an input element is “understanding of speaker's words”. In terms of the “understanding of speaker's words”, the different feature between the virtual human resource O and the conventional speech assist and robot is described as follows. That is, since the virtual human resource O is produced based on a context estimation logic (e.g., a context estimation logic PL3 in FIG. 2, which will be described later), a personalization summarization logic (e.g., a personalization summarization logic PL1 in FIG. 2, which will be described later), and the like, the virtual human resource O can deepen the mutual understanding with the speaker to thereby understand the speaker's words, by asking the speaker to confirm the understood contents while ruminating in its own words or by clarifying and re-inquiring a question if the virtual human resource O cannot understand the speaker's words. In contrast, the speech assistant and the robot estimate the speaker's words based on the similarity to a sample of the registered utterance. That is, the speech assistant and the robot search for words similar to the speaker's words from the sample of utterance registered in a “skill” set prepared in advance, thereby estimating the speaker's words.

Next, key points as a process element are “estimation of a purpose” and a “method of registering a skill”. In terms of the “estimation of a purpose”, the common feature between the virtual human resource O and the conventional speech assist and robot is described as follows. That is, the virtual human resource O and the conventional speech assistant and robot are common in estimating a target skill from the registered skill group, and an intent in the skill. Specifically, for example, in the case of the speech assistant, the correct intent is estimated from among one or a plurality of intents in a skill “I want to know the weather forecast”, based on which of slots such as “which place of” and “which date of” has been recognized with respect to the skill. This corresponds to which skill (e.g., the If then rule logic PL4 in FIG. 2, which will be described later) is to be invoked in the virtual human resource O, and therefore both are common in this respect.

In contrast, in terms of the “estimation of a purpose”, the different feature between the virtual human resource O and the conventional speech assist and robot is described as follows. That is, since the virtual human resource O is produced based on the internal model PM, a multilayered purpose can be set. That is, the conventional speech assistant and robot determines the action while reflecting only the speaker's intent, whereas the virtual human resource O can perform the action to achieve the multilayered purposes including, for example, KGI/KPI of the client C and the improvement in psychology, emotions, values and the like of the speaker.

In addition, in terms of the “method of registering a skill”, the common feature between the virtual human resource O and the conventional speech assist and robot is described as follows. That is, the virtual human resource O and the conventional speech assistant and robot are common in that a skill is manually registered by a company that provides the skill.

In contrast, in terms of the “method of registering a skill”, the different feature between the virtual human resource O and the conventional speech assist and robot is described as follows. That is, since the virtual human resource O is produced based on curriculum data (e.g., curriculum data PDC in FIG. 2, which will be described later), the internal model PM, a personalization summarization logic (e.g., the personalization summarization logic PL1 in FIG. 2, which will be described later), a recognition formation logic (e.g., a recognition formation logic PL2 in FIG. 2, which will be described later), a context estimation logic (e.g., the context estimation logic PL3 in FIG. 2, which will be described later), the skill can be automatically produced from these data. Specifically, for example, in the case where the virtual human resource O with high cooperativeness is produced, the skill may be produced so that the virtual human resource O can offer fine response according to a character of the partner based on the internal model PM. In contrast, in the conventional speech assistant, the skill is not automatically produced, and the skill manually registered is set, as a skill service, for the interface. Also in the conventional robot, the skill is not automatically produced, and the skill manually registered is set, as an event to be activated, for the agent and intent.

key points as an output element are “utterance contents”, “retention of a continuation state”, “execution of a task”, and an “appearance”. In terms of the “utterance contents”, the common feature between the virtual human resource O and the conventional speech assist and robot is described as follows. That is, the virtual human resource O and the conventional speech assistant and robot are common in that the contents implemented on the skill service are output as the utterance contents.

In contrast, in terms of the “utterance contents”, the different feature between the virtual human resource O and the conventional speech assist and robot is described as follows. That is, since the virtual human resource O is produced based on a context estimation logic (e.g., the context estimation logic PL3 in FIG. 2, which will be described later), and a personalization summarization logic (e.g., the personalization summarization logic PL1 in FIG. 2, which will be described later), the virtual human resource O can change the contents to make the utterance with vocabularies suitable for the partner. Specifically, for example, if the partner is a fifth grade elementary student, the virtual human resource O can convert the utterance contents to be understood even by the fifth grade elementary student, and output the converted utterance contents. This can deepen the mutual understanding with the speaker. In contrast, the conventional speech assistant and robot can only output, as the utterance contents, the same contents to all the persons. That is, unlike the virtual human resource O, the speech assistant and the robot are not imparted with diverse individuality, so that all individuals can only provide the same response.

In terms of the “retention of a continuation state”, the different feature between the virtual human resource O and the conventional speech assist and robot is described as follows. That is, since the virtual human resource O is produced based on the internal model PM, the virtual human resource O can retain the context as a whole while grasping an ordinary state, independently of a unit of skill. As a result, for example, if it is necessary to always provide the same response for a specific partner such as a personal tutor, the continuation state can be retained, which makes it possible to further deepen the mutual understanding with the partner. In contrast, in the conventional speech assistant the skill is implemented as a stateful skill. In the case where an application for a credit card is made, for example, in the conventional speech assistant, the information such as the context is retained in the skill related to the application procedures, but the retention of the information is discontinued on the next day. In the conventional robot, the skill is implemented by constructing a scenario in which continuous intents are interfaced with each other.

In terms of the “execution of a task”, the common feature between the virtual human resource O and the conventional speech assist and robot is described as follows. That is, the virtual human resource O and the conventional speech assistant and robot are common in that the task is executed based on the skill.

In contrast, in terms of the “execution of a task”, the different feature between the virtual human resource O and the conventional speech assist and robot is described as follows. That is, since the virtual human resource O is produced based on a personalization summarization logic (e.g., the personalization summarization logic PL1 in FIG. 2, which will be described later), the virtual human resource O can receive a task instruction in a form of a message readable by a human such as speech, and correlate the task instruction with an API when the external API is activated. That is, in the virtual human resource O, firstly, a task instruction is issued in a form of a message readable by a human once, and then the API is executed based on the instruction contents. That is, since human understandable words are passed, a specific task can be executed by either a human or the virtual human resource O, which enables flexible response according to the situations. In contrast, in the conventional speech assistant and robot, the API described in the skill service and the event specified by the event specification are executed immediately. That is, in the conventional speech assistant and robot, since human understandable words are not passed, the human cannot understand what kind of processing is performed, even when checking the interface and information of the API.

Next, in terms of the “appearance”, the different feature between the virtual human resource O and the robot is described as follows. That is, since the virtual human resource O is produced based on an individuality dependent avatar (e.g., an individuality dependent avatar generation logic PL5 in FIG. 2, which will be described later), the virtual human resource O can listen and respond by the appearance according to the individuality. This can further deepen the mutual understanding with the partner. In contrast, the speech assistant except for the conventional robot is only implemented on the hardware such as a smartphone and a household electric appliance, to assist in operation through speech, but has no avatar. In the conventional robot, a uniform appearance is merely applied as the robot.

Next, each of the comprehension level and the automation level is compared between the virtual human resource O to be dispatched to the client C through the present service as described above and the speech assistant and robot of the conventional technologies.

In the case where the comprehension when a person understands a thing is classified into levels, the comprehension can be generally classified into the following six levels of (0) to (5). That is, the comprehension level is firstly classified, as the self-checkable levels, into the levels (0) I do not know (zero Input), (1) I know (fragmentary Input), (2) I can read (overall Input, belief in understanding), and (3) I can speak (subjective Output, allowable even when the quality of contents is poor). Then, the comprehension level is classified, as the levels requiring the objectivity, into the levels (4) I can communicate (objective Output, allowable even in the determined range only), and (5) I can teach (evolutionary Output, including related external knowledge), such that the comprehension level can be classified into the six levels. In the case of the six levels, in the conventional technologies, the levels (2) and (3) can be output, but the level (4) of “I can communicate” cannot be achieved. In contrast, the virtual human resource O of the present service can output the levels (4) and (5). It is thus apparent that the comprehension level of the virtual human resource O of the present service is significantly higher than that of the conventional technologies.

Next, in the case where the automation level when a person makes communication is classified into levels, the automation level can be generally classified into the following six levels of (0) to (5). That is, the automation level is classified, as the levels at which a person is a subject, into the levels (0) a person is 100% subject, and an operator responds without a chatbot, (1) a person is 90% subject, and a user only selects an option presented by the system side, and (2) a person is 80% subject and can respond to defined utterance, or an operator confirms the response. Then, the automation level is classified, as the levels at which a bot is a subject, into the levels (3) a person is 70% subject, a bot responds including a certain degree of notation variability, and an operator responds if interpretation by the bot is impossible, (4) a person is 50% subject, and all communication related to a certain genre is made by the bot, and (5) a person is 0% subject, and all communication related to various genres is made by the bot, such that the automation level can be classified into the six levels. In the case of the six levels, in the conventional intent slot type technology, the automation at the levels (1) to (3) can be achieved, whereas in the virtual human resource O of the present service, the automation at the level (4) can be achieved. That is, in the virtual human resource O, all communication related to various genres can be made by the bot.

Returning to FIG. 1, next, an overview of the present service will be described in terms of its function. The present service is roughly classified into a function for producing or updating the virtual human resource O and a function of the virtual human resource O itself.

The function for producing or updating the virtual human resource O can be exerted at an arbitrary position of the information processing system to which the present invention is applied, and for the convenience of the following description, the function is assumed to be exerted at a server (e.g., the server 1 in FIG. 6, which will be described later). The function for producing or updating the virtual human resource O includes the client-specific information registration function CF, the human resource dispatcher-specific virtual human resource management function PA, the human resource dispatcher-specific information registration function PF, and a virtual human resource production function IF.

The client-specific information registration function CF is a function of accepting registration of the client information. Specifically, for example, the client-specific information registration function CF accepts the preferred human resource information CI1, the usage form CI2, the human resource recruitment information/manual CI3 and the like. Providing the thus registered client information for the virtual human resource production function IF makes it possible to produce the virtual human resource O close to ideal imagery of the client C.

The human resource dispatcher-specific virtual human resource management function PA is a function of managing various kinds of information necessary to produce the virtual human resource O. Specifically, for example, the human resource dispatcher-specific virtual human resource management function PA manages a template of each of the internal model PM, the linguistic resource data PD, and the logics PL which are needed to produce the virtual human resource O. A robot registration function RR included in the human resource dispatcher-specific virtual human resource management function PA performs the initial setting to define what request is to be issued for each action based on the interface specification of the actuator of the hardware of the robot. This enables the virtual human resource O to assimilate differences among various robots in the world, and cooperate with various robots. Furthermore, an external API registration function AR included in the human resource dispatcher-specific virtual human resource management function PA performs the initial setting and the management of the external API executable according to the task instruction. This enables the virtual human resource O to execute the task using various APIs in the world. When the external APIs are collectively registered by the human resource dispatcher P, the client C can easily utilize an arbitrary external API merely by selecting the external API.

The human resource dispatcher-specific information registration function PF is a function of accepting the registration of the dispatcher information. Specifically, for example, the human resource dispatcher-specific information registration function PF accepts the registration of the internal model PM, the linguistic resource data PD, the logics PL, and the like. Providing the thus registered dispatcher information for the virtual human resource production function IF makes it possible to produce the virtual human resource O satisfying the preferences of the client C.

The virtual human resource production function IF produces or updates the virtual human resource O based on the client information and the human resource dispatcher information. Specifically, the virtual human resource production function IF produces or updates the virtual human resource O while reflecting an aspect of each of a virtual human resource basic portion I1 and a client and social environment dependent element I2. At this time, the virtual human resource production function IF can produce or update a form of the virtual human resource O including, for example, a virtual human resource OM that executes a task in a form of e-mail and chatbot, a virtual human resource OC that executes a task in a form of a phone, a virtual human resource OA that executes a task in a form of a video chat, and a virtual human resource OR that processes a task in a form of a robot.

That is, the virtual human resource O is produced or updated by exerting the function of each of the client-specific information registration function CF, the human resource dispatcher-specific virtual human resource management function PA, the human resource dispatcher-specific information registration function PF, and the virtual human resource production function IF as described above. Then, the virtual human resource O thus produced or updated is dispatched to the client C.

The function of the virtual human resource O itself is exerted in the information processing device (including a robot) operated or managed by the client C, and for the convenience of the following description, the function is assumed to be exerted in the client terminal (the client terminal 2 in FIG. 6, which will be described later). The function of the virtual human resource O itself includes a client-specific task execution environment setting function T1, a client-specific task execution function T2, and a client-specific virtual human resource training function T3.

The client-specific task execution environment setting function T1 accepts the registration of the information necessary when the virtual human resource O executes a task in the client C.

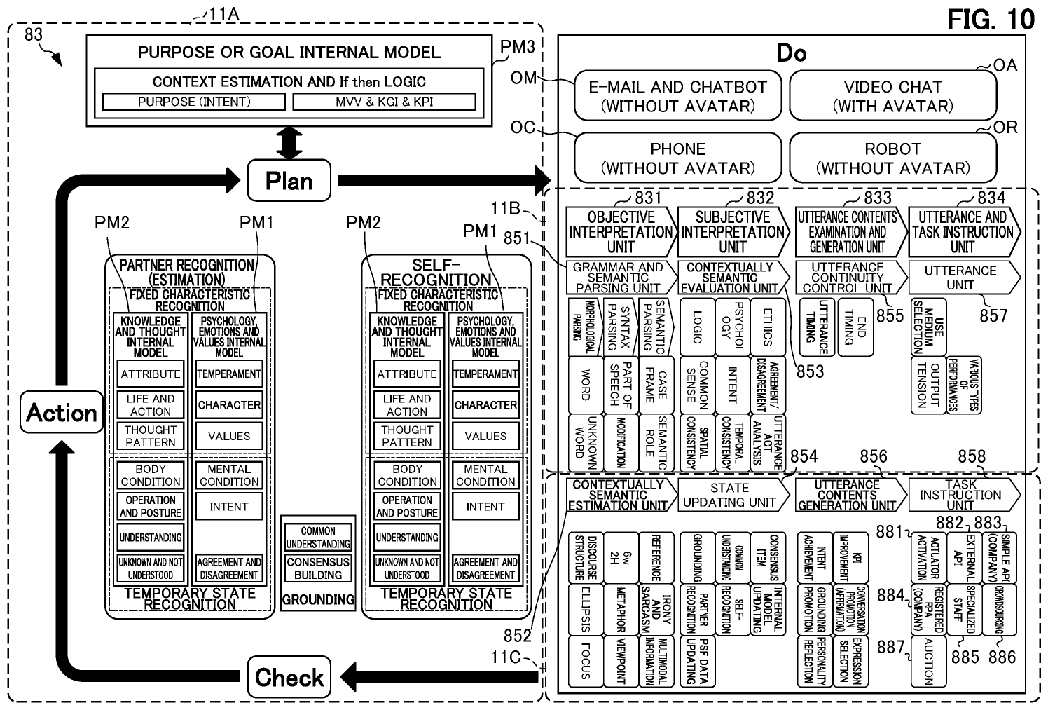

The client-specific task execution function T2 is a function used when the virtual human resource O executes the task. Although the details will be described later with reference to FIG. 10, the virtual human resource O executes the task so that the processing of each of the objective interpretation SA, subjective interpretation SB, utterance contents examination and generation SC, and utterance and task instruction SD are repeated based on the registered internal model PM.

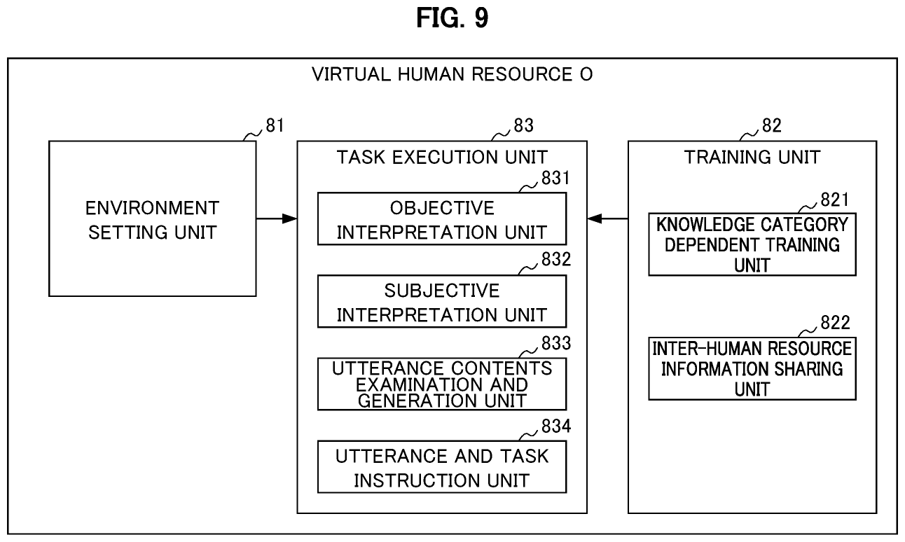

The client-specific virtual human resource training function T3 is a function used to train the virtual human resource O. Although the details will be described later with reference to FIG. 9, the client-specific virtual human resource training function T3 accepts the registration of the information necessary for the virtual human resource O to perform additional learning, and various kinds of information necessary to share knowhow among the virtual human resources O dispatched to the client C.

That is, the virtual human resource O can execute the task in the client C, and perform the additional learning by exerting the function of each of the client-specific task execution environment setting function T1, the client-specific task execution function T2, and the client-specific virtual human resource training function T3 as described above.

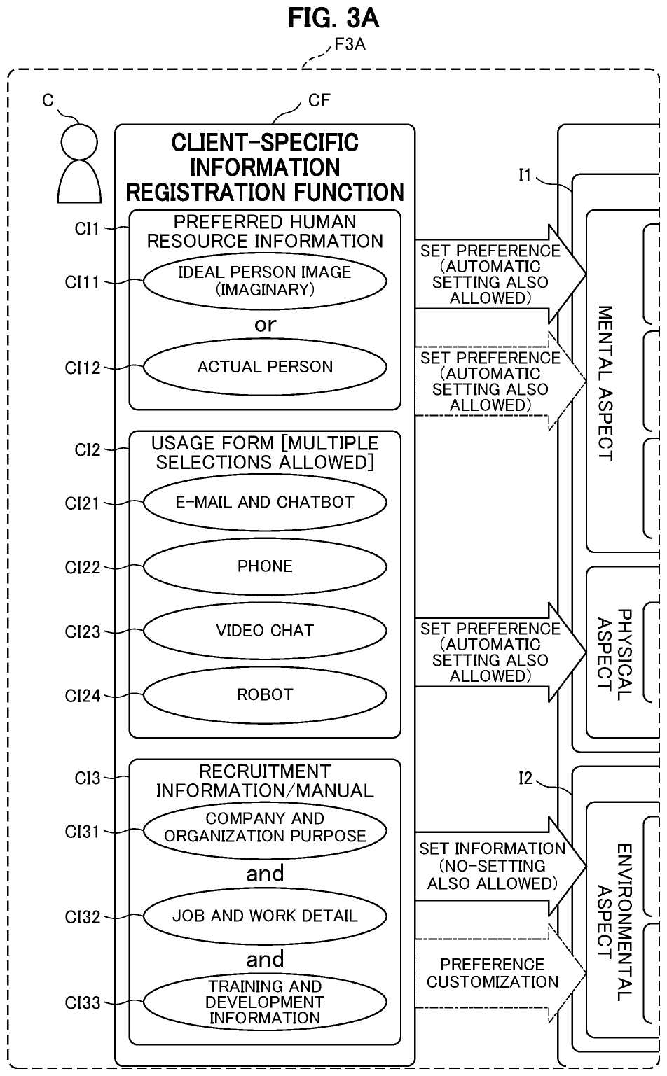

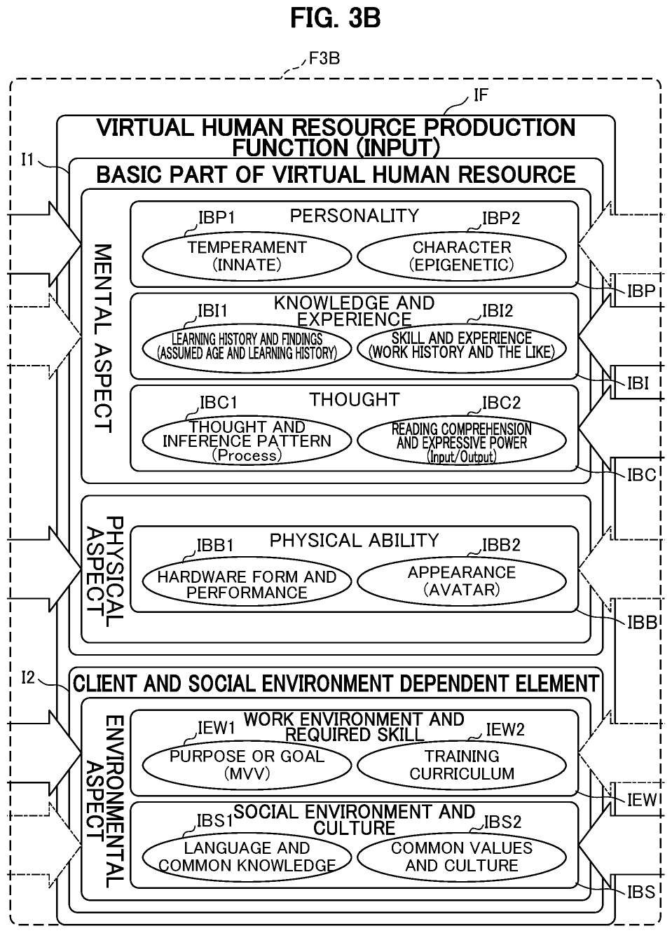

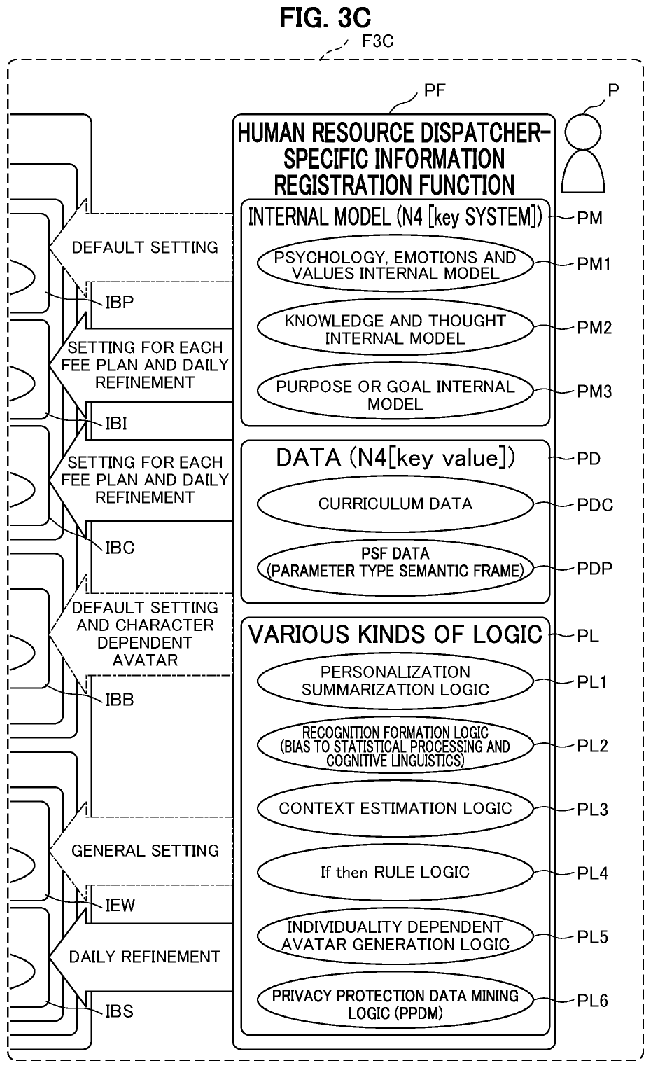

There has been described with reference to FIG. 1, the overview of the present service in terms of its function. Furthermore, among the functions to produce or update the virtual human resource O, each of the client-specific information registration function CF, the human resource dispatcher-specific information registration function PF, and the virtual human resource production function IF will be described in detail with reference to FIG. 2. FIG. 2 is a diagram illustrating more detailed description of the present service illustrated in FIG. 1. FIGS. 3A to 3C each are a split view of the diagram illustrating more detailed description of the present service illustrated in FIG. 2.

The client-specific information registration function CF accepts the registration of the client information including a human resource image sought by the client C to execute a work in the company, a work instruction to the human resource, and the information necessary to transfer the skill. In a conventional human resource dispatch system (hereinafter, referred to as “conventional real human resource dispatch”) which dispatches an actual human, it is difficult for the client to obtain, as the human resource, a human close to ideal imagery even if the client explicitly presents the ideal imagery sought by the company. Then, according to the present service, the client information registered by the client C is provided for the virtual human resource production function IF, which makes it possible to produce the virtual human resource O close to the ideal imagery of the client C, whereby the client C can obtain the human resource close to the ideal imagery of the company.

Specifically, the client-specific information registration function CF accepts the registration of the preferred human resource information CI1, the usage form CI2, the human resource recruitment information/manual CI3, and the like.

The preferred human resource information CI1 refers to information about a human resource sought by the client C. The preferred human resource information CI1 includes an ideal person image (imaginary person image) CI11, and an actual person CI12, and at least one of these pieces of information is provided to the virtual human resource production function IF.

For example, when the information about an ideal person image (imaginary person image) is provided, as the ideal person image (imaginary person image) CI11, to the virtual human resource production function IF, the virtual human resource O close to the imaginary of the ideal person image of the client C is produced. In addition, for example, when the information about the actual person is provided, as the actual person CI12, to the virtual human resource production function IF, the virtual human resource similar to the actual person is produced as the virtual human resource O. In this way, the virtual human resource O closer to the preferences of the client C is produced by providing the preferred human resource information CI1 to the virtual human resource production function IF, which makes it possible to reduce a gap between ideal and reality with respect to the human resource, the gap having been conventionally felt by the client C.

However, for the convenience of the description, the following description will be made on the assumption that the preferred human resource information CI1 is provided by the client C to the virtual human resource production function IF, but the provision of the preferred human resource information CI1 is not always necessary. That is, even when the preferred human resource information CI1 is not provided from the client C, predetermined preferred human resource information CI1 is automatically registered with the virtual human resource production function IF.

The usage form CI2 refers to information about a form of the virtual human resource O when various tasks are executed in the client C. The usage form CI2 includes, as the information about the form, e-mail and chatbot CI21, a phone CI22, a video chat CI23, and a robot CI24, and at least one or more of these pieces of information are provided to the virtual human resource production function IF.

For example, when the e-mail and chatbot CI21 is selected as the usage form CI2, the virtual human resource OA that executes a task in a form of e-mail and chatbot is produced. In addition, for example, when the phone CI22 is selected as the usage form CI2, the virtual human resource OC that executes a task in a form of a phone is produced. In addition, for example, when the video chat CI23 is selected as the usage form CI2, the virtual human resource OA that executes a task in a form of a video chat is produced. However, at this time, the virtual human resource OA may be output as an avatar, though this need not always be the case. Furthermore, for example, when the robot CI24 is selected as the usage form CI2, the virtual human resource OR that executes a task in a form of a robot is produced.

In the conventional technologies, the usage form is limited, or a cross-service such as use in a plurality of usage forms is not provided. That is, for example, there has been no service in which the personality of Pepper, which is an example of a robot, is provided to other devices. According to the present service having a high degree of freedom as described above, the cross-service such as the use in the plurality of usage forms is provided for the virtual human resource O, whereby various works which cannot be applied in the conventional technologies can be included in the target range of the task. This enables the client C to easily accept the provision of the virtual human resource O matching work needs and a preferred usage form, which makes it possible to apply the virtual human resource O to a wide range of works, thereby being able to achieve substantial improvement in productivity. In other words, in the case where a plurality of usage forms are selected as the usage form CI2, the virtual human resource O can execute a task while maintaining the same personality under the environment of all the selected usage forms, thereby achieving the provision of consistent service to the client C.

Note that the virtual human resource OM that executes a task in a form of e-mail and chatbot, the virtual human resource OC that executes a task in a form of a phone, the virtual human resource OA that executes a task in a form of a video chat, and the virtual human resource OR that executes a task in a form of a robot are merely examples of a medium of only text, a medium of only speech, a medium in which the speech and the video are combined with each other, and a medium having physical ability such as a visual sensation and an auditory sensation, respectively, and each can be applied to the similar medium as appropriate.

In addition, for the convenience of the description, the following description will be made on the assumption that the usage form CI2 is provided to the virtual human resource production function IF, but the provision of the usage form CI2 is not always necessary. That is, even when the usage form CI2 is not provided by the client C, a predetermined usage form CI2 is automatically registered with the virtual human resource production function IF.

The recruitment information/manual CI3 refers to recruitment information representing specific work contents of the client C and information about a manual in which procedures standardized to execute a work are outlined. The recruitment information/manual CI3 includes a company and organization purpose CI31, a job and work detail CI32, and training and development information CI33, and at least one or more of these pieces of information are provided to the virtual human resource production function IF.

In the conventional real human resource dispatch, it is difficult even to search for a human resource matching the presented contents even if the recruitment information and the manual of the client C is presented to a human resource candidate, for example. In addition, also in the conventional technologies, a sufficient data amount cannot be obtained only by the information described in the recruitment information and manual, which makes it difficult to apply a learning method such as deep learning. Therefore, it cannot be said that the service reflecting the work contents of the client C can be provided. Then, according to the present service, the recruitment information/manual CI3 is provided to the virtual human resource production function IF, which makes it possible to produce the virtual human resource O with a high matching ratio to the work of the client C. This enables the client C to easily accept the provision of the virtual human resource O matching the work of the company, whereby the client C can expect further improvement in the work efficiency.

At this time, the client-specific information registration function CF may have a function of optical character recognition (OCR) or the like to efficiently incorporate document information, existing in the client C, which is mixed various forms, for example, text, charts and equations. This enables the virtual human resource O to easily acquire the document information, whereby the virtual human resource O can easily perform learning based on the information existing in the client C.

Note that, for the convenience of the description, the following description will be made on the assumption that the recruitment information/manual CI3 is provided to the virtual human resource production function IF, but the provision of the recruitment information/manual CI3 is not always necessary. That is, even when the recruitment information/manual CI3 is not provided, a predetermined virtual human resource O is automatically produced.

The human resource dispatcher-specific information registration function PF accepts in advance the registration of the information necessary for producing the virtual human resource O as the dispatcher information. In the conventional real human resource dispatch, a method of using advertisement and the like to gather human resource candidates is mainstream, and it is difficult to say that the human resources can be efficiently gathered. Then, according to the present service, the dispatcher information is provided to the virtual human resource production function IF, which makes it possible to produce an arbitrary virtual human resource O matching the preferences of the client C. Even when a part of the client information is not clear (the preference of the client C is not registered), the predetermined information is automatically registered, which makes it possible to produce the virtual human resource O of a certain level or more.

Specifically, the human resource dispatcher-specific information registration function PF accepts the registration of the internal model PM, the linguistic resource data PD, the logics PL, and the like.

For example, the internal model PM models the information of the psychology, emotions, and values internal model PM1, the knowledge and thought internal model PM2, the purpose or goal internal model PM3, and the like in the semantically normalized format, and retains the modeled information. Suitable reciprocal variations are implemented among internal models based on the retained co-occurrence, causal relationship and the like among the internal models, thereby ensuring the consistency of the entirety. That is, for example, when such a psychology, emotions, and values internal model PM1 is adopted as the internal model PM, it makes it possible to produce the virtual human resource O capable of offering a response in consideration of person's feelings. For example, when the purpose or goal internal model PM3 is adopted as the internal model PM, it makes it possible to produce the virtual human resource O meeting the purpose of the company. When the plurality of internal models PM are thus combined and optimized, the virtual human resource O capable of taking a purposeful action can be produced.

In the speech assistant and robot of the conventional technologies, there have been no examples in which as in the present service, the psychology, emotions, and values, the knowledge and preference, and the purpose or goal are comprehensively incorporated and are provided as service, and therefore the expression may be made without feelings and emotions. On the other hand, according to the present service, the psychology, emotions, and values internal model PM1, the knowledge and thought internal model PM2, the purpose or goal internal model PM3, and the like are combined and optimized, which makes it possible to grasp an influence of the utterance or action on the psychology, emotions, and values, the knowledge and preference, the purpose or goal, and the like. That is, the utterance or action of the virtual human resource O with respect to specific psychology, emotions, and values, knowledge and preference, and purpose or goal can be optimized.

Most of speech assistants and robots are optimized only for a specific task, and therefore when deviating from the task, they cannot take the action in many cases. This is because it is impossible to effectively solve a frame problem in that it is very difficult for AI to select, from all events which may occur in the world, only the information necessary for analyzing and determination to be made now by surrounding it with a frame. On the other hand, in the present service, the plurality of internal models are combined and adopted, which makes it possible to hierarchically set the motivations such as a purpose affecting the utterance or action of the virtual human resource O. As a result, even if deviating from a purpose range in a specific hierarchy, the action is motivated in the next hierarchy, and therefore the virtual human resource O can effectively solve the frame problem without stopping the function.

The psychology, emotions, and values internal model PM1 retains the internal information of the psychology, emotions, values and the like, in which the relationship of each piece of the internal information is organized to be modeled.

In the conventional technologies, it is said that there is almost no implementation related to the psychology, emotions, and values. On the other hand, in the present service, the interaction and action in consideration of the psychology, emotions, and values are promoted, which makes it possible to increase the execution level of the overall work of the virtual human resource O, and further improve the quality of collaboration with surroundings. Consequently, a virtual human resource O having psychological and ethical mind can be produced. In addition, the psychology, emotions, and values internal model PM1 simulates temperament, instinct, and a physiological portion that a human innately has. Furthermore, the psychology, emotions, and values internal model PM1 can incorporate also common value criteria such as three laws of robotics to be complied with when the virtual human resource O is produced.

The knowledge and thought internal model PM2 retains the internal intellectual activity and information of knowledge, thought and the like, in which the relationship of the internal intellectual activity and information is organized to be modeled.

In the conventional technologies, its internal determination criteria are not visualized, and for example, deep learning or the like is basically a so-called black box. On the other hand, in the present service, the knowledge and thought internal model PM2 refers to a visualized white box type intelligent model and thought model, and when such a knowledge and thought internal model PM 2 is adopted, the virtual human resource O has the intelligence that can be described not in partial aspects but all aspects. That is, according to the present service, the virtual human resource O is produced having the intelligence with continuity and growth correlated with the knowledge and thought and taking advantages of both of recognition and experience. In this way, according to the virtual human resource O that grows intelligently and dynamically, the efficient interaction and action are promoted, thereby increasing the execution level of the overall task of the virtual human resource O, and further improving the quality of collaboration with surroundings.

The purpose or goal internal model PM3 retains the purpose or goal of KGI, KPI and the like with an individual or an organization serving as a unit, in which the relationship of the KGI, KPI and the like with an individual or an organization serving as a unit is organized to be modeled.

The speech assistant and robot of the conventional technologies are often optimized only for a specific task, and therefore are not optimized for the multilayered purposes having a hierarchical relationship, of the KGI, KPI and the like of the company, for example. In contrast, in the present service, the relationship between the purpose or goal of the client C and the virtual human resource O is modeled and managed, which makes it possible to promote the purposeful interaction and action of the virtual human resource O, whereby the execution level of the overall work of the client C can be increased. In other words, according to the present service, the virtual human resource O incorporates the KPI tree of the client C, which enables the virtual human resource O to achieve a purpose-oriented action.

The linguistic resource data PD retains the curriculum data PDC, PSF data PDP, and the like in the semantically normalized format.

The curriculum data PDC is data including contents to be learned that are subjected to priority level evaluation by sequencing the information necessary for developing the virtual human resource O. Specifically, for example, the data is assumed to include files in the forms of video, still image, text and the like, and files into which input information from various sensors corresponding to a visual sensation, an auditory sensation and the like is dropped. In the present service, the document information existing in the client C can be easily acquired by a technique such as OCR, whereby the virtual human resource O can easily perform the learning based on books, business documents, treatises, and the like.

In the conventional technologies, the learning is performed based on the data and the information among the data, the information, the knowledge, and the intelligence, and is often optimized for a specific task. On the other hand, in the present service, the virtual human resource O is additionally involved with the knowledge and the intelligence among the data, the information, the knowledge, and the intelligence, and applies the semantically normalized format (such as N4, and AMR), thereby being able to be useful for its own learning while capturing the values possessed by the knowledge and the intelligence. Consequently, the virtual human resource O can achieve higher learning effect. In this way, improving the strategy of the curriculum data PDC leads to improvement in the learning efficiency of the virtual human resource O, whereby the work execution ability of the virtual human resource O can be improved.

The PSF data PDP is a machine-readable semantic database having high resolution of semantic expression and in a simple form such as a key value form. That is, the PSF data PDP is an aggregate of knowledge including a so-called case frame information, ontology information, and the like. In the virtual human resource O of the present service, the PSF data PDP is positioned as external knowledge to adopt a case of a “centralized and existing type” prepared in advance like a dictionary and a case of a “dispersed and dynamic generation type” intellectually positioned in which the PSD data PDP is generated from scratch. That is, there exist a case in which the semantic database is prepared in advance to perform external reference and a case in which the semantic database is positioned as intelligence itself. Note that in the case of the “centralized and existing type”, when the PSF data PDP is formed, as a recognition logic, the most effective algorithm available according to the number of samples is utilized. On the other hand, the case of the “dispersed and dynamic generation type” is prepared gradually from scratch as if nurturing an infant.

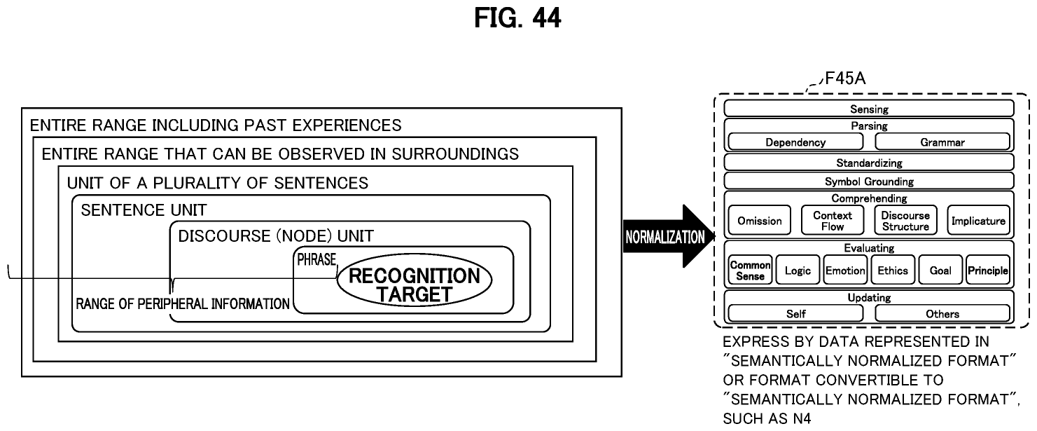

In the conventional technologies, the PSF data of the “centralized and existing type” is similar to the case frame information and the ontology information, but most of which is static and has no dynamic updatability, and since the internal information itself is described directly in natural language, the machine readability is not necessarily high. In the conventional technologies, the PSF data of the “dispersed and dynamic generation type” has a strong aspect of conventional cognitive linguistics approach, and there are few successful examples of using such approach to generate the knowledge database. In contrast, according to the present service, the existence of the PSF data PDP or creation of the PSF data PDP leads to improvement in resolution of semantic expression, which can reduce the semantic lack in a process of interpreting the natural language. That is, most of things that have not been conventionally recognized can be recognized, which enables the virtual human resource O to exactly determine the status. As a consequence, the efficient interaction and action of the virtual human resource O are promoted, thereby increasing the execution level of the overall task of the virtual human resource O, and further improving the quality of collaboration with surroundings. As described above, the PSF data PDP is a database in which high resolution of semantic expression is enabled, a semantic abstract relationship is internally organized, and the relationships between the knowledge and the knowledge with high resolution of semantic expression organized for each context have been compiled. The PSF data PDP will be described later in further detail. The context is one in which the peripheral information with respect to a recognition target is lumped with data represented in a “semantically normalized format” or a format convertible thereto, but the details of which will be described later with reference to FIG. 44.

The logics PL include a core function for forming the virtual human resource O in units of algorithm in which the word “logic” is added to the end of a word. That is, the logics PL include the personalization summarization logic PL1, the recognition formation logic PL2, the context estimation logic PL3, the If then rule logic PL4, the individuality dependent avatar generation logic PL5, a privacy protection data mining logic PL6, and the like. The above-described various logics are customized for the information about individuality of the virtual human resource O, and the utilization level increases according to the dynamic growth of the PSF data PDP. The logics PL are converted into the data as a strategy pattern, and can be easily interchanged, recombined, and freely selected. Furthermore, the logics PL themselves can be easily added, and grow by daily refinement to produce the virtual human resource O.

In the conventional technologies, for example, in the case where the machine learning is adopted, a learning model is generally formed from big data. If the machine learning is supervised learning, the training data is optimized, but logics are a so-called black box which has no mechanism that easily enables the interchange, addition, and the like of the logics. For example, even though a new logic can be fabricated applicatively from a specific learning result by transfer learning or the like, the logic itself is merely optimized for a new specific task and is still a black box, and the logics cannot be interchanged and added easily. In the conventional technologies, in the case where a rule-based type is adopted, the logics themselves are often statically implemented, and cannot be often interchanged and added easily. In contrast, in the present service, a static portion responsible for intelligence of the virtual human resource O is the data, but a dynamic thought portion is achieved by the logics. This enables the virtual human resource O to perform more flexible thought.

As described above, the personalization summarization logic PL1 is a logic used when the virtual human resource O understands a thing or converses with the partner. The use of the personalization summarization logic PL1 enables the virtual human resource O to simply paraphrase sentences according to available vocabularies. Note that when such processing by the personalization summarization logic PL1 is achieved, the data is necessary in which high resolution of semantic expression is enabled and a semantic abstract relationship is internally organized, like the PSF data PDP.

In the conventional technologies, it is impossible to paraphrase a thing depending on the partner while estimating the comprehension of the partner. In the first place, the machine learning, in particular, the mechanism of the supervised learning by deep learning outputs the most likely data based on the past enormous data. That is, expressed in a metaphorical manner, it is actually difficult to prepare all problems and solutions, which can be said to be a method in which the speech assistant and robot of the conventional technologies is more likely to be brought into a state close to a “learner having earnestly learned problems and solutions by rote”. On the other hand, the virtual human resource O produced based on the PSF data PDP and the personalization summarization logic PL1 enables high resolution of semantic expression, which is brought into a state close to a “learner capable of understanding and applying essentials” in a state which can be described. In other words, a difference between the speech assistant and robot of the conventional technologies and the virtual human resource O in the present service can be said to be close to a difference between the “learner having earnestly learned problems and solutions by rote” and the “learner capable of understanding and applying essentials” in the real world. Specifically, the virtual human resource O of the present service can understand a thing by paraphrasing in words understandable by the virtual human resource O itself, thereby capable of achieving not superficial understanding but deep understanding in a format that enables correlation with an existing knowledge level system which will be described later. Utilizing the personalization summarization logic PL1 and the internal model PM in combination enables the virtual human resource O to predict the available vocabularies of the partner side, and represent the information to be conveyed by the virtual human resource O, in a format understandable by the partner, whereby the degree of smooth flow of conversation can be dramatically increased.

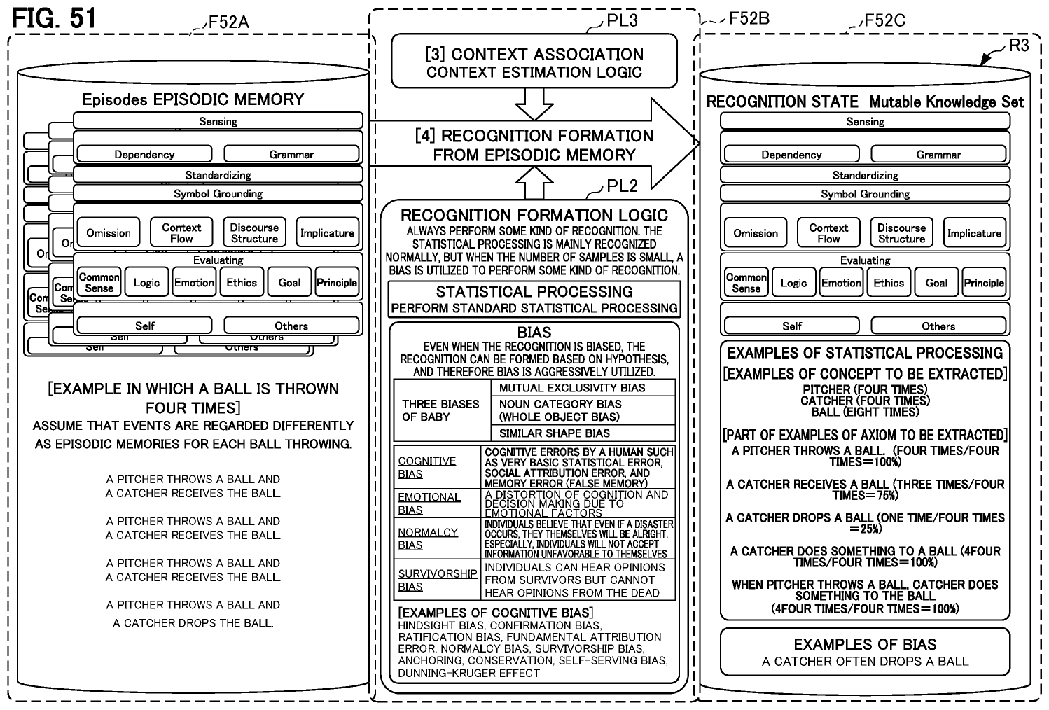

The recognition formation logic PL2 determines how the virtual human resource O recognizes a thing from its own experience and knowledge by combining cognitive bias and statistical processing. The details of the recognition formation logic PL2 will be described later with reference to FIG. 51. Note that when such recognition formation logic PL2 is applied to the virtual human resource O, the personalized correlation is performed according to personality IBP which will be described later. The cognitive linguistics findings may be totally incorporated into the recognition formation logic PL2.

In the provision of the service of the conventional technologies, a data amount equal to or more than a certain amount is required as referred to as so-called big data. Therefore, for example, like the transfer learning, the learning model learned in other fields and tasks is often reused for the speech assistant and robot of the conventional technologies. However, in the field in which a data amount is small as a whole, the results cannot be still produced, which leads to failure in industrial application. In contrast, the recognition formation logic PL2 in the present service can be used regardless of the magnitude of a data amount. Since a process of dynamically becoming smart based on the data is incorporated in the recognition formation logic PL2, the recognition formation logic PL2 has the advantage of being easily applied industrially. That is, in the present service, even when the data amount is small, some conclusion is drawn, which can prevent thought stopping. Furthermore, the virtual human resource O can gain experience at the site, thereby gradually increasing the number of samples, and growing to be able to make the correct statistical determination. In such a virtual human resource O, the reusability of knowledge can be increased, which leads to improvement in efficiency particularly in the case where the application to an unknown field is demanded. The details of the process of dynamically becoming smart will be also described with reference to FIG. 51. As described above, the virtual human resource O can naturally expand the knowledge, which makes it possible to promote the efficient interaction and action in the client C, whereby the execution level of the overall work can be increased. In addition, the virtual human resource O can improve the quality of collaboration with surroundings.

The context estimation logic PL3 estimates a context for all information involved in a work to be executed by the virtual human resource O. That is, the context estimation logic PL3 thoroughly estimates and verifies a context for all information handled by the virtual human resource O, mainly focusing on the PSF data PDP.

In the conventional technologies, the intent of the conversation partner is inferred by the intent slot type chatbot or the like in a status where the intent of the partner is extremely limited, and the presentation of the likely information and the action are only executed based on the inference. On the other hand, in the present service, the context is estimated for all information, whereby the power of the virtual human resource O to predict the intent of the partner can be further increased. That is, according to the present service, word sense disambiguation for determining in which sense a word is used and the identification accuracy of the theory applicable to solve the problem can be improved. This makes it possible to expect the reduction of misunderstanding in the conversation of the virtual human resource O and improvement in the quality of thought of the virtual human resource O. The effect of the use of the context will be described later in detail with reference to FIGS. 44 to 50.

The If then rule logic PL4 is a logic from which the virtual human resource O determines what utterance is to be generated or what action is to be taken for each scene of each work. Specifically, the If then rule logic PL4 is a rule aggregate that takes the form of [If “condition”, then “action to be executed”], and performs an action when the condition is satisfied. However, at this time, the context is often applied to the “condition” portion in the [If “condition”, then “action to be executed”], and therefore the quality of the context recognition affects the quality of If then. In addition, when the If then rule logic PL4 is applied to the virtual human resource O, the personalized correlation is performed according to personality IBP, which will be described later, and appropriate prioritization is performed. Therefore, if the order of application is different among each rule even when a set of the same If then rule logics PL4 is applied to a plurality of virtual human resources O, the action is different among the plurality of virtual human resource O.

Also in the conventional technologies, a mechanism for recognizing the status to perform appropriate processing is implemented, but a difference between the conventional technologies and the present service is integrated into the accuracy of the recognition and estimation of the context applied to the “condition” portion of If then. That is, in the present service, the accuracy of the recognition and estimation of the context is improved, whereby the matching degree of an action selected by the virtual human resource O in each scene can be improved as compared with the conventional technologies. That is, the virtual human resource O can offer appropriate response in various scenes in which the tasks are performed, which makes it possible to promote the efficient interaction and action in the client C, whereby the execution level of the overall work of the client C can be increased. In addition, this makes it possible to improve the quality of collaboration between the virtual human resource O and surroundings.

The individuality dependent avatar generation logic PL5 generates specific appearance, voice, and the like of the virtual human resource O as an avatar. That is, the individuality dependent avatar generation logic PL5 generates an avatar. The individuality dependent avatar generation logic PL5 can generate an avatar according to the individuality, and can designate an avatar from the outside, for example, thereby making it possible to generate an avatar by fixedly designating an animated character or the like.

In the conventional technologies, there is almost no provision of a service with an avatar in the first place. For example, although in the conventional technologies, an avatar having personality exists, these do not allow the avatar to be replaced according to the preferences of the client. On the other hand, in the present service, by providing a mechanism which can generate an avatar having the appearance according to various work needs, an emotion state of the virtual human resource O can be easily conveyed to the surroundings even under any environment, which makes it possible to promote the efficient interaction and action in the client C, whereby the execution level of the overall work of the client C can be increased and the quality of collaboration between the virtual human resource O and surroundings can be improved.

The privacy protection data mining logic PL6 preserves the company confidentiality through protecting the privacy of the virtual human resource O, while mutually sharing the knowhow between the virtual human resources O. The privacy protection data mining logic PL6 is defined in a form including an anonymization technique necessary for privacy protection. Since the information to be provided from the client C when the virtual human resource O is produced is highly confidential, it is necessary to protect the information. However, on the other hand, it is necessary to further enhance the work execution ability of each of a plurality of virtual human resources O dispatched to the same client C while sharing the knowhow among the plurality of virtual human resources O. That is, according to the present service, it is possible to promote the formation of the organizational knowledge in the whole work while protecting the confidential information of the client C.

The virtual human resource production function IF produces or updates the virtual human resource O based on the client information and the human resource dispatcher information. In the conventional real human resource dispatch system, it is very complicated to manage the information about human resource candidates, which requires time and cost for a recruiting process including interview and the like. In addition, also in the conventional technologies, a flow of generating a learning model based on the data is mainstream, and in the first place, there is no concept that the speech assistant and robot of the conventional technologies are dispatched, for example. Therefore, as a matter of course, there has not been an idea that the information provided by the client C and the information provided by the human resource dispatcher P are merged to produce the virtual human resource O. According to the present service, the virtual human resource O matching the needs of the client C is produced and dispatched, which enables the client C to easily ensure the human resource without requiring the information management related to the human resource candidates and the complicated process such as interview. Note that the virtual human resource production function IF can produce the virtual human resource O more matching the needs of the client C as the number of client information items provided increases, but even when the client information is not provided from the client C, the virtual human resource production function IF automatically produces the virtual human resource O based on a predetermined condition. That is, the virtual human resource production function IF can produce the virtual human resource O which satisfies the client information condition as much as possible, according to the setting state including the presence or absence of the provision of the information.

In the virtual human resource production function IF, the virtual human resource basic portion I1 which is a so-called portion for creating a person, and the client and social environment dependent element I2 which depends on the information of the client and social environment are reflected. The virtual human resource basic portion I1 includes, as mental aspects of the virtual human resource O, the personality IBP, knowledge and experience IBI, and thought IBC, and, as physical aspects of the virtual human resource O, physical ability IBB.

The personality IBP provides the virtual human resource O with a function of enabling behavior of a human resource having personality including a temperament and a character. The personality IBP includes a temperament IBP1 and a character IBP2.

The temperament IBP1 provides the virtual human resource O with a function of enabling behavior of a human resource having innate mental tendency of the human resource. With regard to the setting of the mental tendency of the human resource, there exist a number of mental models such as a method focusing on the tendency of the action of substances which are physiologically secreted in the brain, the substances including dopamine, serotonin, testosterone, estrogen, and the like, but the setting is integrally managed by performing ensemble processing while incorporating a plurality of models. As described above, since the mental tendency of the human resource is correlated with the tendency of the action of the intracerebral substances described above and managed, which makes it possible to respond to any preference of the client C regarding the virtual human resource O having the mental tendency.

The conventional technologies are said to be functional and heartless, whereas the virtual human resource O in the present service contributes to the society in such a manner as to express the feelings. That is, in such temperament IBP1, the function of enabling behavior of a human resource having the temperament of the virtual human resource O is managed, whereby the virtual human resource O can express the individuality, for example, in the following points. Specifically, examples of the individuality are assumed to include exploratory behavior, excitement, pursuit of experience and adventure, resistance to boredom, lack of restraint, enthusiasm, lack of self-examination, increase in energy and motivation, physical and intellectual exploration, cognitive flexibility, curiosity, creation of ideas, verbal originality, improvement in nonverbal originality, socialization, uneasy susceptibility, extroversion, the tendency “to have no good friend”, ease of change to positive mind, devoutness, importance of harmony, tendency to orderly action, sincerity, tendency to specifically think a thing, self-control, carefulness, new spirit of inquiry, creativity using figures and numerals, tendency to reach minute details, concentration, a range of interest, suppression of emotion, flood of emotions, social dominance and aggressiveness, low social sensitivity, keen perception of space and numerals, high level of verbal skills such as fluency, ease of empathy, helpfulness, motivation to use capability of sociality such as social friendliness, ability to think based on the context, imagination, and mental flexibility. As a result of the expression of such individuality, for example, it is possible to promote an emotional response and efficient interaction and action of the virtual human resource O, which can lead to an increase in the execution level of the overall work. In addition, this makes it possible to improve the quality of collaboration between the virtual human resource O and surroundings.

The character IBP2 provides the virtual human resource O with a function of enabling behavior of a human resource having characteristics such as mentality and action which are epigenetically formed through experience and knowledge while being affected by the innate temperament. In order to organize the character of the human resource, there has conventionally existed a number of mental models such as five axes, i.e., cooperativeness, extroversion, openness, sincerity, and nervousness, but the individuality is finally represented by performing ensemble processing while incorporating a plurality of models.

That is, in such character IBP2, the response in which the individuality of the virtual human resource O is perceived is expressed, which makes it possible to promote an emotional response of the virtual human resource O to the client C and efficient interaction and action of the virtual human resource O, whereby the execution level of the overall work of the client C can be increased. In addition, this makes it possible to improve the quality of collaboration between the virtual human resource O and surroundings.

Note that the personality IBP is generated mainly based on the preferred human resource information CI1 provided from the client C, but is not particularly limited thereto. Even when the preferred human resource information CI1 is not provided from the client C, the personality may be generated based on the preset information. As a result, for example, even when the client C cannot clearly set the conditions concerning the mental tendency and character of the preferred human resource, it is possible to produce the virtual human resource O having the function of enabling behavior of a human resource having the mental tendency and character of a certain level or more.

In the knowledge and experience IBI, the information about knowledge and experience of the virtual human resource O is generated. The knowledge and experience IBI include learning history and findings IBI1, and skill and experience IBI2.

The learning history and findings IBI1 provide the virtual human resource O with information describing the learning history and findings. The learning history and findings IBI1 produce the virtual human resource O with the information describing appropriate learning history and findings, based on the preferred human resource information CI1, the curriculum data PDC, and the PSF data PDP.

In the conventional real human resource dispatch, it is difficult to search for the human resource having ideal learning history and findings of the client C, depending on the task. Thus, in the present service, it is possible to easily produce the virtual human resource O having the learning history and findings close to the human resource sought by the client C. As a consequence, for example, efficient interaction and action of the virtual human resource O in the client C are promoted, which makes it possible to increase the execution level of the overall work of the client C. In addition, this makes it possible to improve the quality of collaboration between the virtual human resource O and surroundings.

The skill and experience IBI2 provide the virtual human resource O with information about skill and experience. The skill and experience IBI2 produce the virtual human resource O having the information about appropriate skill and experience, based on the preferred human resource information CI1, the recruitment information/manual CI3, the curriculum data PDC, and the PSF data PDP. Note that the skill and experience IBI2 adjusts the information about the skill and experience.

In the conventional real human resource dispatch, it is difficult to search for the human resource having ideal work skill and experience of the client C. Therefore, according to the present service including the skill and experience IBI2, it is possible to easily produce the virtual human resource O having the work skill and experience close to the human resource sought by the client C. As a consequence, for example, efficient interaction and action of the virtual human resource O are promoted, which makes it possible to increase the execution level of the overall work and improve the quality of collaboration between the virtual human resource O and surroundings. Note that the knowledge and experience IB1 mainly improve and enhance the levels of the skill and experience by daily refinement as needed, but which is not limited thereto. That is, the levels of the skill and experience of the virtual human resource O may be changed according to the service plan or the like selected by the client C.

The thought IBC provides the virtual human resource O with a function related to thought. The thought IBC includes thought and inference pattern IBC1, and reading comprehension and expressive power IBC2.

The thought and inference pattern IBC1 provides the virtual human resource O with thought and inference pattern. That is, the thought and inference pattern IBC1 generates the thought and inference pattern of the virtual human resource O, based on the recognition formation logic PL2, the If then rule logic PL4, and the like. Note that the thought and inference pattern IBC1 may be adjusted so that the individuality of the thought and inference pattern can be expressed, based on the collected information in the temperament IBP1 and the character IBP2.

In the conventional real human resource dispatch, it is difficult to search for the human resource having ideal thought and inference pattern of the client C. Thus, in the present service, a plurality of logics are combined and summarized, whereby the thought and inference pattern of the virtual human resource O can be flexibly and easily expanded. Consequently, for example, the growth of the virtual human resource O in the client C is promoted, which makes it possible to increase the execution level of the overall work of the client C. In addition, this makes it possible to improve the quality of collaboration between the virtual human resource O and surroundings.

The reading comprehension and expressive power IBC2 provides the virtual human resource O with a function of enabling behavior of a human resource having reading comprehension and expressive power. The reading comprehension and expressive power IBC2 are roughly classified into a function of enabling behavior of a human resource having reading comprehension and a function of enabling behavior of a human resource having expressive power. The function of enabling behavior of a human resource having reading comprehension generates a function of providing the reading comprehension for the virtual human resource O based on the personalization summarization logic PL1 and the context estimation logic PL3. The function of enabling behavior of a human resource having expressive power generates a function of providing the expression for the virtual human resource O based on the personalization summarization logic PL1, the context estimation logic PL3, and the If then rule logic PL4. Each of the function of enabling behavior of a human resource having reading comprehension and the function of enabling behavior of a human resource having expressive power may be adjusted so that the individuality of each of the reading comprehension and the expressive power can be perceived based on the information collected by two functions of the temperament IBP1 and the character IBP2.

In the conventional real human resource dispatch, it is difficult to search for the human resource having ideal reading comprehension and expressive power of the client C. On the other hand, in the present service, a plurality of logics are combined and summarized, whereby the function of enabling the virtual human resource O to perform behavior of a human resource having reading comprehension and expressive power can be flexibly and easily expanded. Consequently, for example, the function of enabling the virtual human resource O in the client C to perform behavior of a human resource having reading comprehension and expressive power is improved, which makes it possible to increase the execution level of the overall work of the client C and improve the quality of collaboration between the virtual human resource O and surroundings. Note that the thought IBC mainly improves and enhances the level by daily refinement as needed, but which is not limited thereto. That is, the level of the function related to the thought of the virtual human resource O may be changed according to the service plan or the like selected by the client C.

The physical ability IBB provides the virtual human resource O with physical ability. The physical ability IBB includes hardware form and performance IBB1 and an appearance (avatar) IBB2.

The hardware form and performance IBB1 are roughly classified into a function of generating a hardware form and a function of generating hardware performance.

The function of generating a hardware form prepares a connection interface based on the usage form CI2.

Specifically, for example, the function of generating a hardware form sets, for an interface, a specific e-mail address in the case of e-mail, a specific account in the case of a chatbot, a specific number or a specific number and contact name in the case of a phone, a specific account in the case of a video chat, and an access point of a connection destination in the case of a robot, through the connection interface generated. When such a function is used to generate the connection interface of the virtual human resource O, the client C sets specific access information for each virtual human resource O in the dispatcher-specific task execution environment setting function T1.

In the conventional technologies, most is provided as an API, and except for some speech assistants, no human interface is provided to the fore. In some speech assistants, the human interface is implemented in several devices, but personality to be provided is uniform and is provided under a single brand name. That is, in the conventional technologies, it is not known that the personality that is customized based on the preferences of the client C and is different in mental aspects or physical aspects is consistently provided in a form through e-mail and chatbot, a phone, a video chat, a robot, and the like, like the virtual human resource O in the present service. Furthermore, in the present service, an access point for utilizing the virtual human resource O in the preferred usage form is generated, whereby the client C can easily apply the virtual human resource O to the work.

The function of generating hardware performance produces the virtual human resource O according to each operating environment based on the specification information including the performance and capacity of the hardware on which each usage form is operated based on the registered usage forms CI2. Here, the hardware refers to targets, for example, a long term memory and a short term memory in terms of a human, a working memory transmission between cranial nerve cells, and parts that governs thought, and corresponds to a storage medium, a network, and various arithmetic devices in the virtual human resource O.

Also in the conventional technologies, there has been an attempt to be capable of executing the learning model on lightweight hardware as edge computing. Also in the present service, similarly, the function of producing the virtual human resource O is exerted based on the performance of the hardware performed by the edge computing, whereby the virtual human resource O is tuned according to the hardware constraints, which enables the virtual human resource O to operate in a limited environment. Specifically, for example, the size of the working memory of the virtual human resource O is determined depending on the size of the capacity of the storage medium, so that the level of the response capability to continuous thought of the virtual human resource O is adjusted. However, since the adjustable range is limited, the recommended specification of each hardware at the time of providing the virtual human resource O may be explicitly specified.

An appearance generating function IBB2 provides the virtual human resource O with an appearance (avatar). The appearance generating function IBB2 generates an avatar by applying the individuality dependent avatar generation logic PL5 based on the information obtained by combining two functions of the temperament IBP1 and the character IBP2 in the case where the usage form requiring the avatar, such as a video chat, is selected. The specific examples include a pattern for automatically generating an appearance of an imaginary person according to a personality and an age, a pattern for copying an appearance of an existing person, and a pattern for copying an existing character.

The physical ability IBB is generated mainly based on the usage form CI2 provided from the client C, but which is not particularly limited thereto. Even when the usage form CI2 is not provided from the client C, the physical ability of a predetermined level may be generated based on the preset information. As a result, for example, even when the client C cannot clearly set the conditions concerning the mental tendency and character of the preferred human resource, it is possible to produce the virtual human resource O having the mental tendency and character of a certain level or more.

The conventional technologies are said to be functional and heartless, whereas the virtual human resource O in the present service contributes to the society in such a manner as to express the feelings through the avatar. That is, the avatar is provided in the present service, whereby the mental aspects of the virtual human resource O can be easily conveyed to the partner of the conversation, thereby achieving smooth communication.

The client and social environment dependent element I2 include, as environmental aspects of the virtual human resource O, work environment and required skill IEW and social environment and culture IBS.

The work environment and required skill IEW provide the virtual human resource O with information about work environment of the client C and a skill required from the client C. The work environment and required skill IEW include a purpose or goal IEW1, and a training curriculum IEW2.

The purpose or goal IEW1 is based on mission vision values (MVV), and the key goal indicator (KGI) and the key performance indicator (KPI), and the like by integrally utilizing the knowledge and thought internal model PM2 and the purpose or goal internal model PM3.

In the conventional technologies, the learning model optimized for a specific task is often generated, and a series of MVV, and KGI and KPI of the company are generally captured and are not reflected in processing. On the other hand, in the present service, the virtual human resource O always determines the thought and action based on the MVV, and KGI and KPI, whereby the virtual human resource O can perform the work activity in a purposeful direction.

The training curriculum IEW2 integrates the curriculum data PDC provided by the human resource dispatcher P with the recruitment information/manual CI3 as a base, and integrates the contents to be learned by the virtual human resource O in a form centered on the work of the client C.

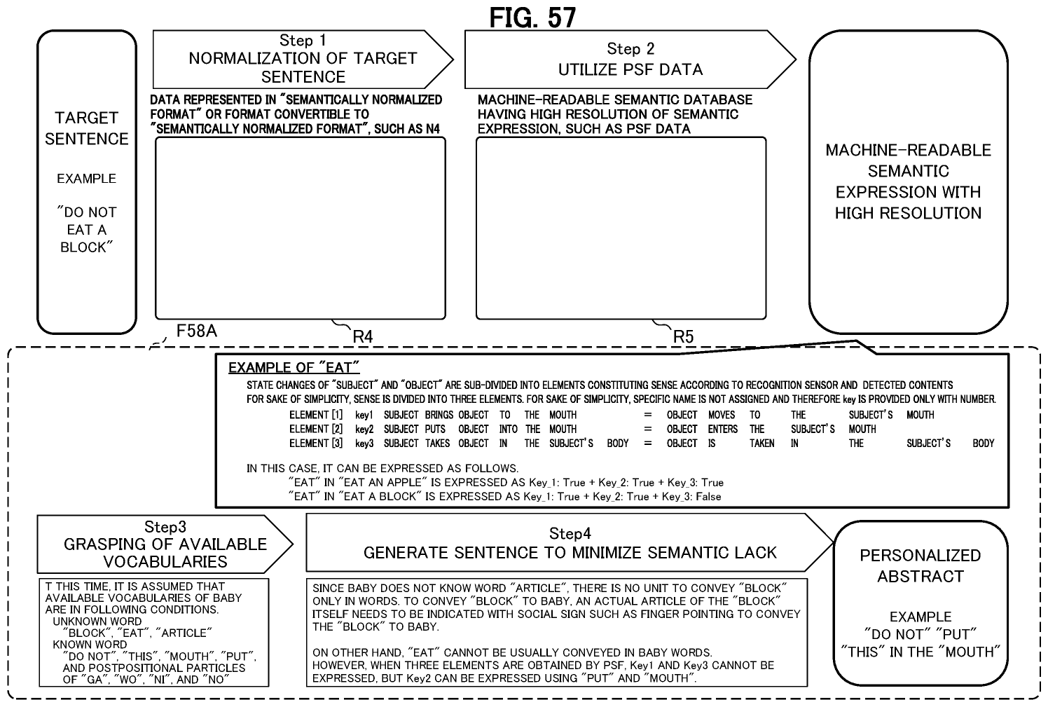

In the conventional technologies, since the learning model optimized for a specific task is generated using big data, it is difficult to generate the learning model in a data amount of a manual or the like in the first place. On the other hand, in the present service, the information of the recruitment information/manual CI3 is read by applying the personalization summarization logic PL1 and the like, which makes it possible to effectively utilize the information. Therefore, the knowhow of the human resource dispatcher P is merged in a form in which the work of the client C is respected and emphasized, which makes it possible to further matching the needs of the site of the client C and produce the virtual human resource O provided with the information about general knowhow. The details of how the manual is specifically read will be described later with reference to FIG. 57.

The work environment and required skill IEW are generated mainly based on the recruitment information/manual CI3 provided from the client C, but which is not particularly limited thereto. Even when the recruitment information/manual CI3 is not provided from the client C, the virtual human resource O may be produced based on the preset information. As a result, for example, even when the client C cannot clearly set the conditions concerning the work environment and the required skill, it is possible to produce the virtual human resource O having the mental tendency and character of a certain level or more.

The social environment and culture IBS provide the virtual human resource O with information about a social environment and culture. The social environment and culture IBS include language and common knowledge IBS1, and common values and culture IBS2.

The language and common knowledge IBS1 utilize the curriculum data PDC provided by the human resource dispatcher P to integrate the language and common knowledge to be provided in the virtual human resource O based on the knowledge and thought internal model PM2 in such a manner as to optimize the mental aspects of the virtual human resource O and the work of the client C.

In the conventional real human resource dispatch, it is difficult for the client C to easily search for the human resource having ideal language and common knowledge. On the other hand, in the present service, the virtual human resource O can be produced further matching the needs of the site of the client C and having information about general knowhow reflecting the social environment and culture.

The common values and culture IBS2 utilize the curriculum data PDC provided by the human resource dispatcher P to integrate the common values and culture to be provided in the virtual human resource O based on the psychology, emotions, and values internal model PM1 in such a manner as to optimize the mental aspects of the virtual human resource O and the work of the client C.

In the conventional real human resource dispatch, it is difficult for the client C to easily search for the human resource having the common values and culture. On the other hand, in the present service, the virtual human resource O can be produced further matching the needs of the site of the client C and having general knowhow reflecting the social environment and culture.

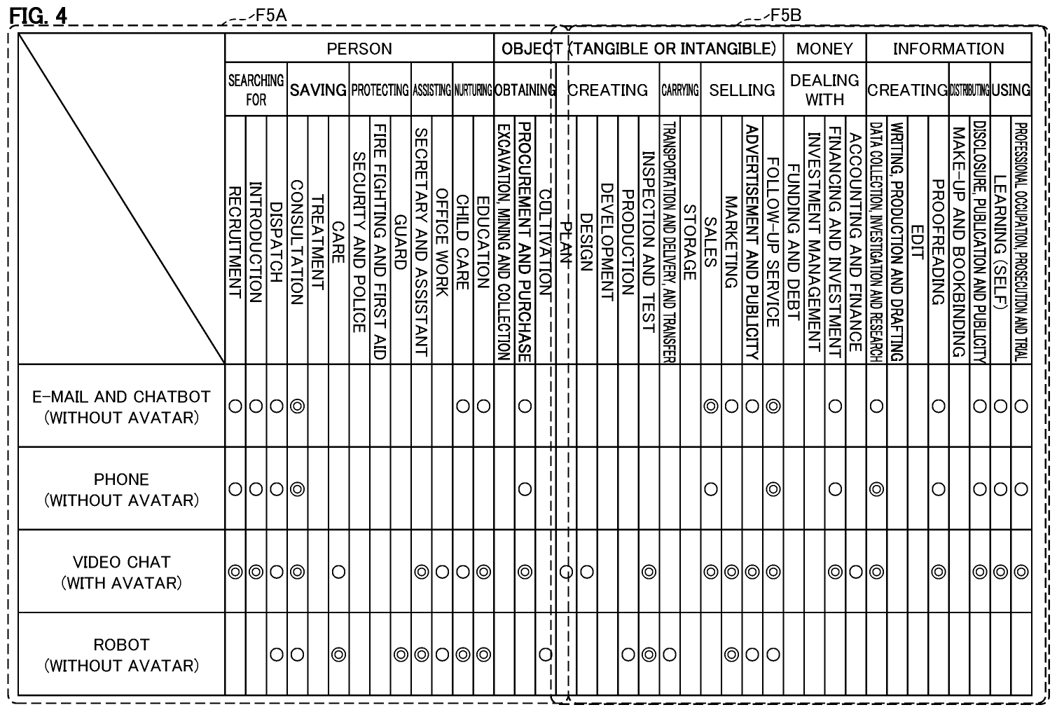

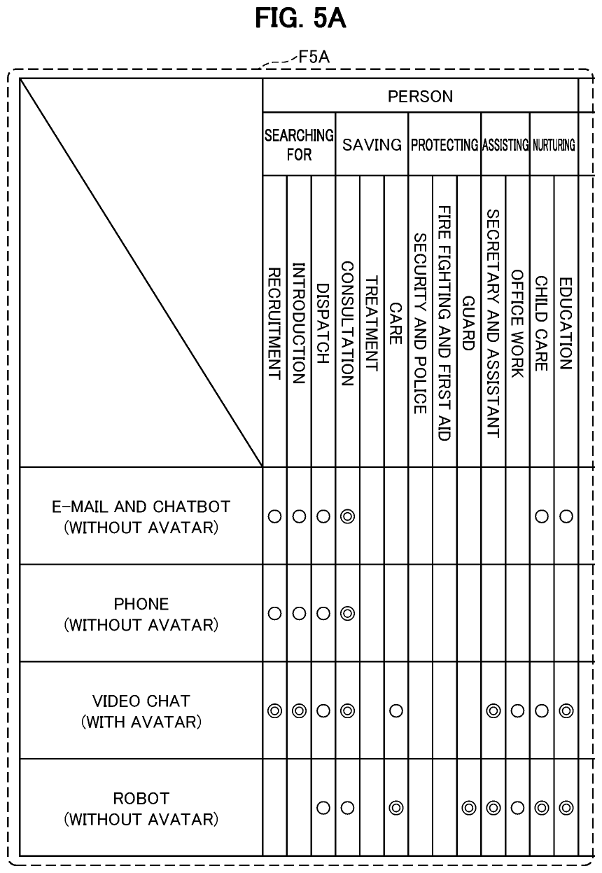

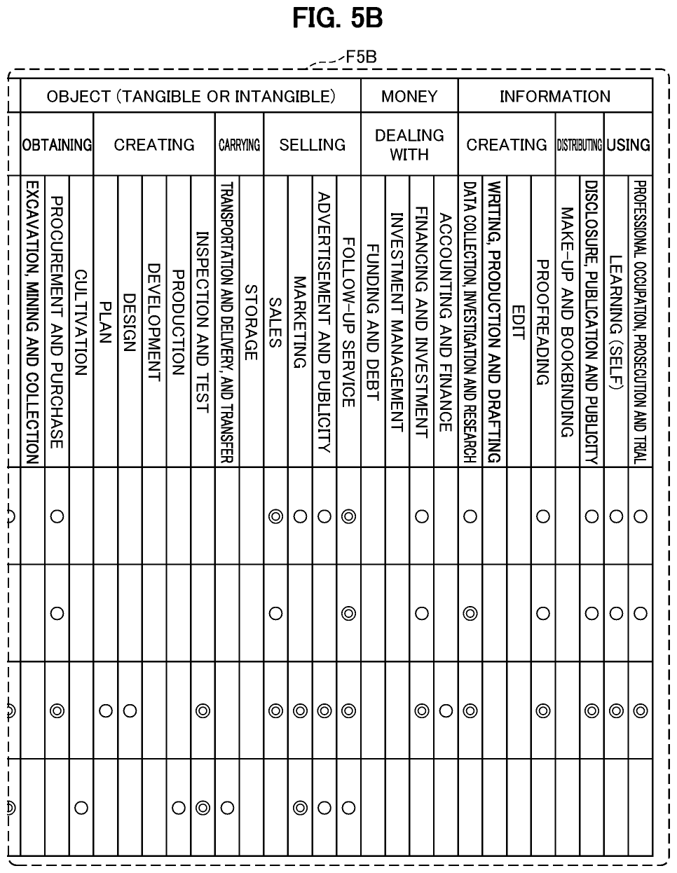

There has been described with reference to FIG. 2, each of the client-specific information registration function CF, the human resource dispatcher-specific information registration function PF, and the virtual human resource production function IF, among the functions for producing or updating the virtual human resource O. The virtual human resource O produced by exerting such various functions is dispatched to the client C, and can execute the work in each usage form. Next, an example of a work that can be executed by the virtual human resource O in the client C will be described with reference to FIG. 4. FIG. 4 is a table illustrating applicable works of the virtual human resource of the present service in FIG. 1. FIGS. 5A and 5B each are a split view of the table illustrating the applicable works of the virtual human resource of the present service illustrated in FIG. 4.

In FIG. 4, the applicable work in each usage form of each of the virtual human resource OM that executes duties in a form of e-mail and chatbot, the virtual human resource OC that can execute duties in a form of a phone, the virtual human resource OA that can execute duties in a form of a video chat, and the virtual human resource OR that can execute duties in a form of a robot is indicated by O, and furthermore, among them, more proper applicable works are indicated by a double circle. That is, for example, the virtual human resource OM that executes duties in a form of e-mail and chatbot is particularly proper for consultation included in works for saving a person, sales and follow-up service included in works for selling articles, and the like. The virtual human resource OC that can execute duties in a form of a phone is particularly proper for consultation included in works for saving a person, follow-up service included in works for selling articles, and the like. The virtual human resource OA that can execute duties in a form of a video chat is particularly proper for recruitment and introduction included in works for searching for a person, consultation included in works for saving a person, education included in works for nurturing a person, procurement and purchase included in works for obtaining articles, and sales, marketing, advertisement and publicity, and follow-up service included in works for selling articles. In the virtual human resource OR that can execute duties in a form of a robot, an actual body exists, and therefore the virtual human resource OR is particularly proper for works requiring the existence of the actual body, such as care included in works for saving a person, guard included in works for protecting a person, child care and education included in works for nurturing a person, and sales included in works for selling articles.

Next, a configuration of the information processing system to which the present service is applied, i.e., the information processing system including a server according to an embodiment of the information processing system of the present invention will be described with reference to FIG. 6. FIG. 6 is a diagram illustrating an example of the configuration according to an embodiment of the information processing system to which the present service in FIG. 1 is applied, i.e., the information processing system of the present invention.

The information processing system illustrated in FIG. 6 is configured so that the server 1, the client terminal 2, and the dispatcher terminal 3 communicate with one another through a predetermined network N such as the Internet.

The server 1 is managed by a service provider (not illustrated) of the present service. The client terminal 2 is operated by the client C, and provides the client information to the server 1. The dispatcher terminal 3 is operated by the human resource dispatcher P, and provides the dispatcher information to the server 1.

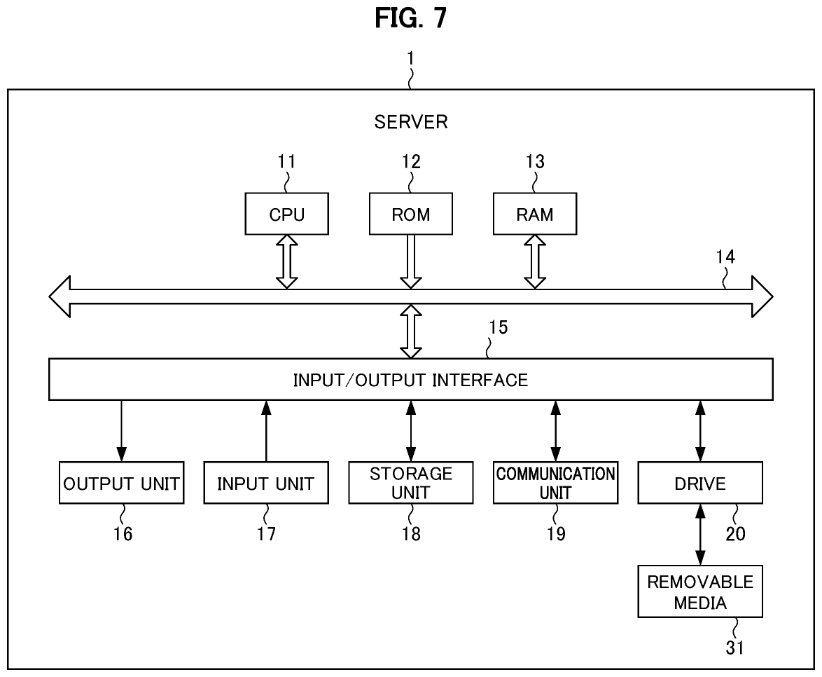

Next, an example of a hardware configuration of the server 1 included in the above-described information processing system will be described with reference to FIG. 7. FIG. 7 is a block diagram illustrating the hardware configuration of the server in the information processing system in FIG. 6.

The server 1 includes a central processing unit (CPU) 11, a read only memory (ROM) 12, a random access memory (RAM) 13, a bus 14, an input/output interface 15, an input unit 16, an output unit 17, a storage unit 18, a communication unit 19, and a drive 20.

The CPU 11 executes various kinds of processing according to a program recorded in the ROM 12 or a program loaded from the storage unit 18 to the RAM 13. Data necessary for the CPU 11 to execute various kinds of processing is stored in the RAM 13 as appropriate.

The CPU 11, ROM 12, and RAM 13 are interconnected via the bus 14. The bus 14 is also connected with the input/output interface 15. The input/output interface 15 is connected with the input unit 16, the output unit 17, the storage unit 18, the communication unit 19, and the drive 20.

The input unit 16 includes, for example, a keyboard, and allows input of various kinds of information. The output unit 17 includes a display such as a liquid crystal display, a speaker, and the like. The storage unit 18 includes a dynamic random access memory (DRAM) and the like, and stores various kinds of data. The communication unit 19 communicates with another device through the network N including the Internet.

A removable medium 21 including a magnetic disk, an optical disc, a magneto-optical disk, a semiconductor memory or the like is mounted on the drive 20 as appropriate. A program read from the removable medium 21 by the drive 20 is installed in the storage unit 18, if necessary. In addition, the removable medium 21 can store various kinds of data stored in the storage unit 18 in the same way as the storage unit 18. Although not illustrated, the client terminal 2 and the dispatcher terminal 3 in the information processing system in FIG. 6 have basically the same configuration as the hardware configuration illustrated in FIG. 7, and therefore description thereof will be omitted here.

The cooperation of various types of hardware such as a server 1 with various types of software enables execution of processing for producing or updating the virtual human resource O (hereinafter, referred to as “virtual human resource production or updating processing”) and processing by the virtual human resource O (hereinafter, referred to as “human resource dispatch processing”). The virtual human resource production or updating processing refers to a series of processes from accepting registration of the client information and the dispatcher information, to producing and updating the virtual human resource O in the server 1. In addition, the human resource dispatch processing refers to a series of processes from the environment setting required for the virtual human resource O to execute a task in the client C to executing the task and to receiving the training such as additional learning.

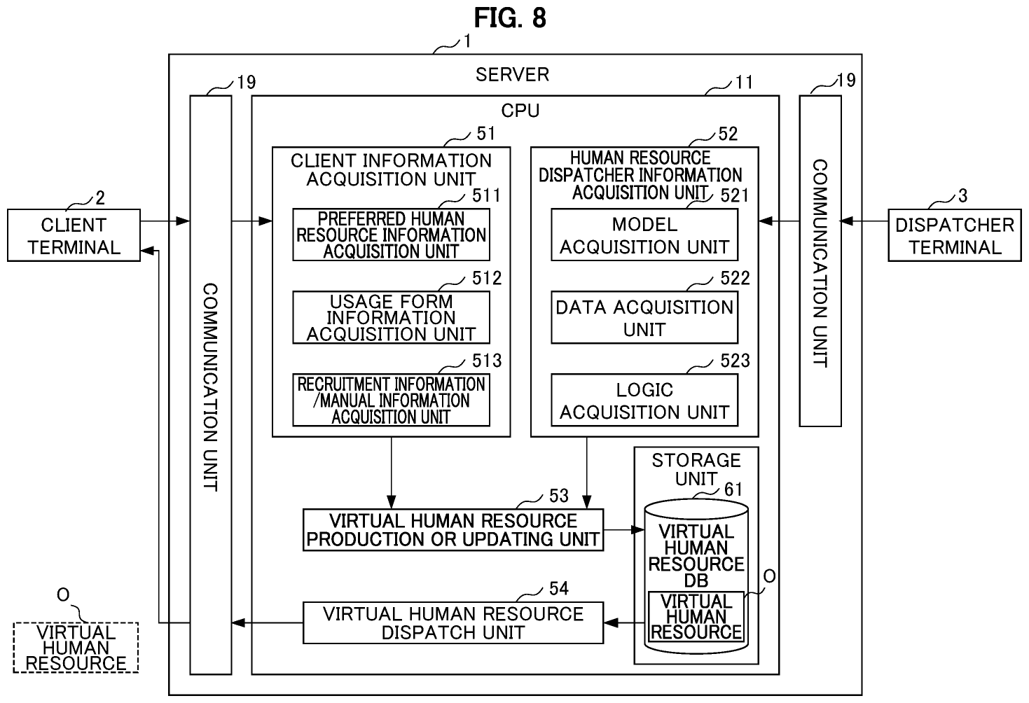

The server 1 has a functional configuration as illustrated in FIG. 8, to execute the virtual human resource production or updating processing. Then, hereinafter, the functional configuration for executing the virtual human resource production or updating processing to be executed in the server 1 and the like according to the present embodiment will be described with reference to FIG. 8.

FIG. 8 is a diagram illustrating an example of the functional configuration that functions when the virtual human resource production or updating processing is executed, among the functional configurations of the server in the information processing system in FIG. 7.

A virtual human resource DB 61 is provided in one region of the storage unit 18 in the server 1 illustrated in FIG. 8. In addition, various kinds of information about the virtual human resource O are stored in the virtual human resource DB 61.

When the virtual human resource production or updating processing is executed, a client information acquisition unit 51, a human resource dispatcher information acquisition unit 52, a virtual human resource production or updating unit 53, and a virtual human resource dispatch unit 54 function in the CPU 11 in the server 1.

The client information acquisition unit 51 includes a preferred human resource information acquisition unit 511, a usage form information acquisition unit 512, and a recruitment information/manual information acquisition unit 513. The preferred human resource information acquisition unit 511 acquires, from among the client information, information about a human resource sought by the client C (e.g., the ideal person image CI11 and the actual person CI12 in FIG. 1). The usage form information acquisition unit 512 acquires, from among the client information, information about a form of the virtual human resource O (e.g., the e-mail and chatbot CI21, the phone CI22, the video chat CI23, and the robot CI24 in FIG. 1) when various tasks are executed in the client C. The recruitment information/manual information acquisition unit 513 acquires, from among the client information, recruitment information representing specific work contents of the client C and information about a manual in which procedures standardized to execute a work are outlined (e.g., the company and organization purpose CI31, the job and work detail CI32, and the training and development information CI33 in FIG. 1).

The human resource dispatcher information acquisition unit 52 includes a model acquisition unit 521, a data acquisition unit 522, and a logic acquisition unit 523. The model acquisition unit 521 acquires, from among the dispatcher information, a model that retains internal information which is normally invisible, such as psychology, emotions, and values, in which the relationship of the information is organized to be modeled, a model that retains internal intellectual activity and information which is normally invisible, such as knowledge and thought, in which the relationship of the information is organized to be modeled, and a model in which a purpose or goal such as KGI and KPI with an individual or an organization serving as a unit, and its internal relationship are organized to be modeled (e.g., the internal model PM in FIG. 1). The data acquisition unit 522 acquires, from among the dispatcher information, data of contents to be learned that are subjected to priority level evaluation by sequencing the information necessary for developing the virtual human resource O, and a machine-readable semantic database having high resolution of semantic expression (e.g., the linguistic resource data PD in FIG. 1). The logic acquisition unit 523 acquires, from among the dispatcher information, a logic used when the virtual human resource O understands a thing or converses with the partner, a logic for determining how the virtual human resource O recognizes a thing from its own experience and knowledge, a logic for estimating a context for all information involved in a work to be executed by the virtual human resource O, a logic from which the virtual human resource O determines what utterance is to be generated or what action is to be taken for each scene of each work, a logic for generating specific appearance, voice, and the like of the virtual human resource O, a logic related to the management of the company confidentiality of the client C and mutual sharing of the knowhow among the virtual human resources, and the like (specifically, for example, various logics PL in FIG. 1).

The virtual human resource production or updating unit 53 produces and updates the virtual human resource O based on the acquired client information and dispatcher information. Then, the virtual human resource production or updating unit 53 stores information about the produced or updated virtual human resource O in the virtual human resource DB 61.

The virtual human resource dispatch unit 54 executes processing of dispatching the produced or updated virtual human resource O to the client C.

In summary, in the information processing system that produces the virtual human resource O to be dispatched from the human resource dispatcher P to the client C, when the human resource dispatcher information acquisition unit 52 acquires, as the dispatcher information, the data including at least the personalization summarization logic PL1, from among the information to be provided from the human resource dispatcher P, the virtual human resource production or updating unit 53 produces the virtual human resource O using the acquired dispatcher information. That is, the virtual human resource production or updating unit 53 uses the personalization summarization logic to produce the virtual human resource O capable of performing a paraphrase according to the status of the partner (the comprehension, available vocabularies and the like). As a consequence, this makes it possible to produce the virtual human resource O that can achieve the communication having high mutual comprehension with the partner in the client C.

As described above, the personalization summarization logic refers to an information system that can paraphrase the contents depending on the partner. Hereinafter, the personalization summarization logic will be specifically described by taking the word “eat” as an example.

For example, it is assumed to say to an infant, “Do not eat the block”. Since the infant has a few available vocabularies, the infant can understand neither the word “block” nor the word “eat”. Therefore, even when the infant is said, “Do not eat the block”, the infant cannot understand the sense. Therefore, first, an act of “eat” is divided into three elements (hereinafter, these elements are referred to as “key values”) constituting the sense according to a change in the states of a “subject” and an “object”. That is, the act of “eat” is dropped into the three elements: (1) the “subject” “brings to the mouth” the “object”; (2) the “subject” “puts in the mouth” the “object”; and (3) the “subject” “takes into the body” the “object”. Then, the combination of words is determined so that the thing to be conveyed to the infant among the three elements can be expressed in a state where the semantic lack is minimized. As a consequence, the sentence “Do not ‘eat’ the ‘block’” is paraphrased as the sentence “Do not ‘put in the mouth’ ‘this,’” for example. As described above, when the personalization summarization logic is adopted to produce or update the virtual human resource O, the contents to be conveyed to the partner is divided into the key values, thereby increasing semantic resolution, which makes it possible to produce the virtual human resource O capable of performing a paraphrase according to the status of the partner (the comprehension, available vocabularies and the like). The key values will be described later in detail with reference to FIG. 57.

In addition, the human resource dispatcher information acquisition unit 52 acquires, as the dispatcher information, the data represented in a “semantically normalized format” or a format convertible thereto, from among the information to be provided from the human resource dispatcher P. The virtual human resource production or updating unit 53 produces the virtual human resource O using the acquired dispatcher information.

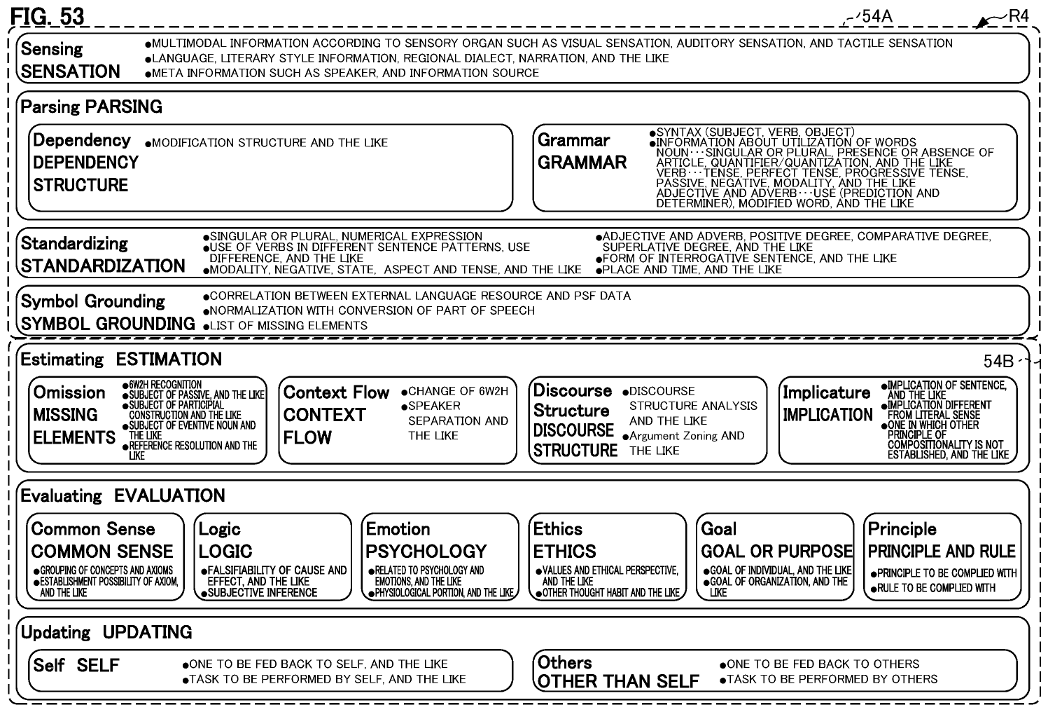

Here, as described above, the “semantically normalized format” refers to a semantic expression form with high machine readability so that the same sense is expressed by the same form, including natural language and programming language. Specific examples include AMR and N4. The N4 will be described later in detail with reference to FIG. 53.

That is, the virtual human resource production or updating unit 53 produces the virtual human resource O enabling communication based on the “visualized” intelligence by using the data represented in a “semantically normalized format” or a format convertible thereto. As a consequence, this makes it possible to produce the virtual human resource O that can achieve the communication having high mutual comprehension with the partner in the client C.

In addition, the human resource dispatcher information acquisition unit 52 acquires, as the dispatcher information, the data represented in a “semantically normalized format” or a format convertible thereto, the data including at least the personalization summarization logic, from among the information to be provided from the human resource dispatcher P. The virtual human resource production or updating unit 53 produces the virtual human resource O using the acquired dispatcher information. This makes it possible to produce the virtual human resource O capable of performing a paraphrase according to the status of the partner (the comprehension, available vocabularies and the like) and enabling communication based on the “visualized” intelligence. As a consequence, this makes it possible to achieve the communication having higher mutual comprehension between the virtual human resource O and the partner.

Note that the produced virtual human resource O can exchange the information with high resolution of semantic expression by using both of the personalization summarization logic PL1 and the PSF data PDP. As the effect, this makes it possible to further enhance the resolution if the comprehension for understanding the words of the conversation partner is low, to paraphrase the words as self-parsable words to thereby increase the comprehension level. On the other hand, when the words are output toward the conversation partner, the words can be selected according to the partner, whereby the level of the interactive communication is increased, and the mutual understanding with the partner can be further deepened. In addition, a recognizable function is provided by using in combination three of the personalization summarization logic PL1, the PSF data PDP, and the data represented in a “semantically normalized format” or a format convertible thereto, such as N4, which makes it possible to understand even the sarcasm, irony, metaphorical expression, and public opinion that cannot be understood easily based on the principle of compositionality because there is a difference between the meaning expressed through the letters and the speaker's true intent, whereby the mutual understanding with the partner can be further deepened. When the virtual human resource O outputs the speech through a task instruction unit 858, the individuality dependent avatar generation logic PL5 is used to change the expression of the face of the avatar according to the output contents, which makes it possible to provide the partner with such an impression as if the virtual human resource O has emotions. Furthermore, even when the speech input is accepted in such a manner as to hear the partner's speech as language, the expression of the face of the avatar can be changed as if the virtual human resource O actually sympathizes with and listens to the speech, whereby the mutual understanding with the partner can be further deepened. The virtual human resource O always estimates psychology, emotions, and values, and knowledge and thought of the conversation partner by using the psychology, emotions, and values internal model PM1, and the knowledge and thought internal model PM2, to determine an action so that the estimation result can be changed positively at all. Furthermore, similarly, the virtual human resource O estimates psychology, emotions, and values, and knowledge and thought of itself, to determine an action so that the estimation result can be changed positively at all, whereby the mutual understanding with the partner can be further deepened.

Furthermore, when the human resource dispatcher information acquisition unit 52 acquires, as the dispatcher information, the data including at least the plurality of internal models, from among the information to be provided from the human resource dispatcher P, the virtual human resource production or updating unit 53 produces the virtual human resource O using the acquired dispatcher information. However, at this time, each of the plurality of internal models is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship.

Here, the plurality of internal models include, as the model produced based on the first aspect, a first model (e.g., a psychology, emotions, and values internal model PM1) that retains human internal information including psychology, emotions, and values, in which the relationship of the information is organized to be modeled in a “semantically normalized format” or a format convertible thereto. The plurality of internal models include, as the model produced based on the second aspect, a second model (e.g., a knowledge and thought internal model PM2) that retains human internal intellectual activity and information including knowledge and thought, in which the relationship of the intellectual activity and information is organized to be modeled in a “semantically normalized format” or a format convertible thereto. The plurality of internal models include, as the model produced based on the third aspect, a third model (e.g., a purpose or goal internal model PM3), in which the purpose or goal including KGI and KPI with a human individual or an organization to which the human belongs serving as a unit, and its internal relationship are organized to be modeled in a “semantically normalized format” or a format convertible thereto.

In this way, the virtual human resource production or updating unit 53 produces the virtual human resource O based on the above-described internal models based on the first to third aspects. This makes it possible to produce the virtual human resource O that can set a wide range of purposes by estimating not only emotions but also the values of the partner, the purpose or goal of the organization, and knowledge and thought pattern. The above-described internal models are retained, which makes it possible to produce the virtual human resource O capable of offering continuous and stable response. As a consequence, a PDCA cycle, which will be described later, can be efficiently executed.

Providing all of the above-described functions in combination makes it possible to produce the virtual human resource O enabling the clarity of purpose and the deep understanding through the mutual understanding, or the virtual human resource O capable of clarifying the purpose while deepening the mutual understanding even if the purpose is not clarified.

In other words, the following virtual human resource O can be produced. That is, the virtual human resource O can autonomously recognize the purpose by having a conversation about information useful for the mutual understanding, and acquire information about what is information to be collected to achieve the purpose. The virtual human resource O can collect the information useful for the mutual understanding through communication, and perform an operation for achieving the purpose using the collected information. The virtual human resource O can check whether the purpose has been achieved by the operation, and, if the purpose is not achieved, can collect what information is necessary for analyzing the result and collect the information useful for the mutual understanding through communication. The virtual human resource O can achieve the purpose by additionally performing an operation for achieving the purpose using the collected information and repeating the above-described operations.

There has been described with reference to FIG. 8, the functional configuration that functions when the virtual human resource production or updating processing is executed, among the functional configurations of the server in the information processing system in FIG. 7. Next, a functional configuration and an overview of human resource dispatch processing executed by the virtual human resource O of the present service in FIG. 1 will be described with reference to FIGS. 9 and 10. FIG. 9 is a diagram illustrating an example of the functional configuration that functions when the human resource dispatch processing is executed, among the functional configurations of the server in the information processing system in FIG. 7.

When the human resource dispatch processing is executed, an environment setting unit 81, a training unit 82, and a task execution unit 83 function in the virtual human resource O of the storage unit 18.

The environment setting unit 81 accepts environment setting necessary for the virtual human resource O to execute a task in the client C. That is, for example, the environment setting unit 81 sets an access point for using the virtual human resource O for each usage form, selects an execution permission API which can be executed by the virtual human resource O, registers a company API, registers an API which is prepared or selected by a company, registers a site of a crowdsourcing type at which a task is processed, registers ordering candidate company by which a task is processed, registers a specialized staff, and registers correlation information between a massage generated by an utterance and task instruction unit 834 in the task execution unit 83, which will be described later, and an action to be activated at that time.

The training unit 82 accepts the registration of the information necessary for the virtual human resource O to perform additional learning, and various kinds of information necessary to share knowhow among the virtual human resources O dispatched to the client C. The training unit 82 includes a knowledge category dependent training unit 821, and an inter-human resource information sharing unit 822. The knowledge category dependent training unit 821 performs the additional learning to increase the comprehension level of the virtual human resource O for each knowledge category based on the visualized intelligence of the virtual human resource O through the internal model PM. In the present invention, the state of the comprehension level for each knowledge category of the virtual human resources O is visualized, whereby the training of the virtual human resource O can be additionally performed. This can improve the function of the virtual human resource O.

The inter-human resource information sharing unit 822 controls the sharing of the knowhow among the virtual human resources O dispatched to the client C. That is, the inter-human resource information sharing unit 822 can control whether to share the knowhow or the knowledge among the virtual human resources O while reflecting the privacy problem and the securing of the diversity of the human resource engaging in the work.

The task execution unit 83 controls execution of a task of the virtual human resource O. The task execution unit 83 includes an objective interpretation unit 831, a subjective interpretation unit 832, an utterance contents examination and generation unit 833, and an utterance and task instruction unit 834. Note that the details of the function of each block in the task execution unit 83 will be described together with the description in FIG. 10.

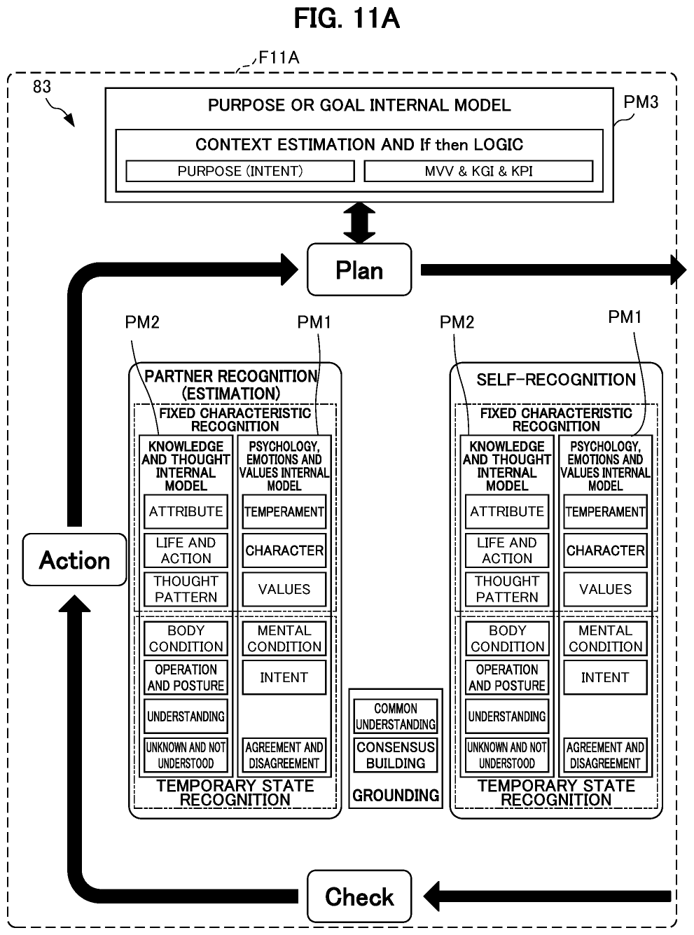

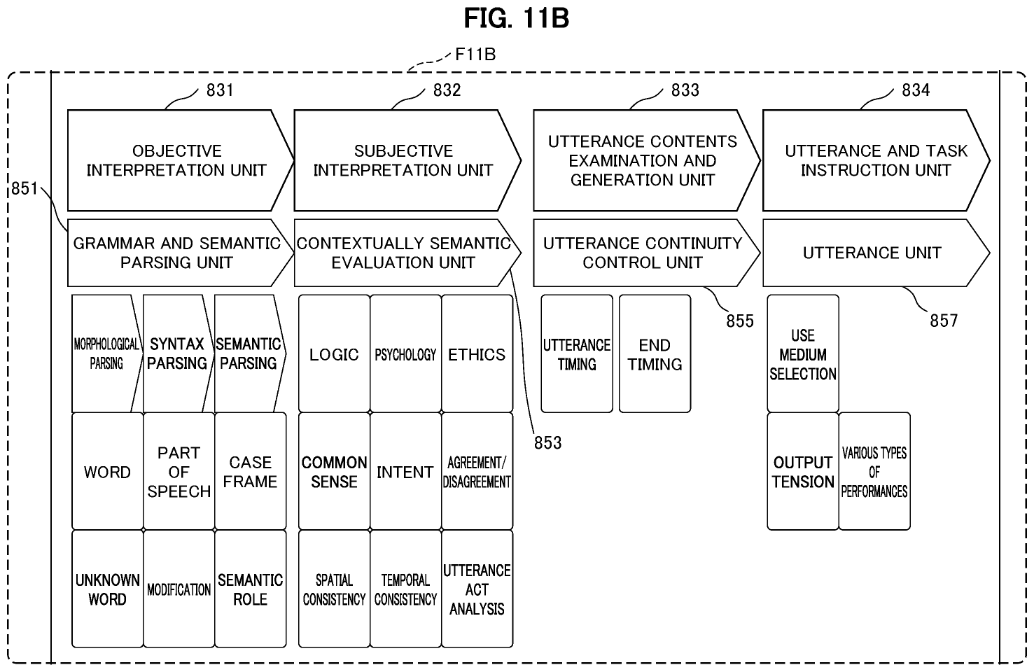

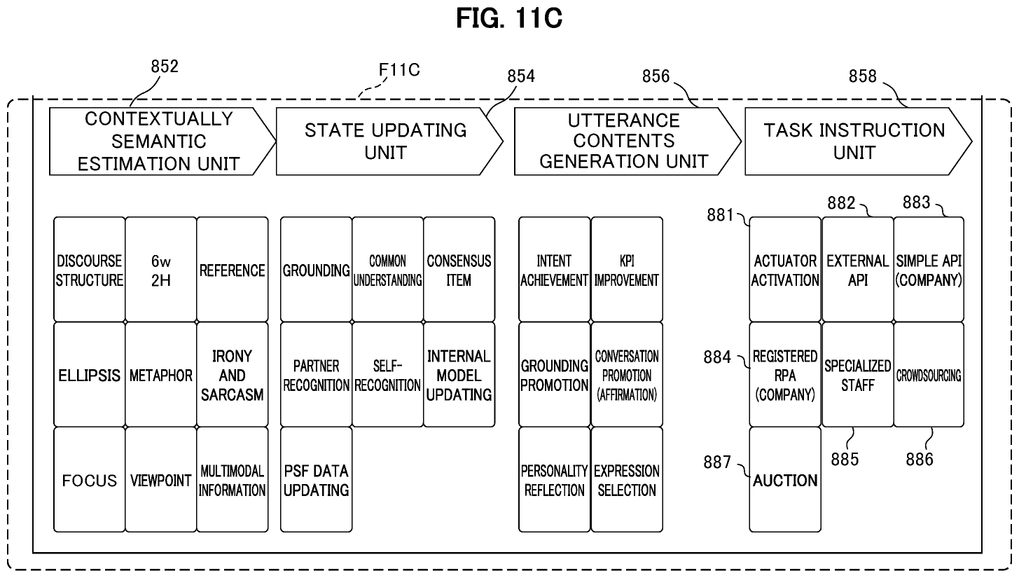

FIG. 10 is a diagram illustrating an overview of a task to be executed by the virtual human resource of the present service in FIG. 1. FIGS. 11A and 11C each are a split view of the diagram illustrating an overview of a task to be executed by the virtual human resource of the present service illustrated in FIG. 10.

The execution of the task by the virtual human resource O in the task execution unit 83 is achieved by repeatedly executing a plan-do-check action cycle (PDCA cycle) as illustrated in FIG. 10. That is, when the virtual human resource O executes the task, first, the information useful for mutual understanding between the partner and the virtual human resource O itself is acquired by conversation between them, whereby the purpose is autonomously recognized, and information is acquired about what is information necessary to achieve the purpose (Plan). Then, such information is collected through communication, and an operation for achieving the purpose is performed (Do). Then, it is checked whether the purpose has been achieved by such an operation (Check), and if the purpose is not achieved, the information necessary for analyzing the result is acquired through communication, and an operation for achieving the purpose is additionally performed (Action).

In such a PDCA cycle, the psychology, emotions, and values internal model PM1, the knowledge and thought internal model PM2, and the purpose or goal internal model PM3 are combined and applied. Hereinafter, an application example of such internal models PM to the PDCA cycle will be described in more detail.

First, as “Plan”, the purpose is autonomously recognized when the virtual human resource O executes the task. Here, the purpose to be autonomously recognized is set in multiple layers as described in (1) to (5) below based on the psychology, emotions, and values internal model PM1, the knowledge and thought internal model PM2, and the purpose or goal internal model PM3.

(1) The virtual human resource O recognizes the action conforming to the intent of the speaker as a purpose, based on the knowledge and thought internal model PM2. That is, in the virtual human resource O, the knowledge and thought of the partner and the virtual human resource O itself are always estimated, and the estimated information is acquired, whereby the virtual human resource O can take the conversation and action conforming to a wide range of purposes including, for example, a purpose of reinforcing the knowledge of the partner, and a purpose of reinforcing the specific thought pattern of the partner.

(2) The virtual human resource O recognizes the action conforming to the KGI/KPI of the client C or the like as a purpose, based on the purpose or goal internal model PM3. This enables the virtual human resource O to aim to achieve KGI of the client C and take the conversation and action conforming to the purpose of reinforcing the specific KPI.

(3) The virtual human resource recognizes the mutual understanding/consensus with the partner as a purpose, based on the knowledge and thought internal model PM2. This enables the virtual human resource O to take the conversation and action conforming to the purpose of increasing a common understanding portion and a consensus portion with the partner.

(4) The virtual human resource O recognizes the improvement in the psychology, emotions, and values as a purpose, based on the psychology, emotions, and values internal model PM1. That is, the virtual human resource O always estimates the psychology, emotions, and values of the partner and the virtual human resource O itself and acquires the estimated information, which makes it possible to take the conversation and action conforming to a wide range of purposes including, for example, a purpose of setting the emotions of the partner to a specific state, and a purpose of reinforcing the specific values of the partner.

(5) The virtual human resource O recognizes the action based on the physiology and three laws of robotics as a purpose, based on the psychology, emotions, and values internal model PM1. This enables the virtual human resource O to take the conversation and action based on the three laws of robotics.

When the internal models PM are thus applied, the purposes are constituted in multiple layers, whereby a frame problem can be effectively solved. Then, “Do” is performed as an operation for achieving such purposes.

When the operation (Do) for achieving the purposes is performed, in the task execution unit 83, each of the objective interpretation unit 831, the subjective interpretation unit 832, the utterance contents examination and generation unit 833, and the utterance and task instruction unit 834 exerts its function.

In the objective interpretation unit 831, a grammar and semantic parsing unit 851 and a contextually semantic estimation unit 852 function. The grammar and semantic parsing unit 851 performs morphological parsing, syntax parsing, and semantic parsing on the words of the partner who performs the interaction. That is, this enables parsing in an expression form in which the semantic lack is reduced based on the semantically normalized format, by performing parsing based on the machine-readable semantic database represented in a “semantically normalized format” or a format convertible thereto. As a consequence, the intellectual ability of the virtual human resource O can be improved, and the discrepancies in semantic interpretation can be reduced. This can solve the problems of the conventional technologies. That is, according to the present invention, the conventionally existing problems can be solved including a problem in that the End to End deep learning or the like is a black box and the ratio of semantic lack is large, and a problem in that in a pipeline connecting various tools, the absences of a unified format and a semantic database with high semantic resolution cause low quality.

The contextually semantic estimation unit 852 performs the semantic estimation in context units about the words of the partner who performs the interaction, using a discourse structure and context estimation (6W2H), and the interpretation, focus, and viewpoint of words such as reference resolution, ellipsis estimation, metaphor and irony, and sarcasm which are not applicable to the principle of compositionality, and further the multimodal information other than the character information, based on the results in the grammar and semantic parsing unit 851. That is, the contextually semantic estimation unit 852 performs the parsing based on the context, by utilizing the results of the grammar and semantic parsing unit 851 with low semantic lack ratio and by utilizing the context estimation logic PL3 acquired by the logic acquisition unit 523 of the human resource dispatcher information acquisition unit 52. As a consequence, the discrepancies in semantic interpretation can be reduced, and the intellectual ability of the virtual human resource O can be improved. As a result, it is possible to solve the problem of recognizing the context.

In the subjective interpretation unit 832, a contextually semantic evaluation unit 853, and a state updating unit 854 function. The contextually semantic evaluation unit 853 positively performs the semantic evaluation based on the results in the grammar and semantic parsing unit 851 and the contextually semantic estimation unit 852 of the objective interpretation unit 831, and temporarily determines the semantic interpretation at the time of evaluation. To temporarily determine such semantic interpretation, the purpose or goal internal model PM3, the psychology, emotions, and values internal model PM1, and the knowledge and thought internal model PM2 that are always estimated by optimizing the internal model PM are utilized. It is important for the virtual human resource O to find out the intent of the partner and confirm the intent of the partner to execute the work, and determining the intent of the partner even temporarily can lead to the determination of subsequent action, whereby the PDCA cycle can work efficiently. As a consequence, it can be expected that the task execution capability of the virtual human resource O can be improved. Since a desired parsing result based on the context can be acquired by the contextually semantic estimation unit 852, the contextually semantic evaluation unit 853 can perform more practical semantic evaluation based on the result. That is, since the context can be evaluated by utilizing the contents of the purpose or goal, and the psychology, emotions, and values, and the knowledge and thought of the partner and the virtual human resource O itself, it makes it possible to reduce the discrepancies in semantic interpretation, and improve the intellectual ability of the virtual human resource O.

The state updating unit 854 estimates the status of grounding mainly regarding the common understanding and consensus building based on the estimation results of the internal model PM through interaction and communication with the partner, and updates the state of the virtual human resource O in a direction in which the levels of the partner recognition and the self-recognition can be deepened. The state updating unit 854 updates the internal model PM and updates the PSF data PDP with respect to unknown information. That is, the state updating unit 854 updates the internal model PM with respect to the purpose or goal, and the psychology, emotions, and values, and the knowledge and thought of the partner and the virtual human resource O itself, and updates PSF with respect to the machine-readable semantic database having high resolution of semantic expression. Therefore, when compared with the conventional method which is not intended for updating information for reference only, the present invention makes it possible to improve the intellectual ability of the virtual human resource O while always recognizing the status of grounding such as the common understanding and the consensus status and process the unknown information or the like to perform self-growth.

In the utterance contents examination and generation unit 833, an utterance continuity control unit 855, and an utterance contents generation unit 856 function. The utterance continuity control unit 855 always monitors the utterance timing at which the utterance is started in the interaction between the partner and the virtual human resource O itself and an end timing at which the utterance is ended, and utilizes the monitored timings for next action of the virtual human resource O itself. Thus, mutual utterance can be made smooth.

The utterance contents generation unit 856 generates utterance contents using the estimation results of the internal model PM. Furthermore, regardless of the estimation of the intent of the partner and the promotion of KPI improvement, the common understanding portion and consensus portion are always increased to promote the grounding, and affirmation or rumination is performed to smooth the conversation to increase the level of information exchange. Furthermore, the utterance contents generation unit 856 reflects the personality to offer a response based on the individuality of the produced virtual human resource O, and then selects the expression to adjust the utterance contents. In the conventional technologies, the intent of the conversation partner is estimated by the intent slot type chatbot or the like in a status where the intent of the partner is extremely limited, and the utterance contents are generated only to execute the presentation of the likely information and the action. Thus, according to the present invention, the estimation results of the internal model PM are used, whereby the virtual human resource O can estimate the intent of the partner and promote the KPI improvement of the entire organization, and further can increase the common understanding portion and consensus portion to promote the grounding. As a consequence, the virtual human resource O can achieve smoother communication than that in the conventional technologies.

The utterance and task instruction unit 834 generates an utterance and task instruction which is a message instructing a task readable by a human, and makes the utterance, the API execution, and the operation based on the message. In the conventional technologies, the speech assistant executes a skill set in an intent slot type, and ends its role. No interface is provided, such as a message readable by a human even when an external function is activated. Thus, according to the present invention, the utterance and task instruction which is a message instructing a task readable by a human is generated, which makes it possible to efficiently activate an actuator, and execute an external API, and a company registration API.

More specifically, in the utterance and task instruction unit 834, an utterance unit 857 and the task instruction unit 858 function. The utterance unit 857 selects a use medium from among the media to optimize output of the contents generated by the utterance contents generation unit 856, and then adjusts the output tension and performs various types of performances to increase the level of conveyance to the partner, thereby providing impressions in a desired direction. When how to convey is thus devised, the virtual human resource O can increase the efficiency of the conveyance to the partner.

The task instruction unit 858 makes the utterance, the API execution, and the operation based on the message instructing a task. The task instruction unit 858 specifically includes an actuator activation unit 881, an external API activation unit 882, a company registration API (simple type) activation unit 883, a company registration API (registered RPA type) activation unit 884, a specialized staff type activation unit 885, a crowdsourcing type activation unit 886, an auction type activation unit 887, and the like.

To cause the robot to perform a specific action, the actuator activation unit 881 provides an appropriate instruction to the actuator of the robot, based on the task instruction, in a method correlated with the robot registration function RR of the human resource dispatcher-specific virtual human resource management function PA in advance. That is, when compared with the conventional method, there is a difference in that the actuator moves according to the message generated by the utterance and task instruction SD described in a natural language readable by a human. In this way, in the actuator activation unit 881, the robot (e.g., the virtual human resource OR that processes a task in the form of a robot) can be associated in a natural manner with the conversation contents by correlating the massage generated by the utterance and task instruction SD and a function of activating the actuator of each robot.

To activate an appropriate external API according to the task instruction, the external API activation unit 882 activates the external API selected in the utterance and task instruction unit 834 from among the APIs selected as executable APIs in the environment setting unit 81 (the client-specific task execution environment setting function T1) with respect to the APIs registered by the external API registration function AR in the human resource dispatcher-specific virtual human resource management function PA in advance. When an appropriate action of the external API is not selected for the task, a task instruction accelerating the selection is regenerated, and the external API is activated as a correct action in the environment setting unit 81 (the client-specific task execution environment setting function T1) via the specialized staff type activation unit 885, which will be described later. This enables the virtual human resource O to execute the work by easily using the external API in association with the utterance and task instruction.

To activate an appropriate company registration API according to the task instruction, the company registration API (simple type) activation unit 883 activates the API selected in the utterance and task instruction unit 834 from among the company APIs registered in the environment setting unit 81 (the client-specific task execution environment setting function T1). Such an API is defined as a company registration API (simple type). When an appropriate action of the company registration API is not selected for the task, a task instruction accelerating the selection is regenerated, and the company registration API (simple type) is activated as a correct action in the environment setting unit 81 (the client-specific task execution environment setting function T1) via the specialized staff type activation unit 885, which will be described later. This enables the virtual human resource O to execute the work by easily using the company registration API (simple type) in association with the utterance and task instruction.

To activate, as an API, an executable file recording automated processing by an appropriate RPA according to the task instruction, the company registration API (registered RPA type) activation unit 884 activates the company registration API (registered RPA type) selected in the utterance and task instruction unit 834 from among the company APIs registered in the environment setting unit 81 (the client-specific task execution environment setting function T1). When an appropriate action of the company registration API is not selected for the task, a task instruction accelerating the selection is regenerated, and the company registration API (registered RPA type) is activated as a correct action in the environment setting unit 81 (the client-specific task execution environment setting function T1) via the specialized staff type activation unit 885, which will be described later. This enables the virtual human resource O to execute the work by easily using the company registration API (registered RPA type) in association with the utterance and task instruction.

To cause an appropriate specialized staff to execute a task according to the task instruction, the specialized staff type activation unit 885 transmits the task to the specialized staff registered in a specialized staff registration function of the client-specific task execution environment setting function T1. When an appropriate action of the specialized staff type processing is not selected for the task, a task instruction accelerating the selection is regenerated, and a task request is transmitted to the specialized staff as a correct action in the environment setting unit 81 (the client-specific task execution environment setting function T1). That is, when compared with the conventional method, there is a difference in that the specialized staff is requested to execute the task according to the human-readable message generated in an utterance and task instruction function described in natural language processing. Note that the specialized staff type activation unit 885 transmits the first task request to an administrator. This enables the virtual human resource O to execute the work by requesting the specialized staff to execute the task, the specialized staff being easily registered in association with the utterance and task instruction.

To cause an appropriate crowdworker to execute a task according to the task instruction, the crowdsourcing type activation unit 886 transmits the task to the crowdsourcing destination registered in the environment setting unit 81 (the client-specific task execution environment setting function T1). That is, when compared with the conventional method, there is a difference in that the crowdsourcing type site is requested to execute the task according to the human-readable message generated in the utterance and task instruction function. When an appropriate action of the crowdsourcing type processing is not selected for the task, a task instruction accelerating the selection is regenerated, and a task request is transmitted to the crowdsourcing destination as a correct action in the environment setting unit 81 (the client-specific task execution environment setting function T1) via the specialized staff type activation unit 885. This enables the virtual human resource O to execute the work by requesting the crowdsourcing type site to execute the task, the crowdsourcing type site being easily registered in association with the utterance and task instruction.

To cause an appropriate crowdworker to execute a task according to the task instruction, the auction type activation unit 887 transmits an auction bidding request to the ordering candidate company registered in the environment setting unit 81 (the client-specific task execution environment setting function T1). That is, when compared with the conventional method, there is a difference in that the auction type site is requested to execute the task according to the human-readable message generated in the utterance and task instruction function. When an appropriate action of the auction type processing is not selected for the task, a task instruction accelerating the selection is regenerated, and an auction bidding request is transmitted to the ordering candidate company as a correct action in the environment setting unit 81 (the client-specific task execution environment setting function T1) via the specialized staff type activation unit 885.

Next, as “Check”, it is checked whether the purpose set by “Plan” has been achieved.

(1) As to whether an action conforming to the intent of the speaker is taken, for example, (A) it is checked whether the virtual human resource O can grasp the intent of the speaker by checking reaction of the partner after performing the rumination according to the intent contents on the speaker. Alternatively, (B) it may be checked whether the virtual human resource O can grasp the intent of the speaker by asking, to the speaker, a question about satisfaction with the action performed according to the intent, for example, “Is this correct?”.

Furthermore, (2) as to whether the KGI/KPI of the client C or the like is directed toward plus, for example, (A) since in the virtual human resource O, a change in the KGI/KPI is always predicted in the purpose or goal internal model PM3, it may be checked whether the KGI/KPI of the client C or the like is directed toward plus as the self-recognition of the virtual human resource O. Alternatively, (B) it may be checked whether the KGI/KPI of the client C or the like is directed toward plus by checking reaction of the speaker to a question for checking the contents of the change in the KPI.

Furthermore, (3) as to whether the mutual understanding/consensus with the partner has been reached, for example, (A) it may be checked whether in the virtual human resource O, a difference in the estimation result of the common understanding and consensus between before and after the task is executed is increased. Alternatively, (B) it may be checked whether the mutual understanding/consensus with the speaker is increased by asking, to the speaker, a question to check the contents of the common understanding and consensus by watching the speaker's reaction, for example, “Is this correct?”.

Furthermore, (4) as to whether the psychology, emotions, and values are improved, and the action is performed based on the physiology and three laws of robotics, for example, (A) it may be checked whether a difference in the estimation result of the psychology, emotions, and values between before and after the task is executed as the self-recognition of the virtual human resource O is increased. Alternatively, (B) it may be checked whether the psychology, emotions, and values are improved by checking reaction of the speaker to a question for checking the psychology, emotions, and values. Alternatively, since the psychological mind of the speaker shows through, (C) it may be checked whether the psychology, emotions, and values are improved based on the information of a visual sensation, an auditory sensation, and the like in multimodal processing. When such checks are performed, Action is executed.

“Action” is executed by applying the If then rule logic PL4, based on the internal model PM updated in the above-described cycle.

As described above, the execution of the task by the virtual human resource O can be achieved by repeating the efficient PDCA process through communication with high level of mutual understanding. There have been described with reference to FIGS. 9 and 10, the overview and functional configuration of the human resource dispatch processing executed by the virtual human resource O of the present service in FIG. 1.

In summary, the virtual human resource O to be dispatched from the human resource dispatcher P to the client C is produced by using, as the dispatcher information, the data including at least the personalization summarization logic PL1, among the information to be provided from the human resource dispatcher P. The task execution unit 83 of the virtual human resource O uses a plurality of internal models to enable a task instruction to be issued in a form of a message readable by a human, thereby executing a predetermined task while interacting with the human. That is, the virtual human resource O capable of performing a paraphrase according to the status of the partner (the comprehension, available vocabularies and the like) uses the internal models PM to enable a task instruction to be issued in a form of a message readable by a human. As a consequence, the virtual human resource O can achieve the communication having high mutual comprehension with the partner in the client C.

The virtual human resource O to be dispatched from the human resource dispatcher P to the client C is produced using, as the dispatcher information, data represented in a “semantically normalized format” or a format convertible thereto among the information to be provided from the human resource dispatcher P. The task execution unit 83 of the virtual human resource O uses the plurality of internal models to enable a task instruction to be issued in a form of a message readable by a human, thereby executing a predetermined task while interacting with the human. That is, the virtual human resource O enabling communication based on the “visualized” intelligence in all aspects uses the internal models PM to enable a task instruction to be issued in a form of a message readable by a human. As a consequence, the virtual human resource O can achieve the communication having high mutual comprehension with the partner in the client C.

The virtual human resource O to be dispatched from the human resource dispatcher P to the client C is produced using, as the dispatcher information, data represented in a “semantically normalized format” or a format convertible thereto, the data including at least the personalization summarization logic PL1, among the information to be provided from the human resource dispatcher P, and the task execution unit 83 of the virtual human resource O uses a plurality of internal models to enable a task instruction to be issued in a form of a message readable by a human, thereby executing a predetermined task while interacting with the human. That is, the virtual human resource O can perform a paraphrase according to the status of the partner (the comprehension, available vocabularies and the like), and enables communication based on the “visualized” intelligence, which makes it possible to achieve the communication having high mutual comprehension with the partner in the client C.

The virtual human resource O to be dispatched from the human resource dispatcher P to the client C is produced using, as the dispatcher information, data including at least a plurality of internal models among the information to be provided from the human resource dispatcher P, and each of the plurality of internal models is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship. Furthermore, the task execution unit 83 of the virtual human resource O sets up a plan using a model produced based on the third aspect while involving self-recognition and partner recognition using models produced based on the first aspect and the second aspect, executes a predetermined task while interacting with a human to achieve the plan, evaluates the result of the execution, and performs improvement based on the result of the evaluation.

The plurality of internal models include, as the model produced based on the first aspect, a first model (e.g., the psychology, emotions, and values internal model PM1) that retains human internal information including psychology, emotions, and values, in which the relationship of the information is organized to be modeled in a “semantically normalized format” or a format convertible thereto. The plurality of internal models include, as the model produced based on the second aspect, a second model (e.g., the knowledge and thought internal model PM2) that retains human internal intellectual activity and information including knowledge and thought, in which the relationship of the intellectual activity and information is organized to be modeled in a “semantically normalized format” or a format convertible thereto. The plurality of internal models include, as the model produced based on the third aspect, a third model (e.g., the knowledge and thought internal model PM2), in which the purpose or goal including KGI and KPI with a human individual or an organization to which the human belongs serving as a unit, and its internal relationship are organized to be modeled in a “semantically normalized format” or a format convertible thereto. That is, since the virtual human resource O capable of estimating the values of the partner, the purpose or goal of the organization, and knowledge and thought pattern can set a wide range of purposes in multiple layers, a frame problem can be effectively solved, and since it is possible to offer continuous and stable response to the partner, high level of response can be offered. As a consequence, the virtual human resource O can efficiently execute the PDCA cycle.

In other words, the virtual human resource O can set a wide range of purposes by estimating not only emotions but also the values of the partner, the purpose or goal of the organization, and knowledge and thought pattern. In addition, retaining the above-described internal models enables the virtual human resource O to offer continuous and stable response. As a consequence, the virtual human resource O can efficiently execute the PDCA cycle.

The virtual human resource O with all of the above-described functions enables the clarity of purpose and the deep understanding through the mutual understanding. That is, the virtual human resource O can clarify the purpose while deepening the mutual understanding even if the purpose is not clarified.

In other words, the virtual human resource O can autonomously recognize the purpose by having a conversation about the information useful for the mutual understanding, and acquire information about what is information to be collected to achieve the purpose. The virtual human resource O can collect the necessary information through smooth communication using conversation about the information useful for the mutual understanding, and perform an operation for achieving the purpose using the collected information. The virtual human resource O can check whether the purpose has been achieved by the operation, and, if the purpose is not achieved, can collect what information necessary for analyzing the result and collect the necessary information through smooth communication using conversation about the information useful for the mutual understanding. The virtual human resource O can achieve the purpose by additionally performing an operation for achieving the purpose using the collected information and repeating the above-described operations.

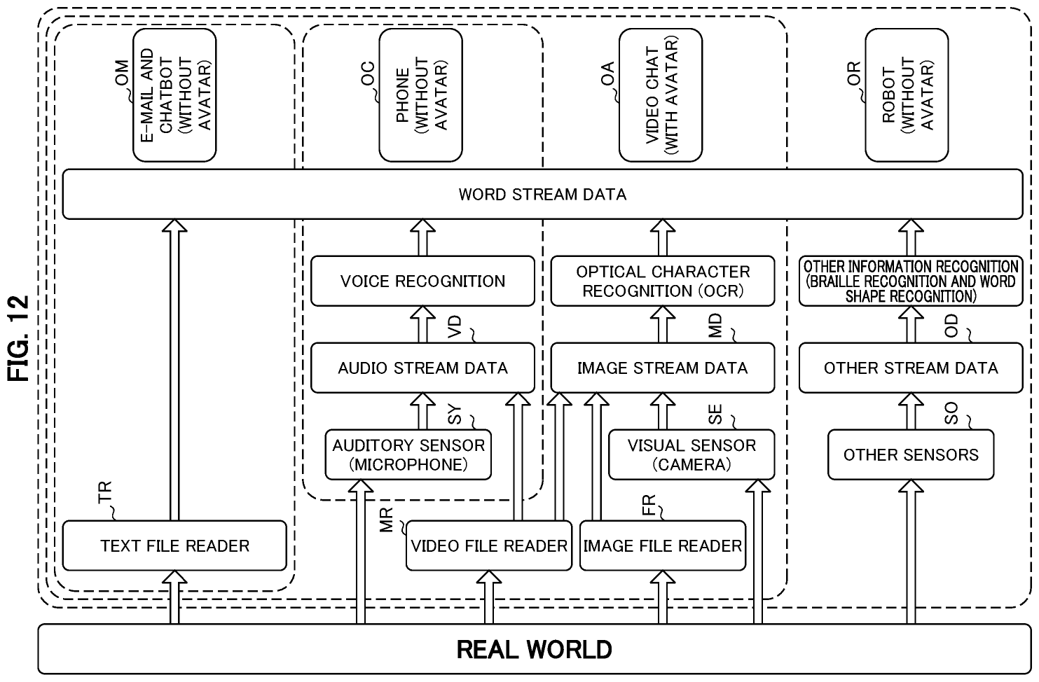

Next, a sensor (perception) of the virtual human resource O and a flow of a multimodal information input to the virtual human resource O will be described with reference to FIG. 12. FIG. 12 is a diagram illustrating various sensors of the virtual human resource of the present service in FIG. 1 and an overview of an information input flow to the virtual human resource.

An organism (including virtual personality) lives in the world (hereinafter, referred to as an “Umwelt”) constrained by its own sensors (perception). That is, all organisms (including the virtual personality) are said to be able to understand the world only by their own perception (a sensor). In the Umwelt for a human, a human has, as special sensations, an auditory sensation (a sound sensor), a visual sensation (a color sensor, a shape change sensor, an amount change sensor, a position sensor), olfaction (odor, smell, a fragrance sensor), taste (taste sensor (sour taste, salty taste, sweet taste, bitter taste, umami taste)), and has, as somatic sensations, a skin sensation (a tactile sensation, pain, a temperature sensation), proprioception (a pressure sensation, a position sensation, a muscles/kinesthetic sensation), and has, as visceral sensations, a hunger/satiety sensation, and uresiesthesia/urge to defecate. On the other hand, in the Umwelt for the virtual personality, the virtual human resource O can take a conversation and an action based on an auditory sensation (a sound sensor), a visual sensation (a color sensor, a shape change sensor, an amount change sensor, a position sensor), olfaction (an odor, smell, and fragrance sensor), a tactile sensation, a temperature sensation, a pressure sensation, and a position sensation. That is, the virtual human resource O executes a task based on the information acquired by its own sensors (perception) including, for example, an auditory sensor (e.g., a microphone), a visual sensor (e.g., a camera), and the other sensors (e.g., an odor, smell, and fragrance sensor, a tactile sensor, a temperature sensation sensor, a pressure sensor, and a position sensation sensor).

Specifically, for example, as illustrated in FIG. 12, the virtual human resource OM that executes a task in a form of e-mail and chatbot executes a task based on the text information acquired by a text file reader TR. The virtual human resource OC that executes a task in a form of a phone executes a task based on the information output by voice recognizing the audio stream data VD acquired by a video file reader MR or its own auditory sensor SY (e.g., a microphone). The virtual human resource OA that executes a task in a form of a video chat executes a task based on the information output by subjecting, to optical character recognition (OCR) processing, the image stream data MD acquired from the video file reader MR, an image file reader FR, and a visual sensor SE (e.g., a camera). The virtual human resource OR that processes a task in the form of a robot executes a task based on the information output by subjecting, to other information recognition (e.g., braille recognition, and word shape recognition) processing, the stream data OD acquired from the other sensors SO (e.g., an odor, smell, and fragrance sensor, a tactile sensor, a temperature sensation sensor, a pressure sensor, and a position sensation sensor). This enables the virtual human resource O to execute various tasks according to the usage form, based on its own sensors (perception).

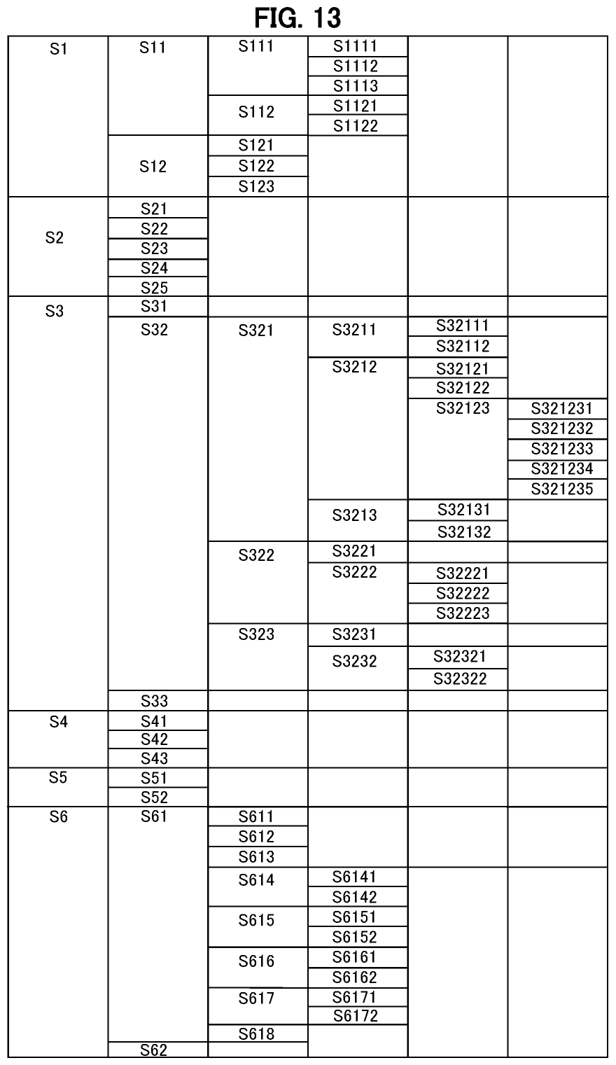

There have been described the sensors (perception) of the virtual human resource O and the flow of the multimodal information input to the virtual human resource O. Next, flows of the virtual human resource production or updating processing and the human resource dispatch processing (hereinafter, these are collectively referred to as “overall processing”) to be executed by the server 1 having the functional configurations in FIGS. 8 and 9 will be described in more detail with reference to FIGS. 13 to 39.

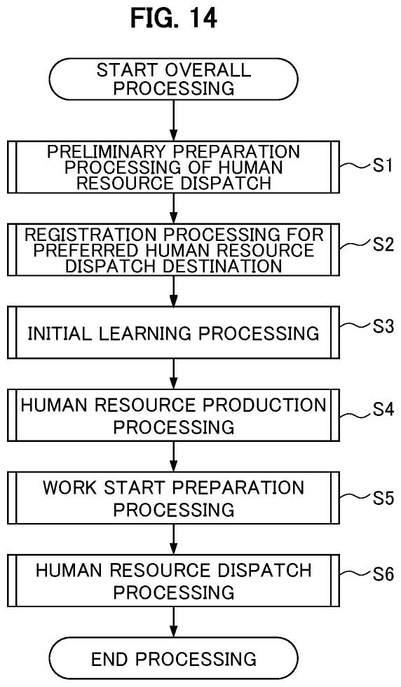

FIG. 13 is a diagram illustrating a correspondence between each step of the overall processing and each figure. The correspondence between each step of the overall processing and FIGS. 14 to 36 is as illustrated in FIG. 13.

FIG. 14 is a flowchart illustrating a flow of the overall processing to be executed by the server 1.

In step S1 in FIG. 14, the human resource dispatcher information acquisition unit 52 in FIG. 8 performs preliminary preparation for producing the virtual human resource O. Such processing of step S1 is hereinafter referred to as “preliminary preparation processing of human resource dispatch”.

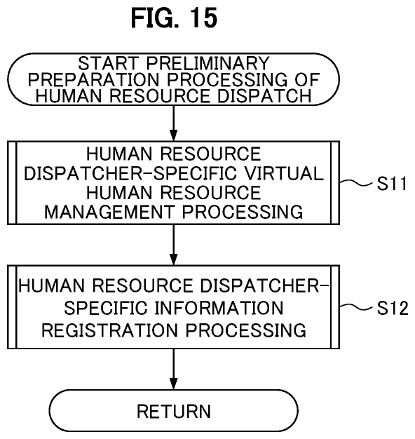

In FIG. 15, an example of the details of the preliminary preparation processing of human resource dispatch of step S1 in the overall processing in FIG. 14 will be described. FIG. 15 is a flowchart illustrating an example of the details of the preliminary preparation processing of human resource dispatch of step S1 in the overall processing in FIG. 14.

In step S11 in FIG. 15, the human resource dispatcher information acquisition unit 52 manages various kinds of information for producing the virtual human resource O. Such processing of step S11 is hereinafter referred to as “human resource dispatcher-specific virtual human resource management processing”.

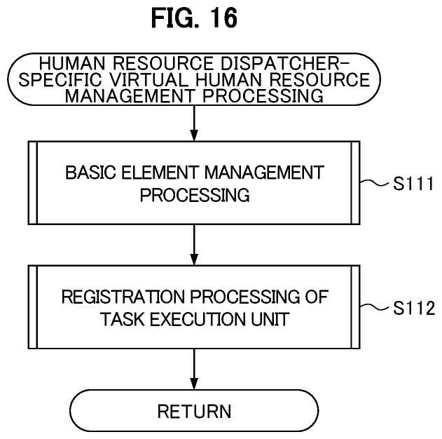

Next, in FIG. 16, an example of the details of the human resource dispatcher-specific virtual human resource management processing of step S1 in the preliminary preparation processing of human resource dispatch in FIG. 15 will be described. FIG. 16 is a flowchart illustrating an example of the details of the human resource dispatcher-specific virtual human resource management processing of step S11 in the preliminary preparation processing of human resource dispatch in FIG. 15.

In step S111 in FIG. 16, the human resource dispatcher information acquisition unit 52 manages basic elements for producing the virtual human resource O. Such processing of step S111 is hereinafter referred to as “basic element management processing”.

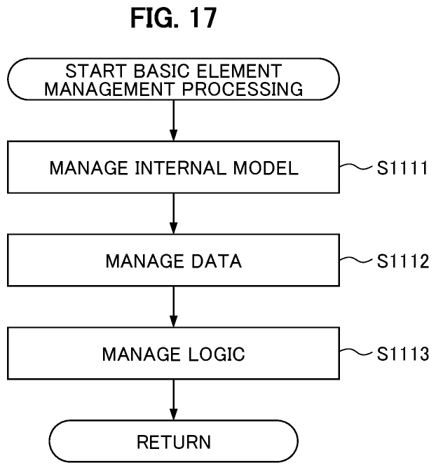

Next, in FIG. 17, an example of the details of the basic element management processing of step S111 in the human resource dispatcher-specific virtual human resource management processing in FIG. 16 will be described. FIG. 17 is a flowchart illustrating an example of the details of the basic element management processing of step S111 in the human resource dispatcher-specific virtual human resource management processing in FIG. 16.

In step S1111 in FIG. 17, the human resource dispatcher information acquisition unit 52 registers the latest internal model PM among the basic elements for producing the virtual human resource O. In step S1112 in FIG. 17, the human resource dispatcher information acquisition unit 52 registers the latest linguistic resource data PD among the basic elements for producing the virtual human resource O. In step S1113 in FIG. 17, the human resource dispatcher information acquisition unit 52 registers the latest logic PL among the basic elements for producing the virtual human resource O. This ends the basic element management processing for producing the virtual human resource O in the human resource dispatcher information acquisition unit 52. Thereby, the processing proceeds from step S111 to step S112 in FIG. 15.

In step S112 in FIG. 16, the human resource dispatcher information acquisition unit 52 registers a task execution unit necessary for the virtual human resource O to execute the task. Such processing of step S112 is hereinafter referred to as “registration processing of a task execution unit”.

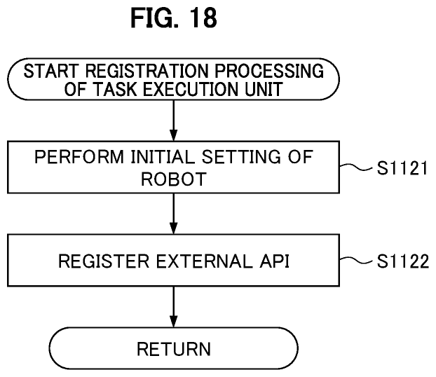

Next, in FIG. 18, an example of the details of the basic element management processing of step S111 in the human resource dispatcher-specific virtual human resource management processing in FIG. 16 will be described. FIG. 18 is a flowchart illustrating an example of the details of the basic element management processing of step S111 in the human resource dispatcher-specific virtual human resource management processing in FIG. 16.

In step S1121 in FIG. 18, when a robot as the virtual human resource O executes the task, the human resource dispatcher information acquisition unit 52 performs initial setting of what request the robot issues for each action. In step S1121 in FIG. 18, the human resource dispatcher information acquisition unit 52 registers an external API executable according to the task instruction. This ends the human resource dispatcher-specific virtual human resource management processing, with the completion of the basic element management processing and the registration processing of a task execution unit by the human resource dispatcher information acquisition unit 52. Thereby, the processing proceeds from step S11 to step S12 in FIG. 15.

In step S12 in FIG. 15, the human resource dispatcher information acquisition unit 52 accepts the registration of the dispatcher information. Such processing of step S12 is hereinafter referred to as “human resource dispatcher-specific information registration processing”.

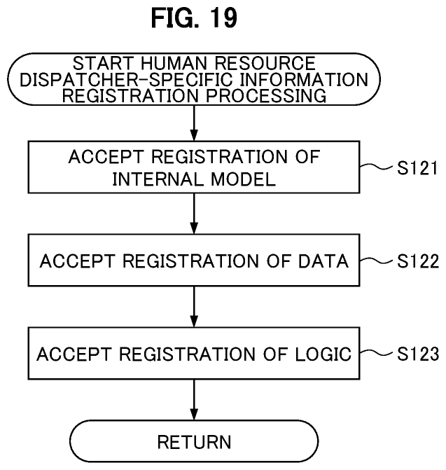

Next, in FIG. 19, an example of the details of the human resource dispatcher-specific information registration processing of step S12 in the preliminary preparation processing of human resource dispatch in FIG. 15 will be described. FIG. 19 is a flowchart illustrating an example of the details of the human resource dispatcher-specific information registration processing of step S12 in the preliminary preparation processing of human resource dispatch in FIG. 15.

In step S121 in FIG. 19, the model acquisition unit 521 of the human resource dispatcher information acquisition unit 52 accepts the registration of the internal model PM. In step S122 in FIG. 19, the data acquisition unit 522 of the human resource dispatcher information acquisition unit 52 accepts the registration of the linguistic resource data PD. In step S123 in FIG. 19, the logic acquisition unit 523 of the human resource dispatcher information acquisition unit 52 accepts the registration of the logics PL. This ends the preliminary preparation processing of human resource dispatch, with the completion of the human resource dispatcher-specific information registration processing for accepting the registration of the dispatcher information. Thereby, the processing proceeds from step S1 to step S2 in FIG. 13.

In step S2 in FIG. 14, the client information acquisition unit 51 in FIG. 8 accepts the registration of the client information. Such processing of step S2 is hereinafter referred to as “registration processing for preferred human resource dispatch destination”.

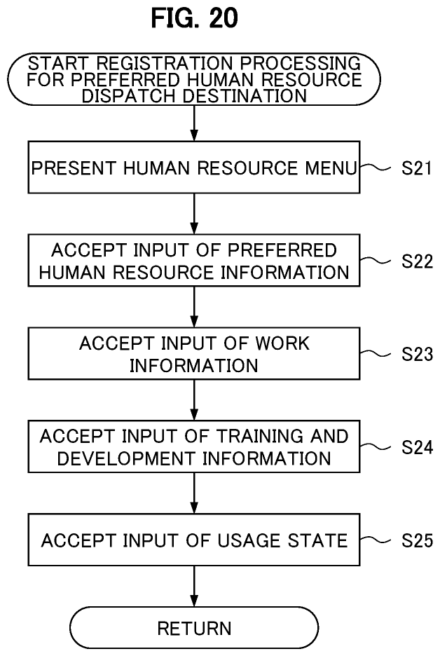

Next, in FIG. 20, an example of the details of the registration processing for preferred human resource dispatch destination of step S2 in the overall processing in FIG. 14 will be described. FIG. 20 is a flowchart illustrating an example of the details of the registration processing for preferred human resource dispatch destination of step S2 in the overall processing in FIG. 14.

In step S21 in FIG. 20, the client information acquisition unit 51 present a human resource menu to the client C. In step S22 in FIG. 20, the preferred human resource information acquisition unit 511 accepts the input of the preferred human resource information. In step S23 in FIG. 20, the recruitment information/manual information acquisition unit 513 accepts the input of the work information. In step S24 in FIG. 20, the recruitment information/manual information acquisition unit 513 accepts the input of the training and development information. In step S25 in FIG. 20, the usage form information acquisition unit 512 accepts the input of the usage form. This ends the registration processing for preferred human resource dispatch destination for accepting the registration of the client information. Thereby, the processing proceeds from step S2 to step S3 in FIG. 14.

In step S3 in FIG. 14, the virtual human resource production or updating unit 53 in FIG. 8 perform initial learning for the virtual human resource O. Such processing of step S3 is hereinafter referred to as “initial learning processing”.

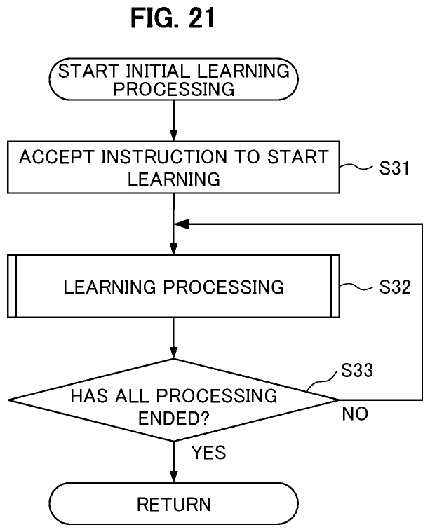

Next, in FIG. 21, an example of the details of the initial learning processing of step S3 in the overall processing in FIG. 14 will be described. FIG. 21 is a flowchart illustrating an example of the details of the initial learning processing of step S3 in the overall processing in FIG. 14.

In step S31 in FIG. 21, the virtual human resource production or updating unit 53 accepts an instruction to start learning from the human resource dispatcher information acquisition unit 52. In step S32 in FIG. 21, the virtual human resource production or updating unit 53 processes the input information regarding the virtual human resource O as appropriate, and generates the learning model. Such processing of step S32 is hereinafter referred to as “learning processing”.

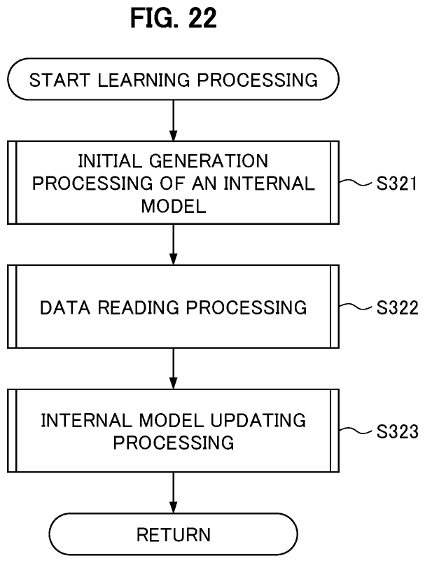

Next, in FIG. 22, an example of the details of the learning processing of step S32 in the initial learning processing in FIG. 21 will be described. FIG. 22 is a flowchart illustrating an example of the details of the learning processing of step S32 in the initial learning processing in FIG. 21.

In step S321 in FIG. 22, the virtual human resource production or updating unit 53 generates an internal model PM for the virtual human resource O based on the internal model PM of which acquisition has been accepted in step S121. Such processing of step S321 is hereinafter referred to as “initial generation processing of an internal model”. Such initial generation processing of an internal model is executed only at the time of initial generation of the virtual human resource O.

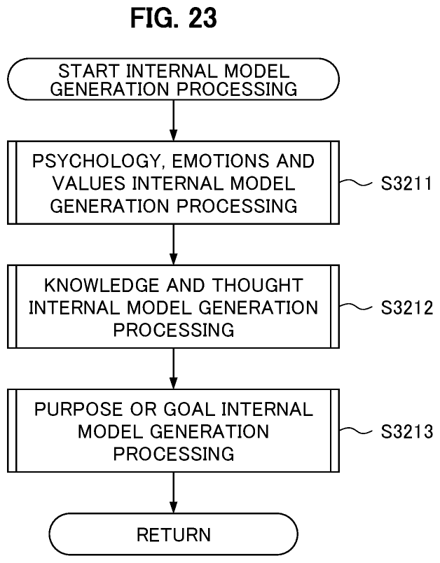

Next, in FIG. 23, an example of the details of the initial generation processing of an internal model of step S321 in the learning processing in FIG. 22 will be described. FIG. 23 is a flowchart illustrating an example of the details of the initial generation processing of an internal model in step S321 of the learning processing in FIG. 22.

In step S3211 in FIG. 23, the virtual human resource production or updating unit 53 generates the psychology, emotions, and values internal model PM1 for the virtual human resource O. Such processing of step S3211 is hereinafter referred to as “psychology, emotions, and values internal model generation processing”.

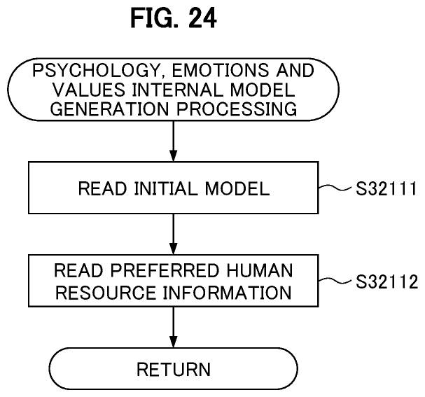

Next, in FIG. 24, an example of the details of the psychology, emotions, and values internal model generation processing of step S3211 in the generation processing of an internal model in FIG. 23 will be described. FIG. 24 is a flowchart illustrating an example of the details of the psychology, emotions, and values internal model generation processing of step S3211 of the generation processing in an internal model in FIG. 23.

In step S32111 in FIG. 24, the virtual human resource production or updating unit 53 reads the initial model of the psychology, emotions, and values internal model PM1 among the internal models PM acquired in the model acquisition unit 521 in step S121. In step S32112 in FIG. 24, the virtual human resource production or updating unit 53 reads the preferred human resource information acquired in the preferred human resource information acquisition unit 511 in step S2. This ends the generation processing of the psychology, emotions, and values internal model PM1 for the virtual human resource O. Thereby, the processing proceeds from step S3211 to step S3212 in FIG. 22.

In step S3212 in FIG. 23, the virtual human resource production or updating unit 53 generates the knowledge and thought internal model PM2 for the virtual human resource O. Such processing of step S3212 is hereinafter referred to as “knowledge and thought internal model generation processing”.

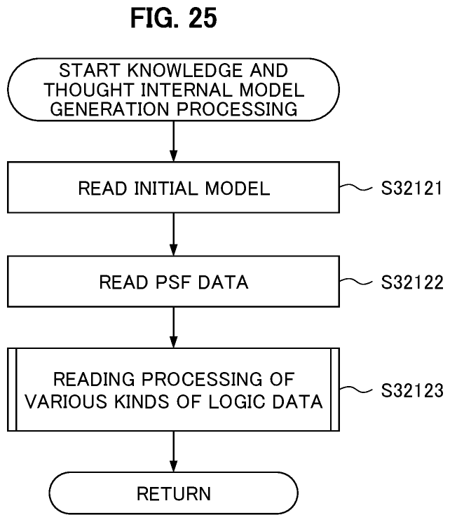

Next, in FIG. 25, an example of the details of the knowledge and thought internal model generation processing of step S3212 in the generation processing of an internal model in FIG. 23 will be described. FIG. 25 is a flowchart illustrating an example of the details of the knowledge and thought internal model generation processing of step S3212 in the generation processing of an internal model in FIG. 23.

In step S32121 in FIG. 25, the virtual human resource production or updating unit 53 reads the initial model of the knowledge and thought internal model PM2 among the internal models PM acquired in the model acquisition unit 521 in step S121. In step S32122 in FIG. 25, the virtual human resource production or updating unit 53 reads the PSF data PDP among the linguistic resource data PD acquired in the data acquisition unit 522 in step S122. The PSF data PDP uses the latest data registered in step S1112, so that the frame information with high resolution of semantic expression can be utilized. In step S32123 in FIG. 25, the virtual human resource production or updating unit 53 reads the logic PL acquired in the logic acquisition unit 523 in step S123. Such processing of step S32123 is hereinafter referred to as “reading processing of various kinds of logic data”.

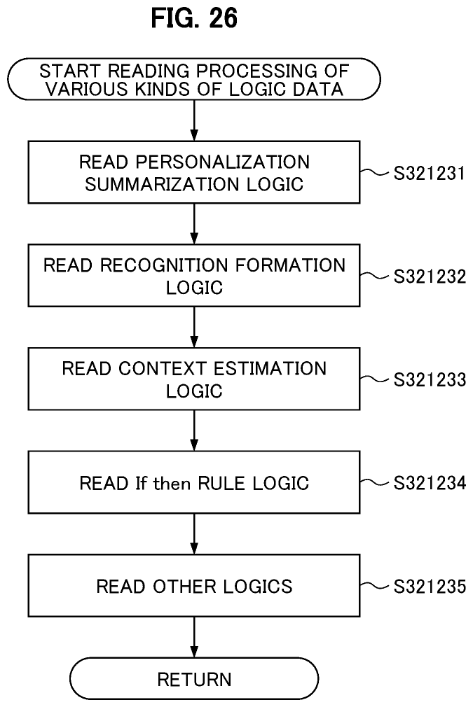

Next, in FIG. 26, an example of the details of the reading processing of various kinds of logic data of step S32123 in knowledge and thought generation processing in FIG. 25 will be described. FIG. 26 is a flowchart illustrating an example of the details of the reading processing of various kinds of logic data of step S32123 in the knowledge and thought generation processing in FIG. 25.

In step S321231 in FIG. 26, the virtual human resource production or updating unit 53 reads the personalization summarization logic PL1. In step S321232 in FIG. 26, the virtual human resource production or updating unit 53 reads the recognition formation logic PL2. In step S321233 in FIG. 26, the virtual human resource production or updating unit 53 reads the context estimation logic PL3. In step S321234 in FIG. 26, the virtual human resource production or updating unit 53 reads the If then rule logic PL4. In step S321235 in FIG. 26, the virtual human resource production or updating unit 53 reads the other logics. This ends the knowledge and thought internal model generation processing with the completion of the reading processing of various kinds of logic data. Thereby, the processing proceeds from step S3212 to step S3213 in FIG. 23.

In step S3213 in FIG. 23, the virtual human resource production or updating unit 53 generates the purpose or goal internal model PM3 for the virtual human resource O. Such processing of step S3213 is hereinafter referred to as “purpose or goal internal model generation processing”.

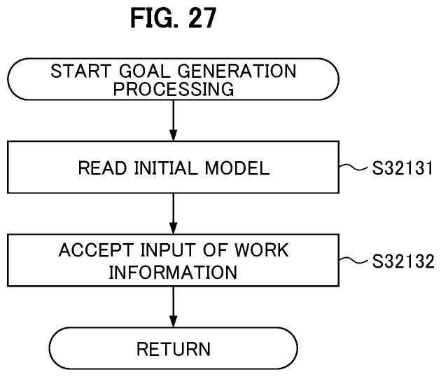

Next, in FIG. 27, an example of the details of the purpose or goal internal model generation processing of step S3213 in the generation processing of an internal model in FIG. 23 will be described. FIG. 27 is a flowchart illustrating an example of the details of the purpose or goal internal model generation processing of step S3213 in the generation processing of an internal model in FIG. 23.

In step S32131 in FIG. 27, the virtual human resource production or updating unit 53 reads, as an initial model, the purpose or goal internal model PM3 among the internal models PM acquired in the model acquisition unit 521 in step S121. In step S32132 in FIG. 27, the virtual human resource production or updating unit 53 reads the work information acquired in the recruitment information/manual information acquisition unit 513 in steps S24 and S25. This ends generation processing of the purpose or goal internal model for the virtual human resource O. Thereby, the processing proceeds from step S321 to step S322 in FIG. 22.

In step S322 in FIG. 22, the virtual human resource production or updating unit 53 reads the linguistic resource data PD. Such processing of step S322 is hereinafter referred to as “data reading processing”.

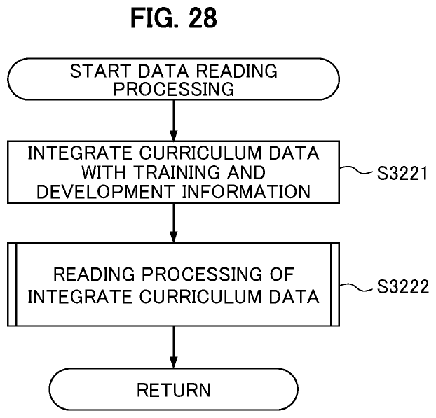

Next, in FIG. 28, an example of the details of the data reading processing of step S322 in the learning processing in FIG. 22 will be described. FIG. 28 is a flowchart illustrating an example of the details of the data reading processing of step S322 in the learning processing in FIG. 22.

In step S3221 in FIG. 28, the virtual human resource production or updating unit 53 integrates the training and development information CI33 acquired in the recruitment information/manual information acquisition unit 513 with the curriculum data PDC among the linguistic resource data PD acquired in the data acquisition unit 522. In step S3222 in FIG. 28, the virtual human resource production or updating unit 53 read the integrated curriculum data PDC. Such processing of step S3222 is hereinafter referred to as “integrated curriculum data reading processing”.

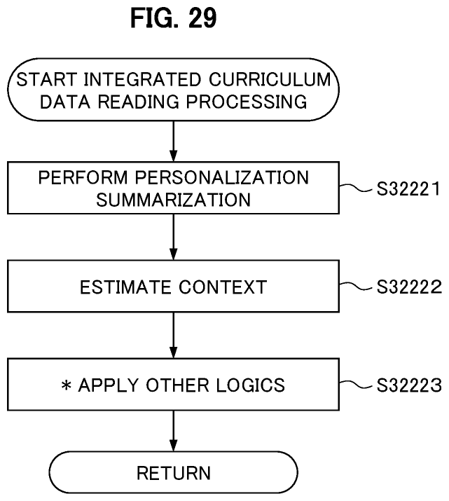

Next, in FIG. 29, an example of the details of the reading processing of the integrated curriculum data PDC of step S3222 in the data reading processing in FIG. 28 will be described. FIG. 29 is a flowchart illustrating an example of the details of the reading processing of the integrated curriculum data PDC of step S3222 in the data reading processing in FIG. 28.

In step S32221 in FIG. 29, the virtual human resource production or updating unit 53 performs the personalization summarization. That is, the virtual human resource production or updating unit 53 incorporates the above-described integrated curriculum data PDC into the knowledge and thought internal model PM2 for the virtual human resource O by using the personalization summarization. In step S32222 in FIG. 28, the virtual human resource production or updating unit 53 estimates the context. In step S32223 in FIG. 29, the virtual human resource production or updating unit 53 performs the learning processing of the virtual human resource O by applying, as needed, logics other than the personalization summarization logic PL1 and the context estimation logic P3. This ends the data reading processing with the completion of the reading processing of the integrated curriculum data PDC. Thereby, the processing proceeds from step S322 to step S323 in FIG. 22.

In step S323 in FIG. 22, the virtual human resource production or updating unit 53 updates the internal model PM. Such processing of step S323 is hereinafter referred to as “internal model updating processing”.

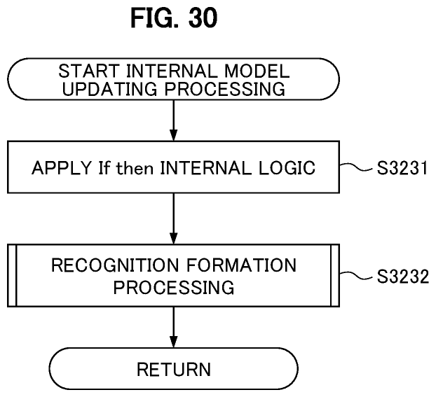

Next, in FIG. 30, an example of the details of the internal model updating processing of step S323 in the learning processing in FIG. 22 will be described. FIG. 30 is a flowchart illustrating an example of the details of the internal model updating processing of step S323 in the learning processing in FIG. 22.

In step S3231 in FIG. 30, the virtual human resource production or updating unit 53 executes the necessary processing by applying the If then rule logic PL4 each time the virtual human resource O learns. In step S3232 in FIG. 30, the virtual human resource production or updating unit 53 performs the recognition formation of the virtual human resource O. Such processing of step S3232 is hereinafter referred to as “recognition formation processing”.

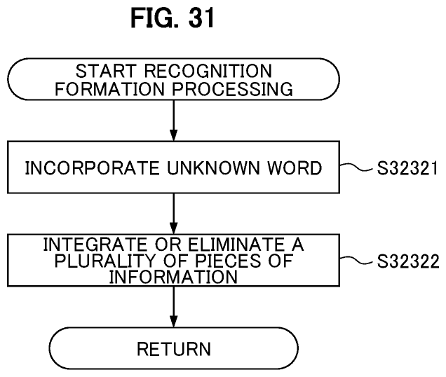

Next, in FIG. 31, an example of the details of the recognition formation processing of step S3232 in the internal model updating processing in FIG. 30 will be described. FIG. 31 is a flowchart illustrating an example of the details of the recognition formation processing of step S3232 in the internal model updating processing in FIG. 30.

In step S32321 in FIG. 31, the virtual human resource production or updating unit 53 incorporate unknown words. In step S32322 in FIG. 31, the virtual human resource production or updating unit 53 integrates and eliminates a plurality of pieces of information contributing to the recognition formation. When the recognition formation processing thus ends, the learning processing ends. Thereby, the processing proceeds from step S32 to step S33 in FIG. 21.

In step S33 in FIG. 21, when it is determined that all the curriculum processing has ended in the virtual human resource production or updating unit 53, the initial learning processing ends. On the other hand, when it is not determined that all the curriculum processing has ended in the virtual human resource production or updating unit 53, the processing is returned to step S32, and the subsequent processing is repeated. When the initial learning processing thus ends, the processing proceeds from step S3 to step S4 in FIG. 14.

In step S4 in FIG. 14, the virtual human resource production or updating unit 53 produces the virtual human resource O. Such processing of step S4 is hereinafter referred to as “human resource production processing”.

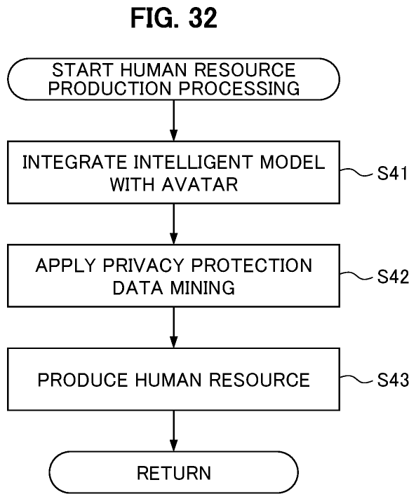

Next, in FIG. 32, an example of the human resource production processing of step S4 in the overall processing in FIG. 14 will be described. FIG. 32 is a flowchart illustrating an example of the human resource production processing of step S4 in the overall processing in FIG. 14.

In step S41 in FIG. 32, the virtual human resource production or updating unit 53 integrates an intelligent model with an avatar. That is, the virtual human resource production or updating unit 53 integrates the internal model PM for the virtual human resource O produced by learning, with the avatar. In step S42 in FIG. 32, the virtual human resource production or updating unit 53 utilizes the privacy protection data mining technology. In step S43 in FIG. 32, the virtual human resource production or updating unit 53 produces the virtual human resource O. That is, the virtual human resource production or updating unit 53 produces the virtual human resource O preferred by the client C. When the human resource production processing thus ends, the processing proceeds from step S4 to step S5 in FIG. 13.

In step S5 in FIG. 14, the environment setting unit 81 in FIG. 9 prepares to start the work. Such processing of step S5 is hereinafter referred to as “work start preparation processing”.

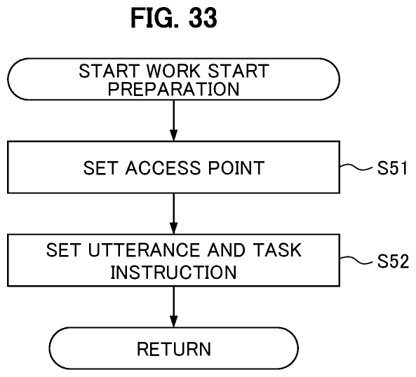

Next, in FIG. 33, an example of the work start preparation processing of step S5 in the overall processing in FIG. 14 will be described. FIG. 33 is a flowchart illustrating an example of the work start preparation processing of step S5 in the overall processing in FIG. 14.

In step S51 in FIG. 33, the environment setting unit 81 sets an access point for using the virtual human resource O for each usage form. In step S52 in FIG. 33, the environment setting unit 81 performs various settings related to the utterance and task instruction. This ends the work start preparation processing necessary for the virtual human resource O to start the work. Thereby, the processing proceeds from step S5 to step S6 in FIG. 14.

In step S6 in FIG. 14, the virtual human resource O is dispatched to the client C. Such processing of step S6 is hereinafter referred to as “human resource dispatch processing”.

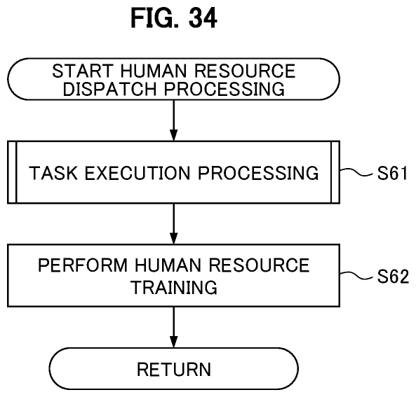

Next, in FIG. 34, an example of the human resource dispatch processing of step S6 in the overall processing in FIG. 14 will be described. FIG. 34 is a flowchart illustrating an example of the human resource dispatch processing of step S6 in the overall processing in FIG. 14.

In step S61 in FIG. 34, the task execution unit 83 in FIG. 9 executes the task. Such processing of step S61 is hereinafter referred to as “task execution processing”.

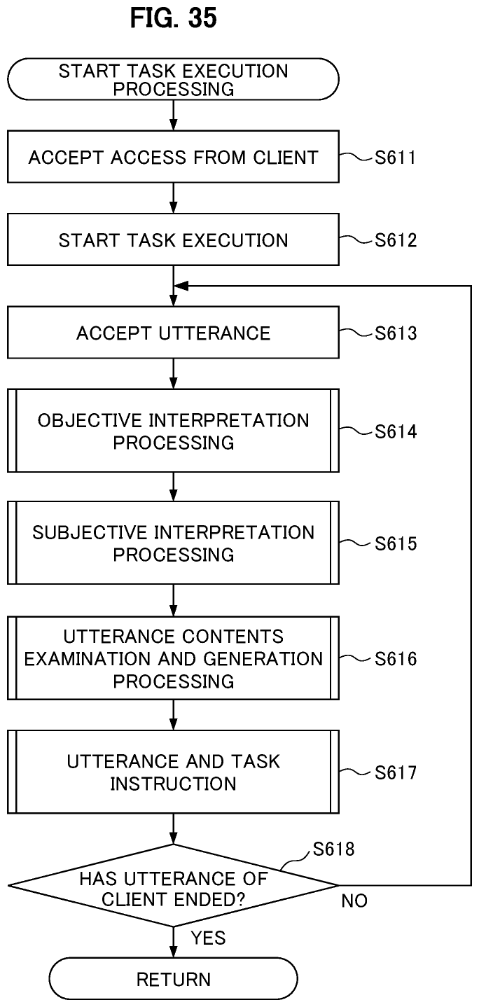

Next, in FIG. 35, an example of the task execution processing of step S61 in the human resource dispatch processing in FIG. 34 will be described. FIG. 35 is a flowchart illustrating an example of the task execution processing of step S61 in the human resource dispatch processing in FIG. 34.

In step S611 in FIG. 35, the virtual human resource dispatch unit 54 in FIG. 8 accepts access subject to the task execution. In step S612 in FIG. 35, the task execution unit 83 in FIG. 9 starts the task execution. In step S613 in FIG. 35, the task execution unit 83 accepts the utterance by the client C. In step S614 in FIG. 35, the objective interpretation unit 831 in FIG. 9 performs the objective interpretation on the utterance contents accepted in step S613. Such processing of step S614 is hereinafter referred to as “objective interpretation processing”.

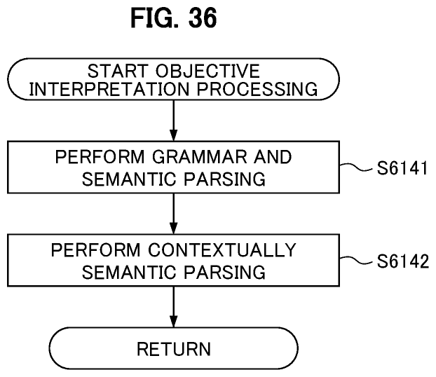

Next, in FIG. 36, an example of the objective interpretation processing of step S614 in the task execution processing in FIG. 35 will be described. FIG. 36 is a flowchart illustrating an example of the objective interpretation processing of step S614 in the task execution processing in FIG. 35.

In step S6141 in FIG. 36, the objective interpretation unit 831 performs the grammar and semantic interpretation. In step S6142 in FIG. 36, the objective interpretation unit 831 performs the contextually semantic interpretation. This ends the objective interpretation processing of the utterance contents of the client C. Thereby, the processing proceeds from step S614 to step S615 in FIG. 35.

In step S615 in FIG. 35, the subjective interpretation unit 832 performs the subjective interpretation on the utterance contents accepted in step S613. Such processing of step S615 is hereinafter referred to as “subjective interpretation processing”.

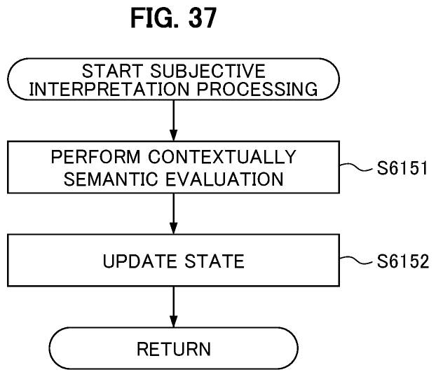

Next, in FIG. 37, an example of the subjective interpretation processing of step S615 in the task execution processing in FIG. 35 will be described. FIG. 37 is a flowchart illustrating an example of the subjective interpretation processing of step S615 in the task execution processing in FIG. 35.

In step S6151 in FIG. 37, the subjective interpretation unit 832 performs the contextually semantic evaluation. In step S6152 in FIG. 37, the subjective interpretation unit 832 updates the state. This ends the subjective interpretation processing of the utterance contents of the client C. Thereby, the processing proceeds from step S615 to step S616 in FIG. 35.

In step S616 in FIG. 35, the utterance contents examination and generation unit 833 in FIG. 9 examines the contents regarding the utterance contents accepted in step S613 and generates a candidate of the utterance and task based on the examination. Such processing of step S616 is hereinafter referred to as “utterance contents examination and generation processing”.

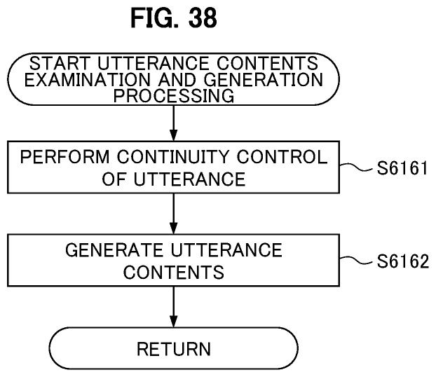

Next, in FIG. 38, an example of the utterance contents examination and generation processing of step S616 in the task execution processing in FIG. 35 will be described. FIG. 38 is a flowchart illustrating an example of the utterance contents examination and generation processing of step S616 in the task execution processing in FIG. 35.

In step S6161 in FIG. 38, the utterance contents examination and generation unit 833 performs the continuity control of the utterance. In step S6162 in FIG. 38, the utterance contents examination and generation unit 833 generates the utterance contents. This ends the utterance contents examination and generation processing. Thereby, the processing proceeds from step S616 to step S617 in FIG. 34.

In step S617 in FIG. 35, the utterance and task instruction unit 834 in FIG. 9 issues an instruction of the utterance and task based on the utterance contents generated in step S616. Such processing of step S617 is hereinafter referred to as “utterance and task instruction processing”.

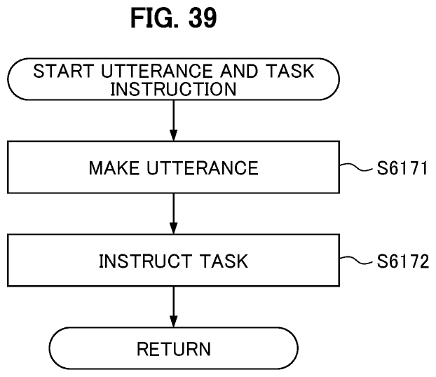

Next, in FIG. 39, an example of the utterance and task instruction processing of step S617 in the task execution processing in FIG. 35 will be described. FIG. 39 is a flowchart illustrating an example of the utterance and task instruction processing of step S617 in the task execution processing in FIG. 35.

In step S6171 in FIG. 39, the utterance and task instruction unit 834 executes the control of the utterance. In step S6172 in FIG. 39, the utterance and task instruction unit 834 instructs a task. This ends the utterance and task instruction processing. Thereby, the processing proceeds from step S617 to step S618 in FIG. 35.

In step S618 in FIG. 35, when it is determined that the acceptance of the utterance by the client C has been completed in the task execution unit 83, the task execution processing ends. On the other hand, when it is not determined that the acceptance of the utterance by the client C has been completed in the task execution unit 83, the processing is returned to step S613, and the subsequent processing is repeated. When the task execution processing thus ends, the processing proceeds from step S61 to step S62 in FIG. 34.

In step S62 in FIG. 34, the knowledge category dependent training unit 821 in FIG. 10 performs the training processing of the virtual human resource O. As a consequence, the ability of the virtual human resource O can be improved as well as in humans.

There has been described with reference to FIGS. 13 to 39 the flow of the overall processing. Next, the above-described flow of the overall processing will be described using a specific example.

Here, an example will be described in which the virtual human resource O as a personal tutor is dispatched to a boy (an end user) in second grade at high school at a request from a personal tutor management company (an example of the client C). The virtual human resource O to be dispatched as a personal tutor to the personal tutor management company executes a task of teaching mathematics “formula of distance from a point to a line” to a boy who is an end user. It is assumed that the boy is weak in mathematics, and is shy of strangers and is not good at talking with persons.

First, in the human resource dispatcher information acquisition unit 52, the “preliminary preparation processing of human resource dispatch” for producing the virtual human resource O is executed (step S1 in FIG. 14).

The human resource dispatcher information acquisition unit 52 registers the latest internal model PM, the latest linguistic resource data PD, and the latest logic PL as the basic elements for producing the virtual human resource O (steps S1111 to S1113 in FIG. 17).

The human resource dispatcher information acquisition unit 52 registers the external API that can depict a graph and display it on a screen. (Step S1122 in FIG. 18)

The model acquisition unit 521 of the human resource dispatcher information acquisition unit 52 accepts the registration of the internal model PM as the dispatcher information (step S121 in FIG. 19). There are often preferences that include, as those generally desired for a personal tutor, whether to be “kind” or “strict”, sex, the presence or absence of the same or similar entrance examination experience, and whether to be “good at developing student's specialty” or “supporting a weak student”. Then, an option meeting the above-described preferences in the appropriate internal model PM is adopted to be automatically reflected into the internal temperament and character of the virtual human resource O.

The data acquisition unit 522 of the human resource dispatcher information acquisition unit 52 accepts the registration of the linguistic resource data PD (step S122 in FIG. 19). That is, in the data acquisition unit 522, the curriculum data PDC is registered, the curriculum data PDC including all ranges of mathematics and being created by covering the knowledge required for educational act. Such curriculum data PDC factors learning items in the sphere of “mathematics” up to the minimum unit to organize and prepare, as basic information, their dependency relations.

The logic acquisition unit 523 of the human resource dispatcher information acquisition unit 52 accepts the registration of the logics PL (step S123 in FIG. 19). That is, for example, there is registered in the If then rule logic PL4 how to understand for each basic element of the sphere of mathematics. Specifically, the basic elements of the sphere of mathematics are mainly classified into a calculation system, a memorization system, and a reading system. Accordingly, there are registered in the If then rule logic PL4 the information indicating the contents in which the calculation is drilled in the case of the calculation system, the contents in which a portion not memorized separated from a portion memorized is checked at appropriate intervals according to the partner and a knack for memorizing, such as a pun existing for each item is taught in the case of the memorization system, and the contents in which only extracting and writing out a necessary portion are practiced in the reading system.

Next, in the client information acquisition unit 51, the “registration processing for preferred human resource dispatch information” for producing the virtual human resource O is executed (step S2 in FIG. 14).

The client information acquisition unit 51 provides a human resource menu to the personal tutor management company which is the client C (step S21 in FIG. 20). That is, the personal tutor management company operates the client terminal 2 to thereby to function the client-specific information registration function CF.

The preferred human resource information acquisition unit 511 accepts the input of the preferred human resource information CI1 (step S22 in FIG. 20). That is, the personal tutor management company registers, as the preferred human resource information CI1, information about a type of the personal tutor desired to be dispatched with the preferred human resource information acquisition unit 511, the information being obtained as a result of hearing from a boy and the personal tutor being “kind”, being “female” in sex, and the information of an anticipated learning level as “entrusting”. When such client information is input, a fee plan of a dispatch price of the virtual human resource O is updated so that an appropriate fee is presented for each content to be requested. Note that the fee information is registered in advance in the human resource dispatcher-specific information registration function PF.

The recruitment information/manual information acquisition unit 513 accepts the input of the work information (step S23 in FIG. 20). That is, the personal tutor management company registers, as the company and organization purpose CI31, information for teaching a boy to “avoid a failing mark in mathematics”, the information being obtained as a result of hearing the boy and the boy's mother, with the recruitment information/manual information acquisition unit 513.

The recruitment information/manual information acquisition unit 513 accepts the input of the training and development information (step S24 in FIG. 20). That is, the personal tutor management company registers, as the training and development information CI33, the teaching manual for an instructor of the company, the teaching materials and workbooks of mathematics developed uniquely, and the contents of the video class, with the recruitment information/manual information acquisition unit 513.

The usage form information acquisition unit 512 accepts the input of the usage form (step S25 in FIG. 20). That is, the personal tutor management company registers, as the e-mail and chatbot CI21 and the video chat CI23, the “virtual human resource OM that executes a task in a form of e-mail and chatbot” which can easily accept questions at any time, and the “virtual human resource OA that executes a task in a form of a video chat” which enables thorough teaching, respectively, with the usage form information acquisition unit 512. This ends the registration processing for preferred human resource dispatch destination for accepting the registration of the client information.

Next, in the virtual human resource production or updating unit 53, the “initial learning processing” for the virtual human resource O is executed (step S3 in FIG. 14).

The virtual human resource production or updating unit 53 receives an instruction to start the learning from the human resource dispatcher information acquisition unit 52 (step S31 in FIG. 21). That is, the human resource dispatcher P instructs the virtual human resource O as a personal tutor to start the learning via the dispatcher terminal 3.

The virtual human resource production or updating unit 53 produces the internal model PM for the virtual human resource O based on the initial model of the internal model PM registration of which has been accepted in step S121 in the preliminary preparation processing of human resource dispatch (step S321 in FIG. 22).

First, the virtual human resource production or updating unit 53 reads the initial model of the psychology, emotions, and values internal model PM1 among the internal models PM registration of which has been accepted in step S121 (step S32111 in FIG. 24). The virtual human resource production or updating unit 53 reads the preferred human resource information CI1 registered in the preferred human resource information acquisition unit 511 (step S32112 in FIG. 24).

When the psychology, emotions, and values internal model PM1 for the virtual human resource O is thus generated, then, the virtual human resource production or updating unit 53 reads the initial model of the knowledge and thought internal model PM2 among the internal models PM registration of which has been accepted in step S121 (step S32121 in FIG. 25). That is, the virtual human resource production or updating unit 53 predicts the studied contents in a target period of a boy as the end user in second grade at high school, and produces the initial model of the knowledge and thought internal model PM2 while estimating the knowledge of the boy. However, since the teaching has not been started (before the work start of the virtual human resource O), the comprehension in all knowledge remains unidentified as meta information, and the updating is performed during the teaching act as needed.

The virtual human resource production or updating unit 53 reads the PSF data PDP among the linguistic resource data PD registration of which has been accepted in step S122 (step S32122 in FIG. 25).

The virtual human resource production or updating unit 53 reads the logic PL registration of which has been accepted in step S123 (step S32123 in FIG. 25).

Specifically, the virtual human resource production or updating unit 53 reads the personalization summarization logic PL1 (step S321231 in FIG. 26). That is, since the boy as the end user is in second grade at high school, the virtual human resource production or updating unit 53 sets a measure of available vocabularies to the boy corresponding to the second grade at high school to be retained in the knowledge and thought internal model PM2 so that the virtual human resource O can internally estimate the boy's state.

The virtual human resource production or updating unit 53 reads the recognition formation logic PL2 (step S321232 in FIG. 26). That is, the virtual human resource O as the personal tutor must guess the reliability of the word “understood” of the boy. Therefore, in generating the knowledge and thought internal model PM2 for the virtual human resource O, the recognition formation logic PL2 avoids the use of the bias system as much as possible and is set to be moved in a thought pattern so that the virtual human resource O always ascertains the facts by itself to accumulate the facts. In this way, even when the boy says “understood”, the virtual human resource O is produced so as to firstly present the problems while doubting the word, and determine whether the boy can understand really while looking at the results for the problems as the fact base.

The virtual human resource production or updating unit 53 reads the context estimation logic PL3 (step S32123 in FIG. 26). When the virtual human resource O as a personal tutor teaches the mathematics, it is very important for the virtual human resource O to estimate the context correctly. This is because the determination of “what formula can be used” is highly dependent on the context. Therefore, when the virtual human resource O self-recognizes that it cannot correctly grasp the context, the virtual human resource O continues to check the contents of the context by additionally asking a question until a lacking portion in the context becomes clear. In this way, not only a specific level of “formula of distance from a point to a line” and the like but also the context in which each common terms are combined can be set when teaching the mathematics, which makes it possible to easily specify the available formulas, the other rules, hints and the like.

The virtual human resource production or updating unit 53 reads the If then rule logic PL4 (step S32123 in FIG. 26). The If then rule logic is important to output the values in teaching mathematics. Specifically, the If then rule logic PL4 is a rule aggregate that takes the form of [If “condition”, then “action to be executed”], and performs an action when the condition is satisfied. The states of the knowledge and thought internal model PM2 for the boy that is to be estimated by the virtual human resource O, the psychology, emotions, and values internal model PM1, and the context are registered with the “condition” portion of If then, and what should be done by the virtual human resource O to improve the academic ability of the boy is registered with the “action to be executed” portion. Note that the processing in this step is merely processing for generating an initial value, and the If then rule logic PL4 itself is dynamically optimized according to the change in state of the boy through the teaching act.

The virtual human resource production or updating unit 53 reads the other logics (step S321235 in FIG. 26). That is, to form the virtual human resource O, the dynamic optimization is also necessary for logics other than the above-described logic PL, and such logics can be registered as specific contents of the If then rule logic PL4 as needed. That is, the result and conclusion, and actions to be selected are quite different depending on how a plurality of If then rule logics PL4 is combined to advance the inference, and therefore it is also extremely important to manage the other logics.

When the knowledge and thought internal model PM2 for the virtual human resource O is generated in this manner, next, the virtual human resource production or updating unit 53 reads the initial model of the purpose or goal internal model PM3 among the internal models PM registration of which has been accepted in step S121 (step S32131 in FIG. 27).

The virtual human resource production or updating unit 53 reads the company and organization purpose CI31 registered in step S24 (step S32132 in FIG. 27). That is, when it is confirmed as the work information that teaching to “avoid a failing mark in mathematics” is started among the read company and organization purpose CI31, the virtual human resource production or updating unit 53 sets an initial value of the purpose or goal internal model PM3 of the boy, centering on not increasing “things having been done” but increasing “things being able to be done”, for example. This ends the initial generation processing of an internal model for the virtual human resource O.

The virtual human resource production or updating unit 53 integrates the curriculum data PDC acquired in step S122 with the training and development information CI33 acquired in step S24. That is, the virtual human resource production or updating unit 53 integrates the curriculum data PDC prepared by the human resource dispatcher P with the teaching manual for an instructor of the company prepared by the personal tutor management company, the teaching materials and workbooks of mathematics developed uniquely, the contents of the video class, and the like.

The virtual human resource production or updating unit 53 reads the integrated curriculum data PDC. That is, the virtual human resource production or updating unit 53 incorporates the data generated by integrating the curriculum data PDC with the training and development information CI33 into the knowledge and thought internal model PM2 for the virtual human resource O using the personalization summarization logic PL1. That is, apart from the curriculum data PDC prepared by the human resource dispatcher P, the contents prepared by the personal tutor management company is not provided by the human resource dispatcher P, which causes increase in difficulty level of the automatic reading comprehension. The comprehension level of the virtual human resource O in terms of the data generated from such contents can be increased using the personalization summarization logic PL1. In other words, using the personalization summarization logic PL1 for the data generated by integrating the curriculum data PDC with the training and development information CI33 enables the virtual human resource O to understand in a form in which the available vocabularies are set to the junior high school level based on the setting status of a school year of the boy and the information that the boy is not good at mathematics. As a consequence, the virtual human resource O can provide plainer explanation to the boy.

The virtual human resource production or updating unit 53 estimates the context (step S32222 in FIG. 28). That is, as described above, the estimation of context is a very important element for specifying the available formulas, the other rules, hints and the like. Specifically, when the data generated by integrating the curriculum data PDC with the training and development information CI33 is read, the context of each information is correctly recognized and set, whereby the virtual human resource O can correctly teach the boy.

The virtual human resource production or updating unit 53 updates the internal model PM (step S323 in FIG. 22). That is, the virtual human resource production or updating unit 53 executes necessary processing by applying the If then rule logic PL4 each time the virtual human resource O learns something (step S3231 in FIG. 30).

The virtual human resource production or updating unit 53 incorporate unknown words (step S32321 in FIG. 31). That is, the virtual human resource production or updating unit 53 determines whether the learning target is the same as known or is unknown during the process of learning of the virtual human resource O. When it is determined that the learning target is unknown, the learning target is retained, as new knowledge, in the knowledge and thought internal model PM2. Even when it is determined once that the learning target is unknown, the knowledge is integrated into the knowledge and thought internal model PM2 if it is found in the subsequent learning process that the learning target is the same as known.

The virtual human resource production or updating unit 53 integrates and eliminates a plurality of pieces of information. That is, the virtual human resource production or updating unit 53 integrates and eliminates, as needed, the duplicated information while updating the statistical information as the meta information. Specifically, in the case of the virtual human resource O as the personal tutor for teaching mathematics, there is almost no possibility of encountering information that is mutually contradictory, but there is a possibility of a description mistake of the teaching material, for example. Then, the virtual human resource production or updating unit 53 aggregates and updates the statistical information while checking consistency with the existing knowledge. This ends the initial learning processing on the virtual human resource O.

Furthermore, in the human resource dispatcher P, the “human resource production processing” for the virtual human resource O is executed (step S4 in FIG. 14). The virtual human resource production or updating unit 53 integrates an intelligent model with an avatar. That is, the virtual human resource production or updating unit 53 prepares to generate “kind” and “female” avatar according to the preference of the boy (step S41 in FIG. 32).

The virtual human resource production or updating unit 53 can apply the privacy protection data mining. That is, the virtual human resource production or updating unit 53 applies the privacy protection data mining logic PL6 to protect privacy so that the virtual human resource O does not leak, to the outside, the information learned from the boy (step S42 in FIG. 32). By applying the privacy protection data mining logic PL6, the virtual human resource O can share the teaching knowhow with the other virtual human resources and analyze it while protecting the privacy of the student. In this manner, the virtual human resource production or updating unit 53 generates a personal tutor as the virtual human resource O preferred by the boy (step S43 in FIG. 32). This ends the human resource production processing on the virtual human resource O.

Furthermore, in the client C, the “work start preparation processing” for executing a task is executed (step S5 in FIG. 14). The environment setting unit 81 sets an access point for using the virtual human resource O for each usage form. That is, the environment setting unit 81 sets a URL for activating the video chat and e-mail address for communicating with the virtual human resource O so that the boy can access the virtual human resource O as a personal tutor (step S51 in FIG. 33).

The environment setting unit 81 performs various settings related to an utterance and task instruction. That is, the environment setting unit 81 selects an “API that can depict a graph and display it on a screen” as an available API. In addition, the environment setting unit 81 sets a contact address of a real human resource (a specialized staff) that supports when the virtual human resource O as the personal tutor cannot offer the response. For example, the specialized staff is set at a ratio of one to ten virtual human resources O, and executes a task instruction transmitted from the virtual human resource O as needed (step S52 in FIG. 33). This ends the work start preparation processing on the virtual human resource O.

Furthermore, in the client C, the “human resource dispatch processing” is executed (step S6 in FIG. 14). The virtual human resource dispatch unit 54 accepts an access of an end user. That is, the boy accesses the provided URL, and attempts to start a lesson of the personal tutor which is the virtual human resource O (step S611 in FIG. 35).

The task execution unit 83 starts task execution. That is, the virtual human resource O starts the response as the personal tutor (step S612 in FIG. 35). The task execution unit 83 accepts first the boy's status, reported by the boy, about what the boy wants to do today or that the boy has not decided what to do today (step S613 in FIG. 35).

The objective interpretation unit 831 performs objective interpretation on the received utterance contents of the boy. That is, the grammar and semantic parsing unit 851 of the objective interpretation unit 831 performs grammar and semantic parsing of the boy's words (step S6141 of FIG. 36).

The contextually semantic estimation unit 852 of the objective interpretation unit 831 performs contextually semantic interpretation on the boy's words (step S6142 of FIG. 36).

Next, the subjective interpretation unit 832 performs subjective interpretation on the received utterance contents of the boy. That is, the contextually semantic evaluation unit 853 of the subjective interpretation unit 832 performs contextually semantic evaluation on the boy's words (step S6151 in FIG. 37).

The state updating unit 854 of the subjective interpretation unit 832 updates the state. That is, in the case where the virtual human resource O finds the boy not to be good at mathematics but to be good at national language and social studies in a process of teaching the body, the available vocabularies for mathematics are adjusted to the level of third grade at junior high school, and the other explanation vocabularies are adjusted to the level of second grade at high school, so that the time required until the whole understanding is optimized (step S6152 in FIG. 37).

The utterance contents examination and generation unit 833 performs the continuity control of the utterance. That is, the utterance continuity control unit 855 of the utterance contents examination and generation unit 833 estimates an intent of a boy such as whether the boy continues speaking or expects the response from the virtual human resource O (step S6161 in FIG. 38).

The utterance contents generation unit 856 of the utterance contents examination and generation unit 833 generates the utterance contents (step S6162 in FIG. 38). That is, the utterance contents generation unit 856 clarifies the utterance and task instruction of the virtual human resource O to be issued to the boy according to the estimated intent of the boy. For example, the following are candidates for the utterance and task instruction. That is, the utterance contents generation unit 856 generates the utterance contents to the boy, for example, to check the presence or absence and the contents of things that the boy wants to do in the lesson, to check whether the spoken contents can be understood, to ask a question to check whether the contents can be understood, to explain so that the boy can understand the specified portion that the boy cannot understand, to introduce the information that can be used to understand the specified portion that the boy cannot understand, to check the completion of the lesson, and to check whether there is a problem in the response of the virtual human resource.

The utterance and task instruction unit 834 executes the control of the utterance. That is, the utterance unit 857 of the utterance and task instruction unit 834 performs appropriate utterance based on the generated utterance contents and the If then rule logic PL4 (step S6171 in FIG. 39).

The task instruction unit 858 of the utterance and task instruction unit 834 instructs a task. That is, the task instruction unit 858 instructs an appropriate task according to the If then rule logic PL4. That is, the task instruction unit 858 makes a support request to the specialized staff. Alternatively, the utterance and task instruction unit 834 executes the “API that can depict a graph and display it on a screen” registered in advance and displays it on the screen (step S6172 in FIG. 39).

The task execution unit 83 ends the task execution processing. That is, the task execution unit 83 determines whether the task is completed, based on the boy's intent of terminating the lesson and the progress state of a predetermined time of the lesson. For example, in the case where the boy is absent because of poor health, the task execution unit 83 may ends the processing even when time does not elapse (step S618 in FIG. 35).

The knowledge category dependent training unit 821 of the training unit 82 performs the training processing on the virtual human resource O. That is, the personal tutor management company can train the virtual human resource O dispatched to each household. The inter-human resource information sharing unit 822 of the training unit 82 protects the privacy of the student by applying the privacy protection data mining logic PL6 as needed, and an effective teaching method can be shared in a format of the If then rule logic PL4. Since the knowledge and thought internal model PM2 for the virtual human resource O is a visualized model, the knowledge category dependent training unit 821 may additionally learn the field to be enhanced using additional curriculum data PDC according to the comprehensive state in each knowledge field. Furthermore, the knowledge category dependent training unit 821 may add the learning of the virtual human resource O when the range has changed or when the trend of problems has changed due to a change in the teaching procedure. In this manner, the virtual human resource O can improve its ability as well as a human by receiving the training.

There has been described an example in which the virtual human resource O as a personal tutor is dispatched to a boy (an end user) in second grade at high school at a request from the personal tutor management company (an example of the client C). As described above, in the PDCA cycle executed when the virtual human resource O executes a task, the internal models of the partner and the virtual human resource O itself are always estimated. That is, the virtual human resource O increases the estimation accuracy by refining the psychology, emotions, and values internal model for a boy in the daily teaching, and adjusts the psychology, emotions, and values internal model PM1 for the virtual human resource O itself to simultaneously increase boy's learning motivation, thereby enabling the refinement of how to contact. Specifically, for example, since “a stop of thinking is caused when the boy does not know what to do, and often stop his/her hands”, the virtual human resource O can retain this fact as the psychology, emotions, and values internal model for a boy to teach the boy while always keeping it in mind during continuous teaching. In addition, the virtual human resource O improves the grasp level of the state of the knowledge and thought internal model for a boy through daily learning, and further dynamically grasps the knowledge and thought internal model for the boy in time series while taking into consideration whether the boy has forgotten the learned contents. Specifically, for example, when learning that the boy can remember most of the learned contents by reviewing three times every one week even if he/she has forgotten them, the virtual human resource O can newly register the contents of “checking three times at intervals of one week if forgetting once” as the If then rule logic PL4. The information indicating that “in such a case, it suffices to teach in such a manner” is refined in the daily educational act by the virtual human resource O, while logistic support is performed by reinforcing the If then rule logic PL4 and the external API as an executable action, that are registered in the human resource dispatcher-specific virtual human resource management function PA. Specifically, a specific means which leads to improvement in the academic ability of the boy is provided in a form of act other than the utterance act of the virtual human resource O in a form in which when If “square root cannot be understood”, then “the contents on the Internet to be referred to are displayed”.

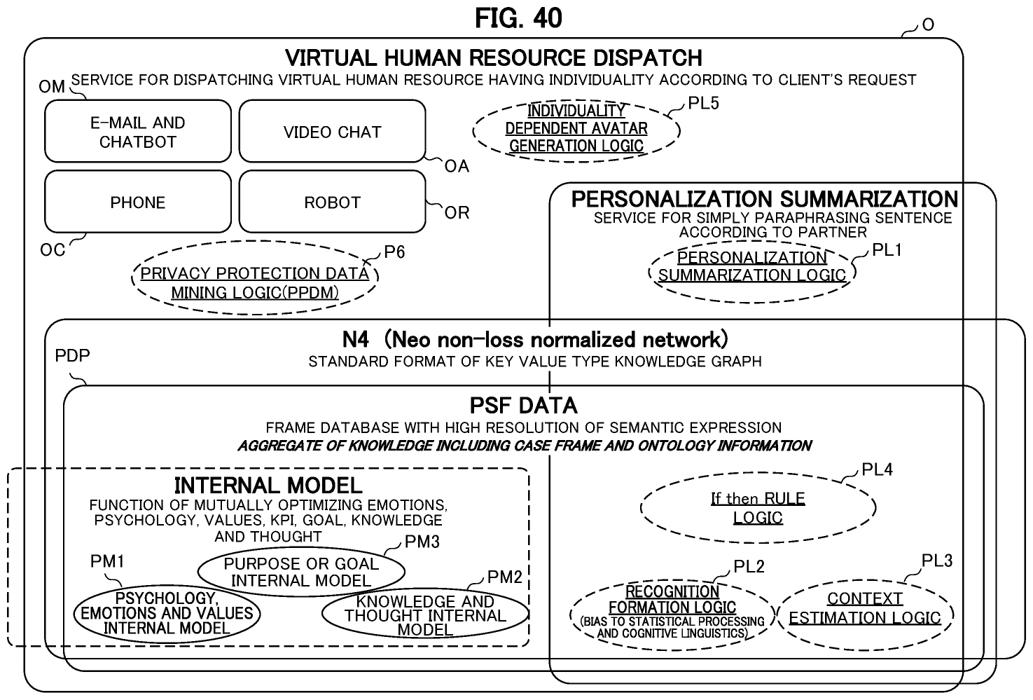

As described above, various technologies illustrated in FIG. 40 exist as fundamental technologies necessary to achieve the virtual human resource.

FIG. 40 is a diagram illustrating an overview of fundamental technologies necessary to achieve the virtual human resource. That is, the virtual human resource O is produced as the fundamental technologies of the personalization summarization, the data represented in a “semantically normalized format” or a format convertible thereto (e.g., N4), the PSF data PDP, and the internal model PM. Here, the personalization summarization refers to an information system that can paraphrase the contents depending on the partner, and the personalization summarization logic PL described above refers to the processing that achieves it.

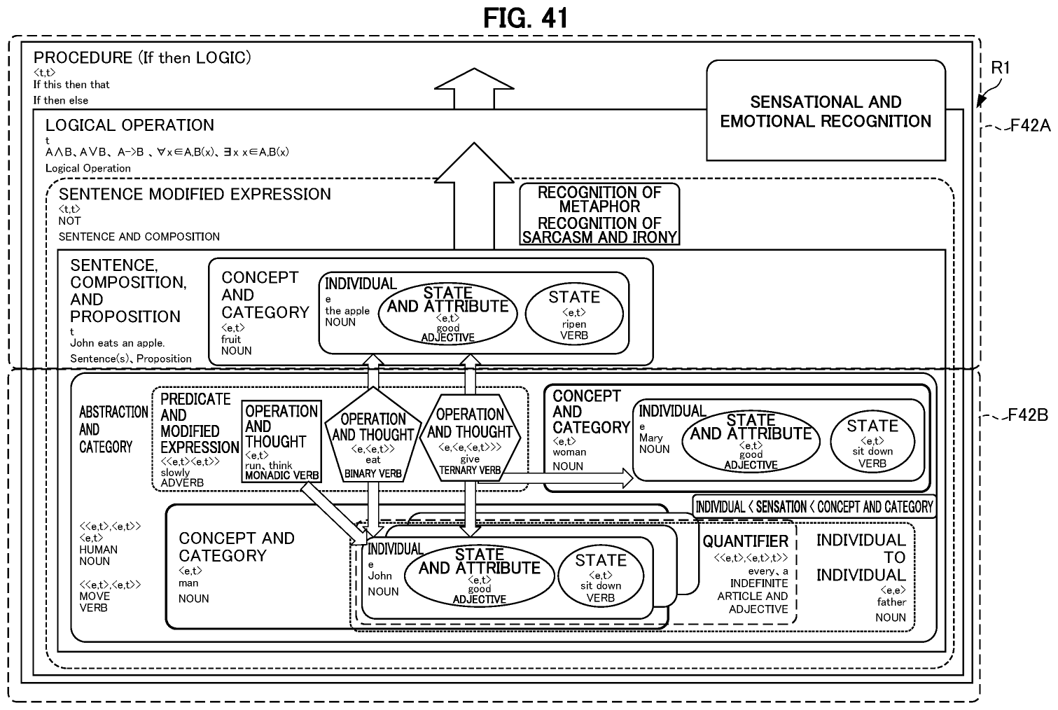

Such four fundamental technologies are technologies that can be applied not only to achieving the virtual human resource O but also to various kinds of fields other than the virtual human resource O. Hereinafter, with reference to FIGS. 41 to 54, the details and specific application examples of the four fundamental technologies including the personalization summarization, N4 as the data represented in a “semantically normalized format” or a format convertible thereto, the PSF data PDP, and the internal model PM will be described in sequence. Note that, in the following description, these four fundamental technologies will be described as being applied to the information processing system such as the virtual human resource O.

First, with reference to FIGS. 41 to 52, the PSF data PDP will be described. Although the details will be described later, the PSF data PDP is constituted by combining the technologies (1) normalized representation of all definition information, (2) sensor-based semantic decomposition, (3) context association, and (4) a recognition formation from an episodic memory with respect to existing ontology.

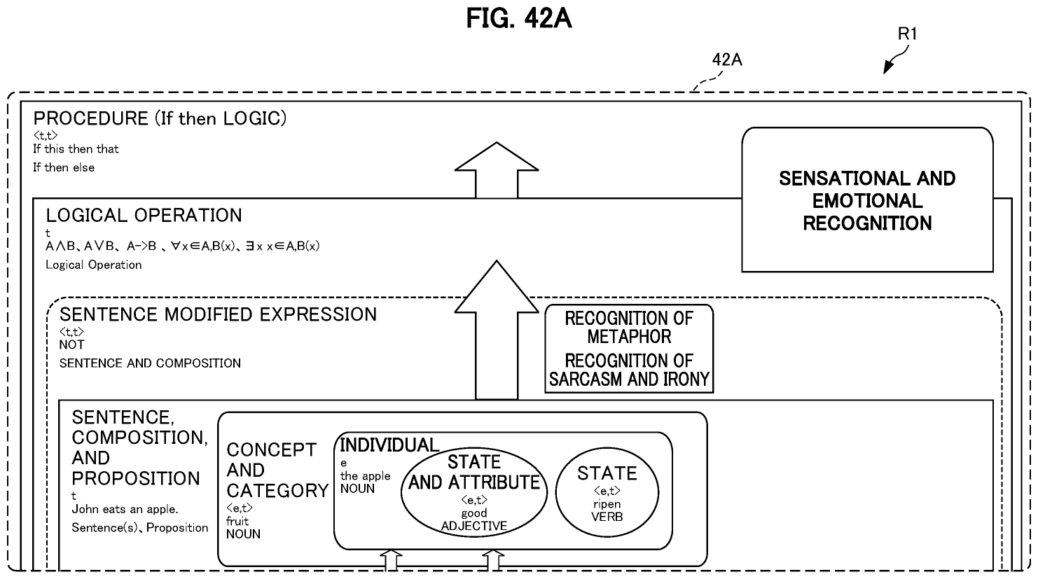

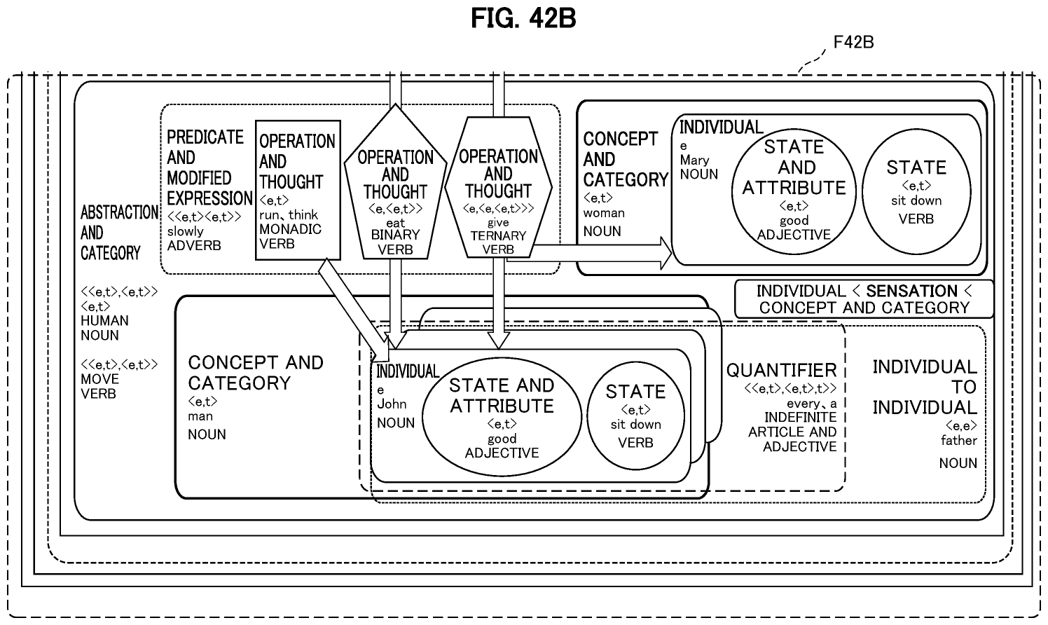

FIG. 41 is a diagram illustrating (1) normalized representation of all definition information. FIGS. 42A and 42B each are a split view of the diagram illustrating (1) normalized representation of all definition information illustrated in FIG. 41. FIG. 41 illustrates a configuration example of (1) normalized representation R1 of all definition information. The configuration example of (1) normalized representation R1 of all definition information in FIG. 41 includes, as the information having a definition (hereinafter, referred to as “definition information”), an individual, state and attribute, concept and category, predicate and modified expression, and the like. In the conventional technologies, most of the definition information including the individual, the state and attribute, the concept and category, the predicate and modified expression, and the like adopts a method in which the definition is described in a natural language. That is, for example, a conventional dictionary is a method in which a plurality of semantic sentences are written in words with respect to entry words. Therefore, even if a conventional virtual human resource uses the definition information generated by such a conventional method, it is difficult for the conventional virtual human resource to understand the true meaning of a given sentence. Therefore, in the PSF data PDP applicable to the information processing system such as the virtual human resource O, as in the configuration example of (1) normalized representation R1 of all definition information in FIG. 41, the definition information is generated by representing the definition in the data represented in a “semantically normalized format” or a format convertible thereto, such as N4. Thus, for example, since a machine-readable semantic database is generated, the information processing system such as the virtual human resource O can improve the resolution of semantic expression.

Specifically, for example, the individual is represented by a definition of the data represented in a “semantically normalized format” or a format convertible thereto, such as a noun that can specify the individual, an adjective indicating state and attribute, and a verb indicating a state. Each of the plurality of individuals is classified into the concept and category. That is, the concept and category are represented by a definition of the data represented in a “semantically normalized format” or a format convertible thereto, including a noun that can specify the concept and category, and one or more individuals belonging thereto. These plurality of concepts and categories are grouped as necessary and classified into abstraction and category. That is, the abstraction and category are represented by a definition of the data represented in a “semantically normalized format” or a format convertible thereto, including a noun that can specify the abstraction and category, and one or more concepts and categories belonging thereto. The operation and thought are represented by a definition of the data represented in a “semantically normalized format” or a format convertible thereto, such as a verb that can specify the operation and thought. Then, the operation and thought are appropriately correlated with one or more individuals.

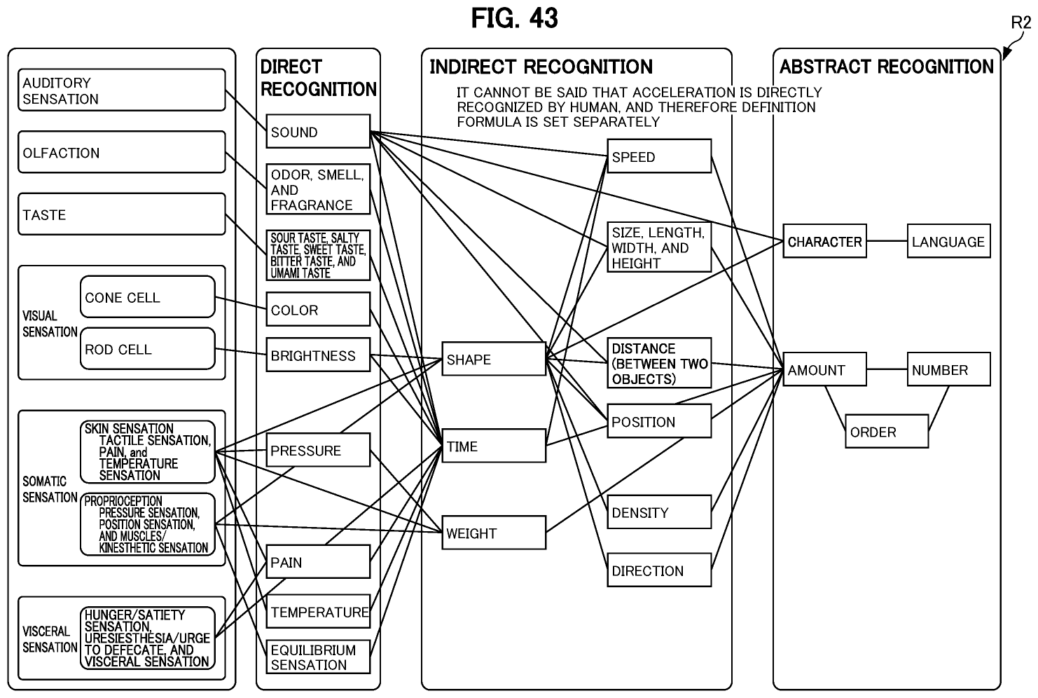

FIG. 43 is a diagram illustrating (2) sensor-based semantic decomposition. FIG. 43 illustrates a configuration example of (2) sensor-based semantic decomposition R2. A human recognizes things based on not only languages but also various perceptions of the human itself. Therefore, (2) sensor-based semantic decomposition R2 of FIG. 43 is applied so that the information processing system such as the virtual human resource O can recognize based on sensors corresponding to various perceptions of the human. Specifically, for example, as illustrated in (2) sensor-based semantic decomposition R2 of FIG. 43, the information processing system such as the virtual human resource O recognizes things that can be recognized based on a sensor as a unit, such as direct recognition that enables direct recognition based on its own special sensations, indirect recognition that enables recognition from the direct recognition, and abstract recognition that enables recognition from the indirect recognition. That is, in the PSF data PDP, basic units of recognition include ones that can be directly recognized by a sensor corresponding to a human sensation, ones that can be indirectly recognized from those, and ones that can be abstracted and recognized from those. This can capture the meaning in a finer unit than a case where an inter-class relationship such as a semantic sentence of the conventional dictionary or Wordnet is defined, and a case in which case frame information such as Framenet is summarized.

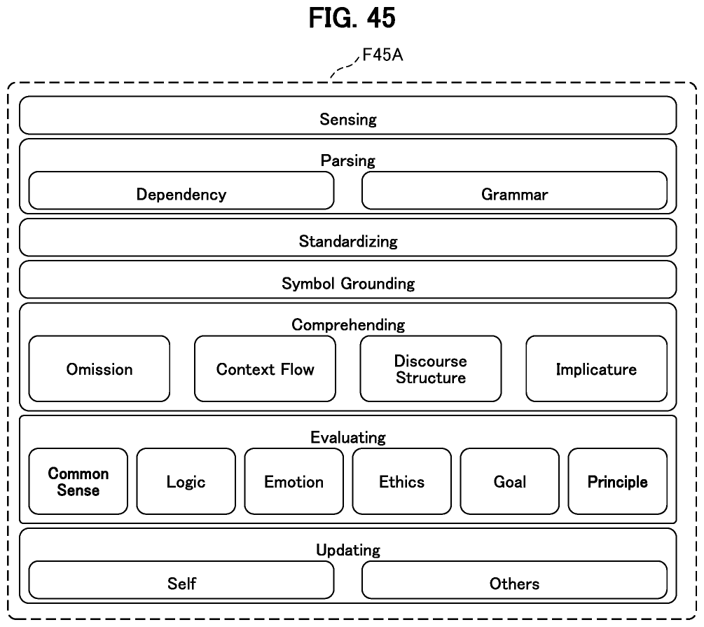

FIG. 44 is a diagram illustrating (3) context association. FIG. 45 is a split view of the diagram illustrating (3) context association illustrated in FIG. 44. Here, the context refers to data obtained by combining peripheral information about a recognition target with data represented in a “semantically normalized format” or a format convertible thereto. As illustrated in FIG. 44, as a range of the peripheral information to be normalized, for example, an arbitrary range is set, such as a word, a phrase, a discourse (node unit), a sentence unit, a unit of a plurality of sentences, an entire range that can be observed in the surroundings, an entire range including past experiences, and the like, for example. Here, the peripheral information itself may be represented in an arbitrary format such as a format in which the details are listed within the set range, or a format in which the details are tabulated in advance in an arbitrary unit. Then, the peripheral information of the range set as described above is combined with the data represented in a “semantically normalized format” or a format convertible thereto, whereby a predetermined context is obtained. Hereinafter, one thus organized for each context is referred to as “context association”. By utilizing such context association, for example, word sense disambiguation for determining in which sense a word is used and the identification accuracy of the theory applicable to solve the problem can be improved.

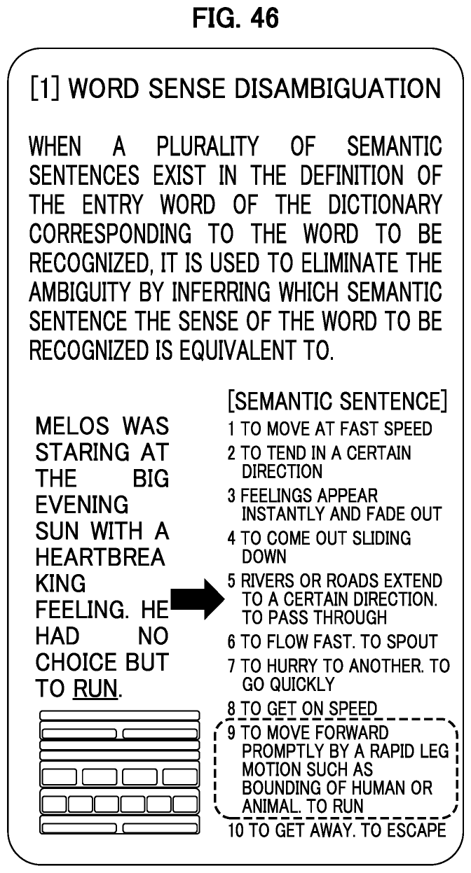

Next, with reference to FIGS. 46 to 50, an application example of the above-described context association will be described.

FIG. 46 is a diagram illustrating an application example of context association for word sense disambiguation. That is, even if a plurality of semantic sentences exist in the definition of the entry word of the dictionary corresponding to the word to be recognized, it is possible to infer in which sense a word to be recognized is used, according to the context. As a result, it is possible to eliminate the ambiguity by inferring which semantic sentence the sense of the word to be recognized is equivalent to. Specifically, for example, it is assumed that sentences “Melos was staring at the big evening sun with a heartbreaking feeling. He had no choice but to run.” are input. Here, regarding only the word “run”, the word has a plurality of first to tenth semantic sentences as illustrated in the figure. Even in such a case, based on the context corresponding to the above-described sentence, the word “run” to be recognized can be inferred to be equivalent to the sense of the ninth semantic sentence. In this way, it is possible to eliminate the ambiguity by inferring which semantic sentence the sense of the word to be recognized is equivalent to.

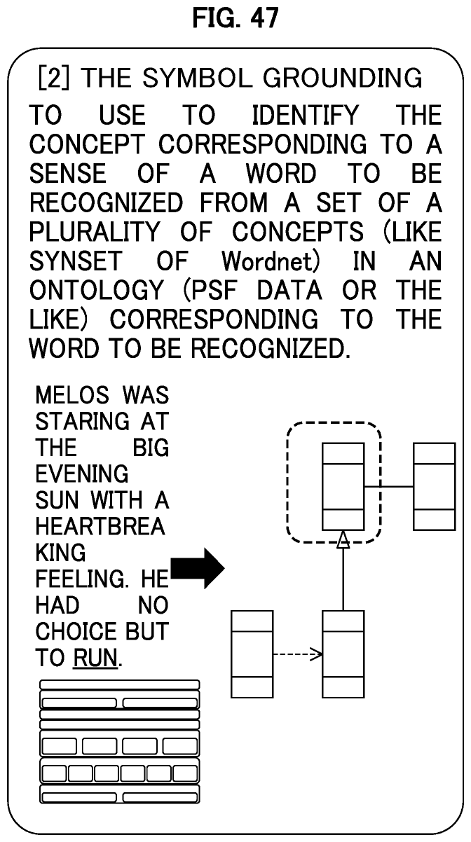

FIG. 47 is a diagram illustrating an application example of the context association for symbol grounding. That is, the concept corresponding to the sense of the word to be recognized (e.g., the concept surrounded by a broken line at the lower right in FIG. 47) can be identified from a set of a plurality of concepts (e.g., like synset of Wordnet) in an ontology (e.g., PSF data PDP) corresponding to the word to be recognized. Specifically, for example, it is assumed that sentences “Melos was staring at the big evening sun with a heartbreaking feeling. He had no choice but to run.” are input. However, in conventional technologies, the concept of the word “run” to be recognized cannot be identified only from such sentences. Even in such a case, for example, the concept surrounded by a broken line at the lower right in FIG. 47 can be identified as the concept corresponding to the sense of the word “run” to be recognized from a set of each concept connected by an arrow or a line at the lower right in FIG. 47.

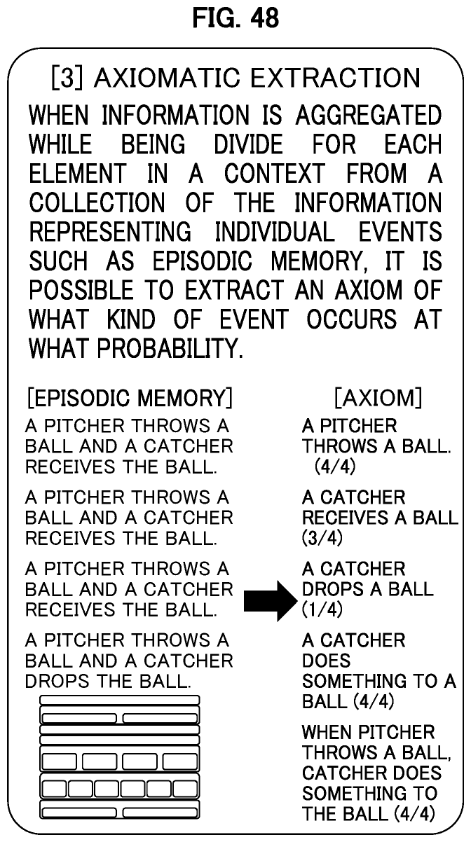

FIG. 48 is a diagram illustrating an application example of the context association for axiomatic extraction. That is, the information is aggregated while being divided for each element in the context from a collection of the information representing individual events such as episodic memory. This can extract an axiom of what kind of event occurs at what probability. Here, the episodic memory is a memory in which the information processed by the information processing system such as the virtual human resource O is accumulated by the data represented in a “semantically normalized format” or a format convertible thereto. Specifically, for example, it is assumed that the episodic memory illustrated in FIG. 48 is input in four patterns. The information is aggregated while being divided for each element in the context, based on the four patterns of episodic memory. Then, for example, an axiom can be extracted, such as “a pitcher throws a ball” at a probability of 4/4, “a catcher receives a ball” at a probability of 3/4, “a catcher drops a ball” at a probability of 1/4, “a catcher does something to the ball” at a probability of 4/4, and “when a pitcher throws a ball, a catcher does something to the ball” at a probability of 4/4.

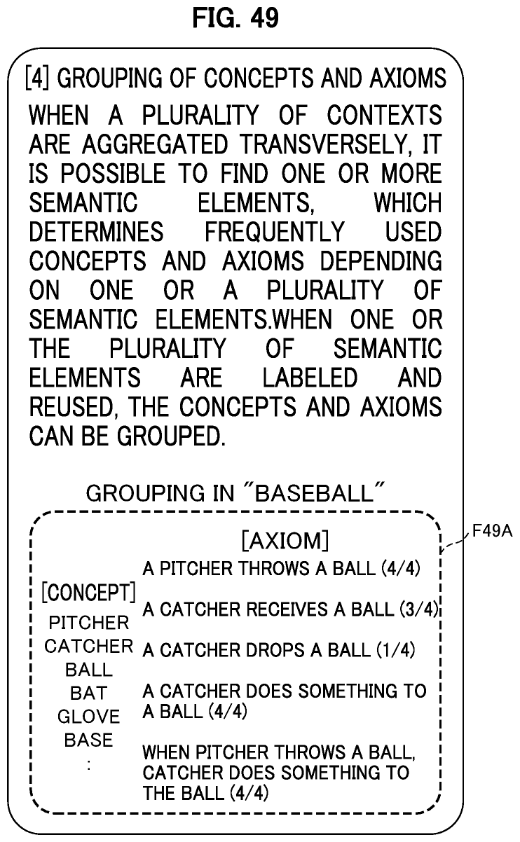

FIG. 49 is a diagram illustrating an application example of the context association for grouping of concepts and axioms. That is, when a plurality of contexts are aggregated transversely, it is possible to find one or more semantic elements, which determines whether frequently used concepts and axioms can be applied depending on one or more semantic elements. Furthermore, by labeling and reusing the one or more semantic elements, the concepts and axioms can be grouped. Specifically, for example when the episodic memory is accumulated as described in the example in FIG. 48, the plurality of contexts can be aggregated transversely. Thus, for example, as illustrated in FIG. 49, it is found that a concept such as a pitcher, a catcher, or the like, and an axiom in which a pitcher throws a ball relates to a semantic element of “baseball”. Furthermore, by labeling and reusing the semantic element “baseball”, it becomes possible to group concepts such as a pitcher, a catcher and the like and axioms in which a pitcher throws a ball.

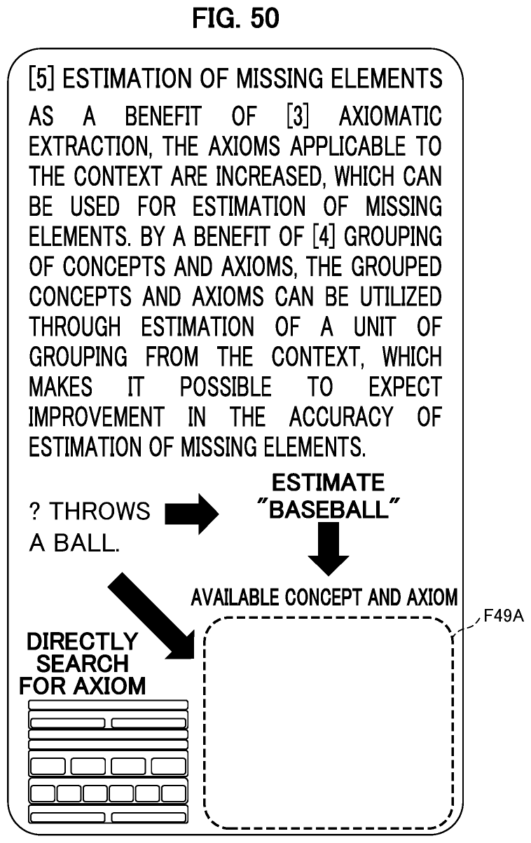

FIG. 50 is a diagram illustrating an application example of the context association for estimation of missing elements. That is, when the axioms are extracted as described in the example in FIG. 48, the axioms applicable to the context are accumulated. By utilizing such axioms, it is possible to estimate missing elements. When the concepts and axioms are grouped as described in the example in FIG. 49, the grouped concepts and axioms can be utilized through a unit of grouping estimated from the context. As a result, it is possible to expect improvement in the accuracy of estimation of missing elements. Specifically, for example, as illustrated in FIG. 50, a portion “00” in “00 throws a ball” is regarded as a missing element, which makes it possible to estimate “00” of the missing element by directly searching for the axioms, extracting the concept and axiom grouped in a unit of “baseball”, and utilizing the extracted axiom and concept.

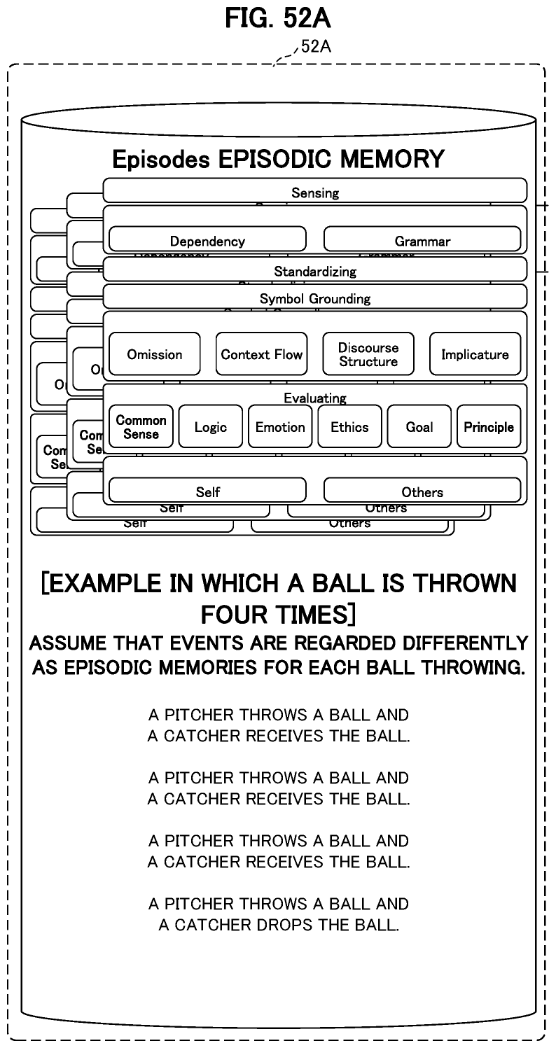

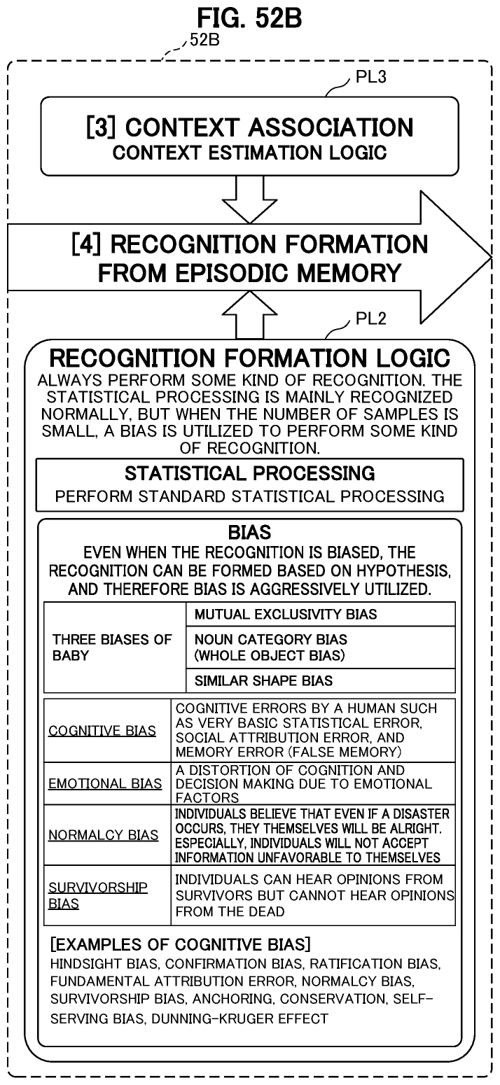

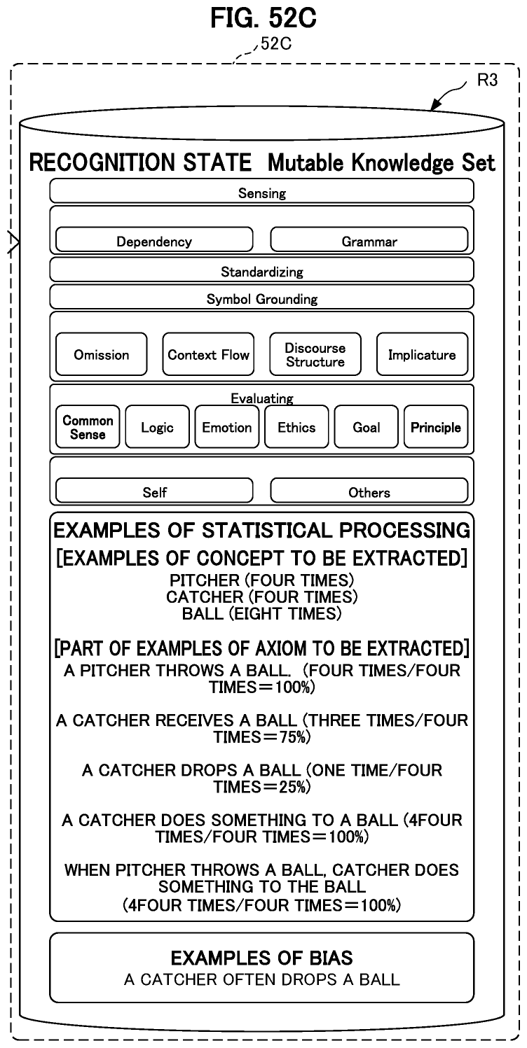

FIG. 51 is a diagram illustrating (4) a recognition formation from an episodic memory. FIGS. 52A to 52C each are a split view of the diagram illustrating (4) a recognition formation from an episodic memory illustrated in FIG. 51. FIG. 51 illustrates a configuration example of (4) a recognition formation R3 from an episodic memory. As described above, the episodic memory is a memory in which the information processed by the information processing system such as the virtual human resource O is accumulated by the data represented in a “semantically normalized format” or a format convertible thereto. By generating the context from such episodic memory (depending on the context association), the sense possessed by the information retained in the episodic memory is aggregated in various units (by the recognition formation logic). As a result, the concept and axiom are generated as the information representing “recognition state” in the PSF data PDP. That is, the recognition formation from the episodic memory can be achieved. Here, in the recognition formation logic PL2, when the sense of each information retained in the episodic memory is aggregated, the conventional statistical processing is also used as appropriate, but in particular, when the number of samples is small, a bias (heuristic method to yield a bias) can be centrally applied. Thus, the information processing system such as the virtual human resource O can always create a state in which some kind of recognition is performed on the input information.

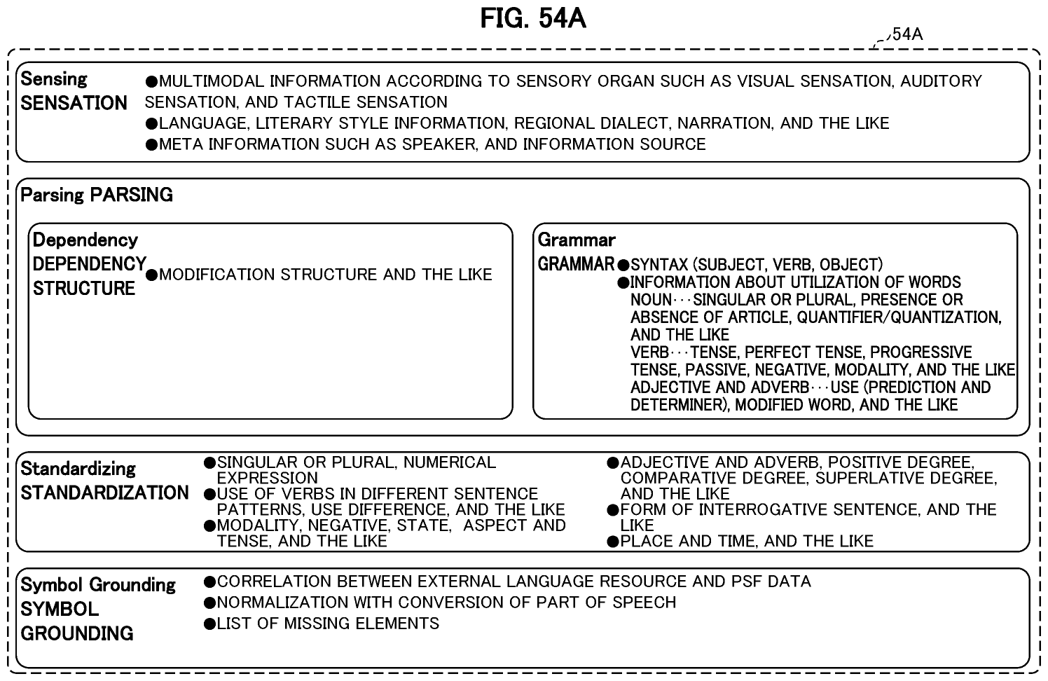

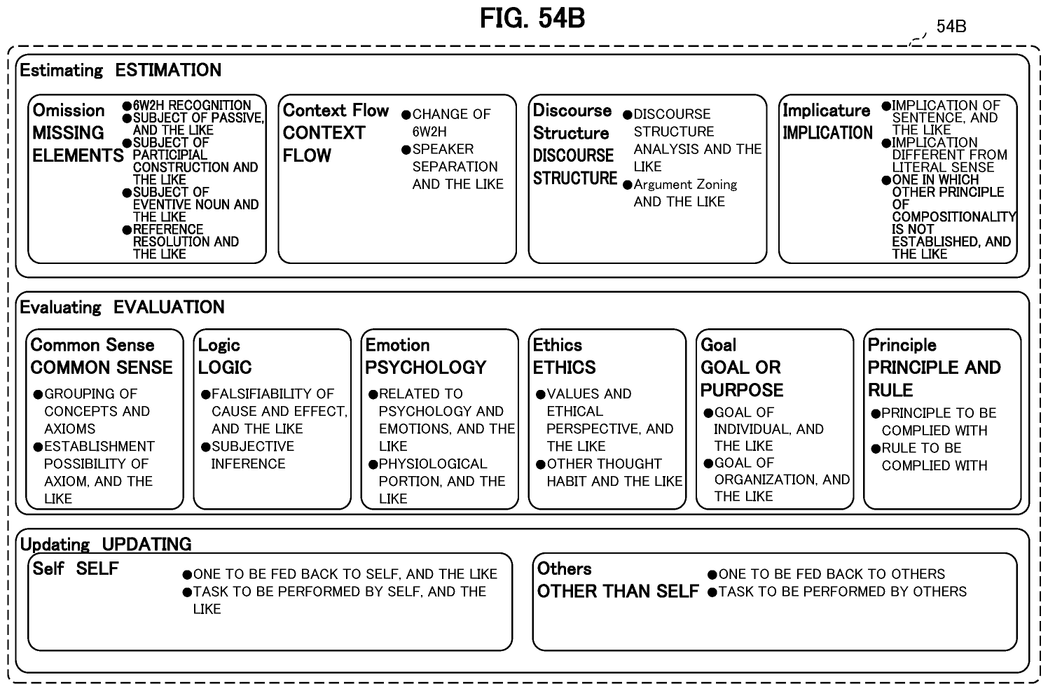

FIG. 53 is a diagram illustrating a specific example of the data represented in a “semantically normalized format” or a format convertible thereto, i.e., N4 (Neo non-loss normalized network). FIGS. 54A and 54B each are a split view of the diagram illustrating the data represented in a “semantically normalized format” or a format convertible thereto, i.e., N4 illustrated in FIG. 53. FIG. 53 illustrates a specific example R4 of N4 which is the data represented in a “semantically normalized format” or a format convertible thereto. Here, the term “semantically normalized” means that if it is regarded as the same sense in one aspect, a retention format of the information about the aspect is in a state in which there is a clear common portion in the retained contents. Specifically, for example, in a state in which N4 is layered as illustrated in the specific example R4, the corresponding information is retained in the machine-readable format of a simple level such as a key value format.

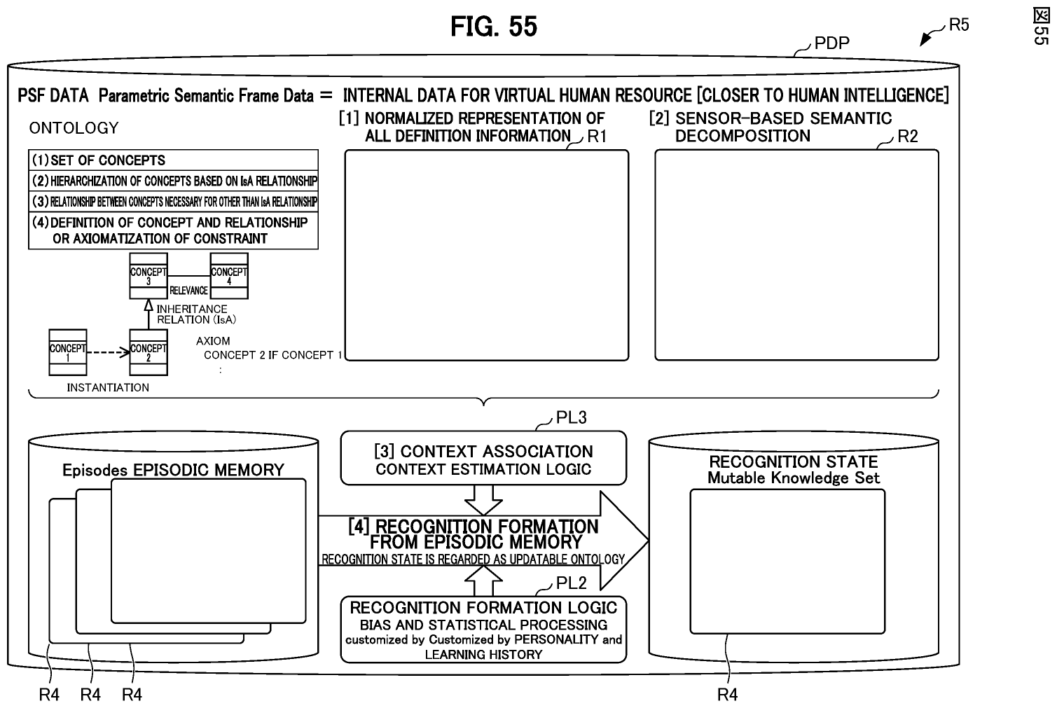

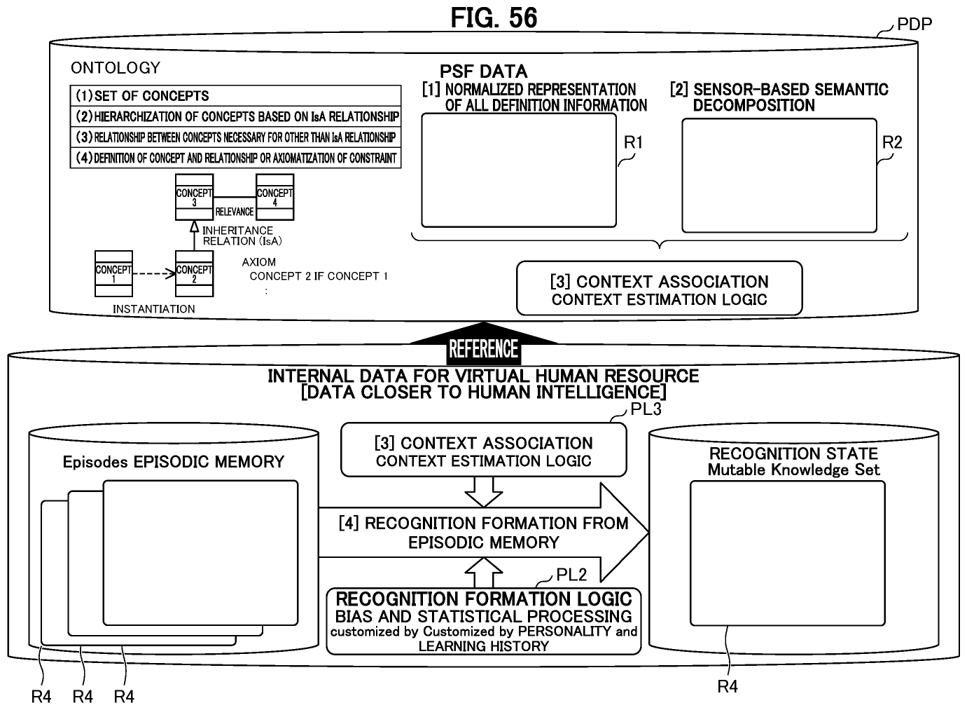

The PSF data PDP represented by N4 (the specific example R4) has a configuration as illustrated in FIGS. 55 and 56, for example.

FIG. 55 is a diagram illustrating a configuration example of PSF data PDP of a “dispersed and dynamic generation type” described above. FIG. 55 is a diagram illustrating a configuration example of the PSF data PDP R5 of the “dispersed and dynamic generation type”. The PSF data PDP of the “dispersed and dynamic generation type” (the configuration example R5) is constituted by combining (1) normalized representation of all definition information (see the configuration example of (1) normalized representation R1 of all definition information in FIG. 41), (2) sensor-based semantic decomposition (see the configuration example of (2) sensor-based semantic decomposition R2 in FIG. 43), (3) context association (see FIGS. 44 to 50), and (4) a recognition formation from an episodic memory (see FIG. 51) with respect to existing ontology. Note that the ontology is, for example, as follows. That is, ontology=case frame information (synset unit (e.g., Framenet) and entry word unit (e.g., KNP))+class relationship (e.g., Wordnet)+related axiom (e.g., SUMO)+class and instance relationship (e.g., YAGO).

FIG. 56 is a diagram illustrating a configuration of PSF data PDP of a “centralized and existing type”. The PSF data PDP of the “centralized and existing type” is constituted by combining (1) normalized representation of all definition information (see the configuration example of (1) normalized representation R1 of all definition information in FIG. 41), (2) sensor-based semantic decomposition (see the configuration example of (2) sensor-based semantic decomposition R2 in FIG. 43), and (3) context association (see FIGS. 44 to 50) with respect to existing ontology.

Next, with reference to FIGS. 57 to 52, the personalization summarization will be described.

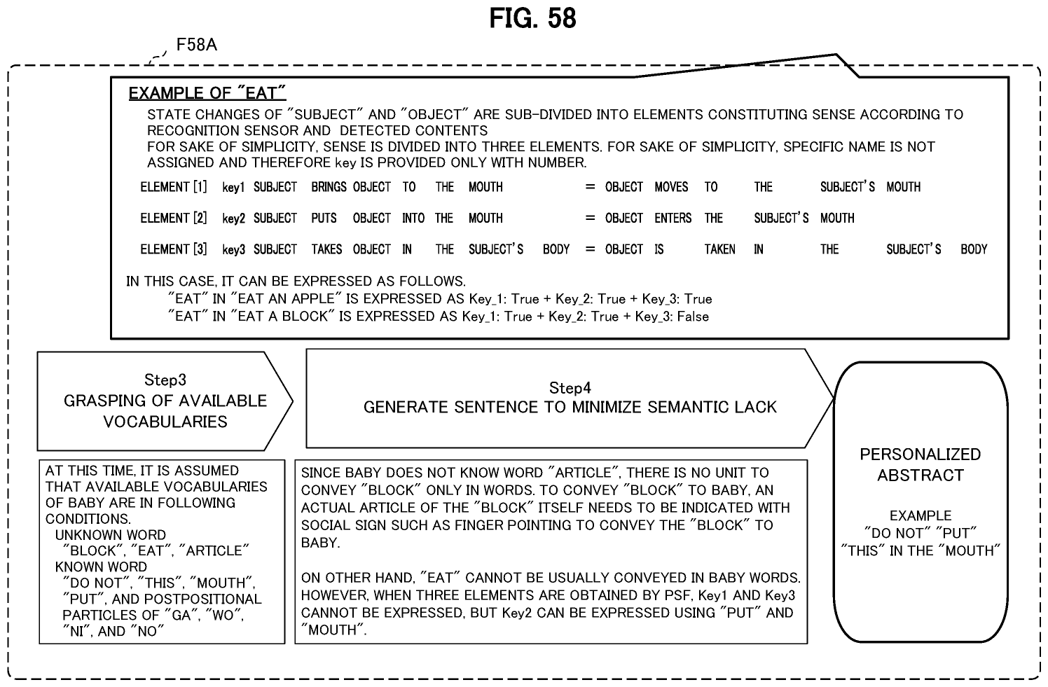

FIG. 57 is a diagram illustrating an overview of processing steps of the personalization summarization. FIG. 58 is a split view of the diagram illustrating an overview of processing steps of the personalization summarization illustrated in FIG. 57. FIG. 57 illustrates an example of the personalization summarization of a sentence such as “Do not eat the block” as the target sentence.

In Step 1, the target sentence is normalized. That is, the target sentence is represented in the definition in the data represented in a “semantically normalized format” or a format convertible thereto (see the specific example R4 of N4 which is the data represented in a “semantically normalized format” or a format convertible thereto in FIG. 53).

In Step 2, the PSF data PDP, i.e., the machine-readable semantic database having high resolution of semantic expression (see the configuration example of the PSF data PDR R5 of the “dispersed and dynamic generation type” in FIG. 55) is utilized with respect to the target sentence represented in a “semantically normalized format” or a format convertible thereto, such as N4. As a result, as illustrated in the example of “eat” in FIG. 57, the target sentence has machine-readable semantic expression with high resolution.

In step 3, the available vocabularies of the communication partner for the information processing system such as the virtual human resource O are grasped. Here, the available vocabularies of the partner can be predicted using demographic information such as age and sex and activity information such as school year, a major subject, and an occupation, and can be designated as a precondition. Specifically, for example, the case where the partner is an infant is as illustrated in FIG. 57.

In Step 4, a sentence having a minimum semantic lack is generated based on the target sentence having machine-readable semantic expression with high resolution in Step 2 and the result of Step 3. Specifically, for example, the case where the partner is an infant is as illustrated in FIG. 57. In this way, the processing of Steps 1 to 4 is performed on the target sentence, whereby generating a “personalized abstract”. For example, in the example in FIG. 57, the processing of Steps 1 to 4 is performed on the target sentence “Do not eat a block”, thereby generating a “personalized abstract” such as “Do not” “put” “this” “in the mouth”.

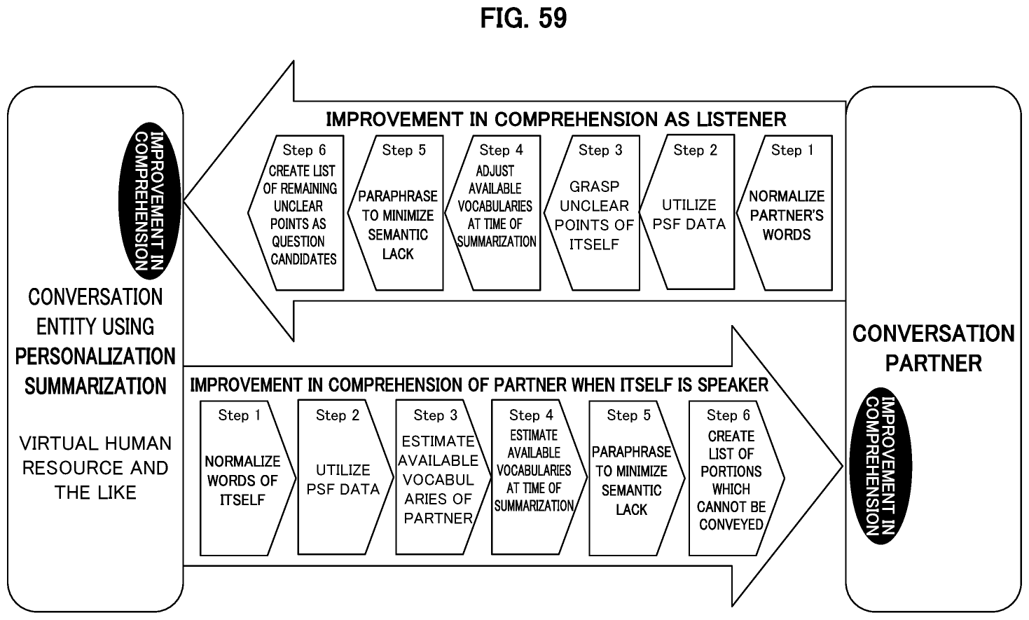

FIG. 59 is a diagram illustrating an effect of the personalization summarization. The personalization summarization has the following effects of the two aspects in the mutual communication between the information processing system such as the virtual human resource O and the partner. The effect of one aspect is “improvement in comprehension as a listener” of the information processing system such as the virtual human resource O. The effect of another aspect is “improvement in comprehension of the partner when itself is a speaker” of the information processing system such as the virtual human resource O. The effects of the two aspects can achieve deep mutual understanding between the information processing system such as the virtual human resource O and the partner. That is, the “improvement in comprehension as a listener” means that the information processing system such as the virtual human resource O paraphrases the words spoken by the partner using the vocabularies understood by itself in the case where many unknown words and unexplained portions are used when parsing the words spoken by the partner, whereby the comprehension of itself can be improved. The “improvement in comprehension of the partner when itself is a speaker” means that the information processing system such as the virtual human resource O infers available vocabularies to the partner based on the demographic information of the partner, and the information such as learning history and academic background, and limits originally available vocabularies to only simple vocabularies, to explain the contents to be conveyed to the partner only using the words known by the partner, whereby the comprehension of the partner can be improved. That is, the deep mutual understanding can be achieved between the conversation entity (the information processing system such as the virtual human resource O) and the partner using the personalization summarization by performing each processing illustrated in FIG. 59.

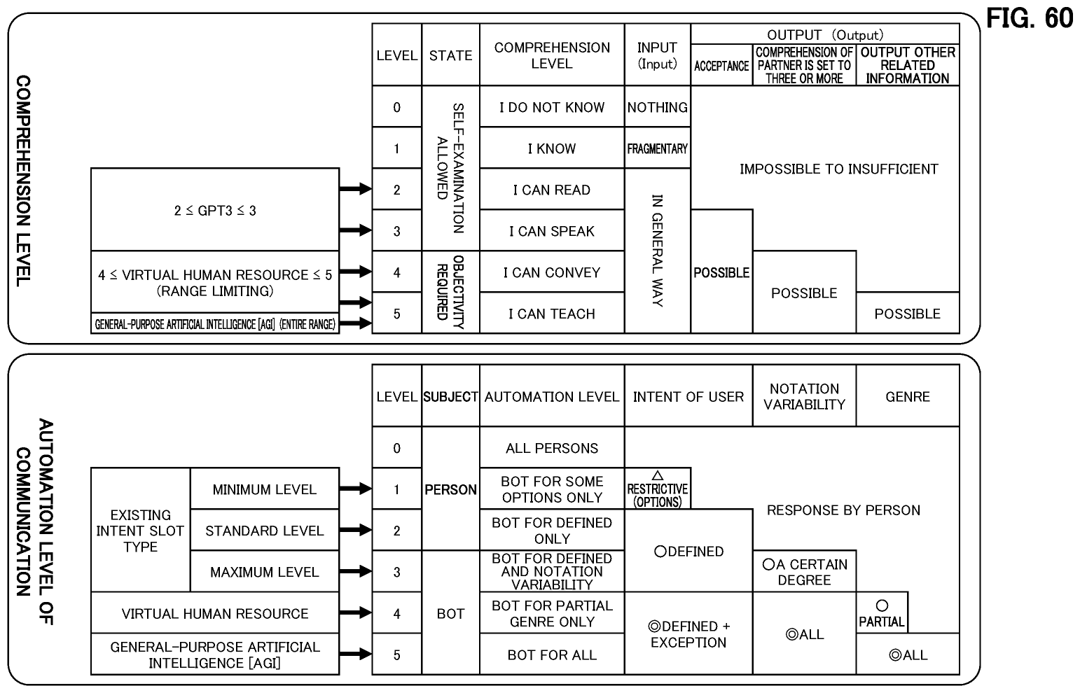

The effects of such personalization summarization can be obtained in the two aspects in the information processing system such as the virtual human resource O. FIG. 60 is a diagram illustrating the comprehension level achieved by the personalization summarization and the automation level of communication in the information processing system such as the virtual human resource O.

That is, the first aspect is the “comprehension level”. The level of achievement of the information processing system such as the virtual human resource O is within the range of 4 to 5 among the comprehension levels 0 to 5 illustrated in FIG. 60. However, at level 5, the range is limited to a specific range. Note that the level of general-purpose artificial intelligence is 5.

The second aspect is the “automation level of communication”. The level of achievement of the information processing system such as the virtual human resource O is 4 among the comprehension levels 0 to 5 illustrated in FIG. 60. Note that the level of general-purpose artificial intelligence is 5.

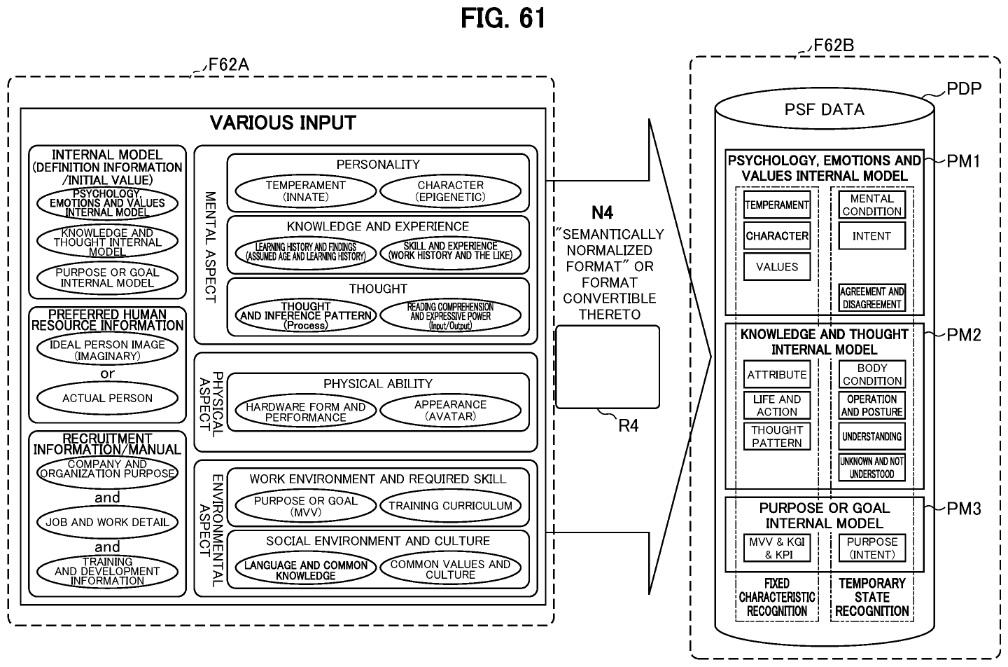

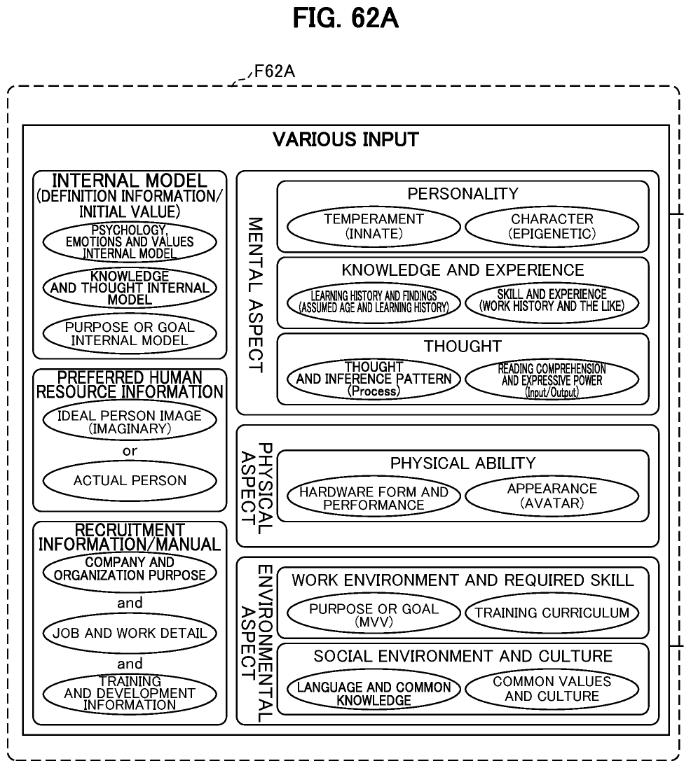

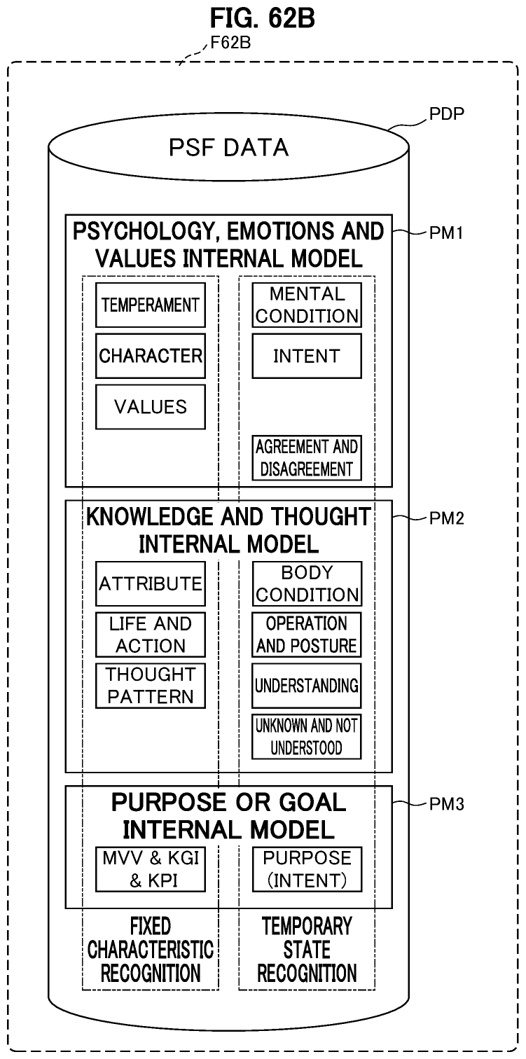

FIG. 61 is a diagram illustrating an overview of an internal model. FIGS. 62A and 62B each are a split view of the diagram illustrating an overview of an internal model illustrated in FIG. 61. The internal model PM is a series of modeled data group that are represented in a “semantically normalized format” or a format convertible thereto, such as N4 and stored in the machine-readable semantic database having high resolution of semantic expression, such as the PSF data PDP. As described above, for example, the internal model PM models the three pieces of information of the psychology, emotions, and values internal model PM1, the knowledge and thought internal model PM2, and the purpose or goal internal model PM3 in the semantically normalized format, and retains the modeled information. The psychology, emotions, and values internal model PM1 is human internal information including psychology, emotions, and values and has the characteristics in that these are used to behave as if these have personality according to the context. The knowledge and thought internal model PM2 is human internal intellectual activity and information including knowledge and thought, and has the characteristics in that these are managed in the comprehension level for each knowledge. The purpose or goal internal model PM3 is a purpose or goal including KGI and KPI with a human individual or an organization to which the human belongs serving as a unit, and has the characteristics in that these are prioritized and managed in plan and result. Each of such internal models is implemented as the PSF data PDP, and has the characteristics of (1) normalized representation of all definition information (see FIG. 41), (2) sensor-based semantic decomposition (see FIG. 43), (3) context association (see FIGS. 44 to 50), and (4) recognition from an episodic memory (see FIG. 51). It is assumed that the information is added and updated according to (4) a recognition formation from an episodic memory.

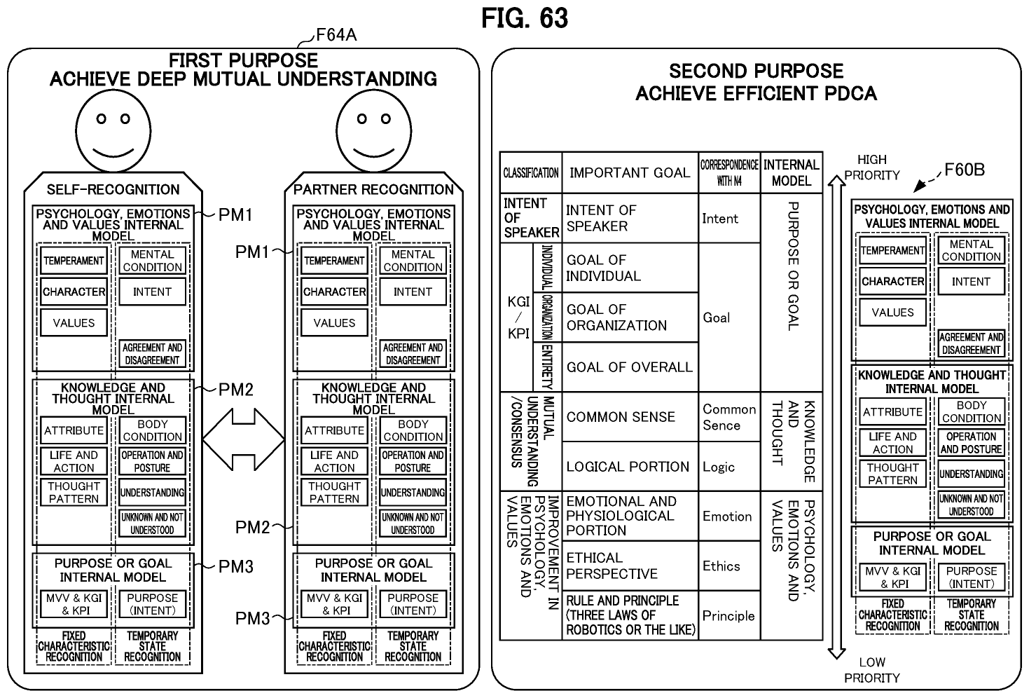

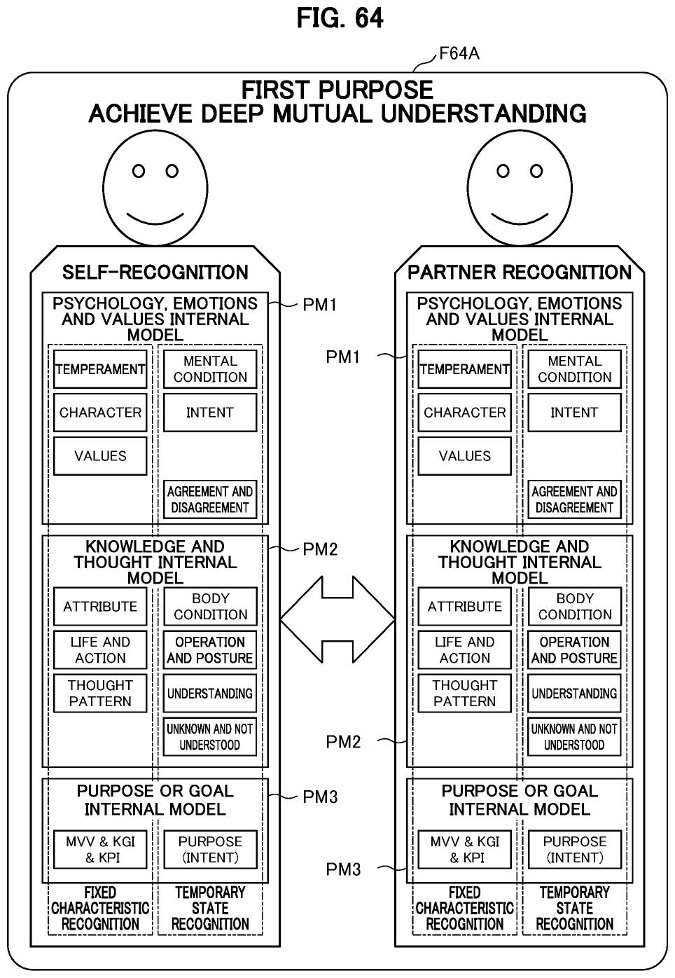

FIG. 63 is a diagram illustrating a purpose of the internal model. FIG. 64 is a split view of the diagram illustrating a purpose of the internal model illustrated in FIG. 63. The internal model PM has two major purposes. That is, the first purpose is to “achieve deep mutual understanding” between the information processing system such as the virtual human resource O and the partner. To accomplish the purpose, the information processing system such as the virtual human resource O always performs self-recognition and partner recognition using the internal model PM to increase the communication level of the partner. The second purpose is to “achieve an efficient PDCA”. To accomplish the purpose, the information processing system such as the virtual human resource O effectively solve a frame problem while maintaining a multilayered purpose using the internal model PM, and smooth the overall improvement cycle.

Although embodiments of the present invention have been described above, the present invention is not limited to the embodiments described above, and the present invention includes modification and improvement within a scope that enables the object of the present invention to be achieved.

The series of processes described above can be executed by hardware or software. In other words, the functional configurations in FIGS. 8 and 9 are merely examples, and the functional configurations are not limited to these examples. That is, it suffices if the information processing system and the virtual human resource have a function capable of executing the above-described series of processes as a whole, and which functional block is used to implement the function is not particularly limited to the examples of FIGS. 8 and 9. The locations of the functional block and database are not particularly limited to the examples of FIGS. 8 and 9, and may be arbitrary. For example, at least a part of the functional block and database necessary to execute each processing may be transferred to the client terminal 2, the dispatcher terminal 3, and the like. On the contrary, the functions of the client terminal 2 and dispatcher terminal 3 may be transferred to the server 1 and the like. One functional block may be made up of hardware alone or may be made up of software alone or may be made up of a combination of hardware and software.

For example, when a series of processes is executed by software, a program that makes up the software is installed from a network or a storage medium onto a computer or the like. The computer may be a computer incorporated in dedicated hardware. The computer may be a computer that is capable of executing various functions by installing various programs and may be, for example, a general-purpose smartphone, or a general-purpose personal computer, in addition to a server.

Furthermore, for example, the recording medium including such a program is not only configured by a removable medium (not illustrated) which is distributed separately from a device main body in order to provide the program to the user (a provider of the present service, a client, and a human resource dispatcher), but also configured by recording medium or the like which is provided to user in a state in which the recording medium is incorporated in the device main body in advance.

In the present specification, the step of describing the program recorded on the recording medium includes not only processing performed in time series along the order but also processing performed in parallel or individually, even though the processing is not necessarily performed in time series. In addition, in the present specification, the term “system” is intended to mean an overall device comprised of a plurality of devices, a plurality of units, and the like.

In other words, the information processing system and the virtual human resource to which the present invention is applied can take various embodiments having the following configurations.

That is, the information processing system to which the present invention is applied is
an information processing system that produces a virtual human resource (e.g., the virtual human resource O in FIG. 1) to be dispatched from a dispatcher (e.g., the human resource dispatcher P in FIG. 1) to a client (e.g., the client C in FIG. 1), the information processing system comprising an acquisition unit (e.g., the logic acquisition unit 523 in FIG. 8) configured to acquire, as dispatcher information, data including at least a personalization summarization logic (e.g., the personalization summarization logic PL1 in FIG. 2) from among information to be provided from the dispatcher, and a virtual human resource production unit (e.g., the virtual human resource production or updating unit 53 in FIG. 8) configured to produce a virtual human resource using the dispatcher information.
That is, the virtual human resource production unit produces the virtual human resource based on the data including at least the personalization summarization logic, and therefore produces the virtual human resource capable of performing a paraphrase according to the status of the partner (the comprehension, available vocabularies and the like). As a consequence, the communication having high mutual comprehension can be achieved between the virtual human resource and the partner in the client.

An information processing system that produces a virtual human resource (e.g., the virtual human resource O in FIG. 1) to be dispatched from a dispatcher (e.g., the human resource dispatcher P in FIG. 1) to a client (e.g., the client C in FIG. 1) comprises

an acquisition unit (e.g., the model acquisition unit 521 in FIG. 8) configured to acquire, as dispatcher information, data represented in a “semantically normalized format” or a format convertible thereto (e.g., a psychology, emotions, and values internal model PM1 in FIG. 2) from among information to be provided from the dispatcher, and
a virtual human resource production unit (e.g., the virtual human resource production or updating unit 53 in FIG. 8) configured to produce a virtual human resource using the dispatcher information.
That is, the virtual human resource production unit produces the virtual human resource O based on the data represented in a “semantically normalized format” or a format convertible thereto and therefore produces the virtual human resource enabling communication based on the “visualized” intelligence. As a consequence, the communication having high mutual comprehension can be achieved between the virtual human resource and the partner in the client.

Furthermore, an information processing system that produces a virtual human resource to be dispatched from a dispatcher (e.g., the human resource dispatcher P in FIG. 1) to a client (e.g., the client C in FIG. 1) comprises an acquisition unit configured to acquire, as dispatcher information, data represented in a “semantically normalized format” or a format convertible thereto, the data including at least a personalization summarization logic (e.g., the personalization summarization logic PL1 in FIG. 2) from among information to be provided from the dispatcher, and a virtual human resource production unit (e.g., the virtual human resource production or updating unit 53 in FIG. 8) configured to produce a virtual human resource using the dispatcher information.

This makes it possible to produce the virtual human resource capable of performing a paraphrase according to the status of the partner (the comprehension, available vocabularies and the like) and enabling communication based on the “visualized” intelligence. As a consequence, the virtual human resource can achieve the communication having higher mutual comprehension with the partner in the client.

An information processing system that produces a virtual human resource to be dispatched from a dispatcher to a client comprises

an acquisition unit configured to acquire, as dispatcher information, data (e.g., an internal model PM in FIG. 2) including at least a plurality of internal models, from among information to be provided from the dispatcher (e.g., the human resource dispatcher P in FIG. 1), and
a virtual human resource production unit (e.g., the virtual human resource production or updating unit 53 in FIG. 8) configured to produce a virtual human resource using the dispatcher information,
wherein
each of the plurality of internal models is produced based on one or more aspects of a first aspect related to human internal information including psychology, emotions, and
values, a second aspect related to human internal intellectual activity and information including knowledge and thought, and a third aspect related to a purpose or goal including KGI and KPI with a human individual or an organization to which the human belongs serving as a unit, and its internal relationship.

The plurality of internal models (e.g., the internal models PM in FIG. 2)

comprise, as the model produced based on the first aspect, a first model (e.g., a psychology, emotions, and values internal model PM1 in FIG. 2) that retains human internal information including psychology, emotions, and values, in which the relationship of the information is organized to be modeled in a “semantically normalized format” or a format convertible thereto,
comprise, as the model produced based on the second aspect, a second model (e.g., a knowledge and thought internal model PM2 in FIG. 2) that retains human internal intellectual activity and information including knowledge and thought, in which the relationship of the intellectual activity and information is organized to be modeled in a “semantically normalized format” or a format convertible thereto, and
comprise, as the model produced based on the third aspect, a third model (e.g., a purpose or goal internal model PM3 in FIG. 2), in which the purpose or goal including KGI and KPI with a human individual or an organization to which the human belongs serving as a unit, and its internal relationship are organized to be modeled in a “semantically normalized format” or a format convertible thereto.
That is, the virtual human resource production unit produces the virtual human resource O based on the plurality of internal models including the psychology, emotions, and values internal model, the knowledge and thought internal model, and purpose or goal internal model PM3, which makes it possible to produce the virtual human resource that can set a wide range of purposes by estimating not only emotions but also the values of the partner, the purpose or goal of the organization to which the partner belongs, and knowledge and thought pattern. The above-described internal models are retained, which makes it possible to produce the virtual human resource capable of offering continuous and stable response. As a consequence, a PDCA cycle can be efficiently executed.

A virtual human resource (e.g., the virtual human resource O in FIG. 1) to be dispatched from a dispatcher (e.g., the human resource dispatcher P in FIG. 1) to a client (e.g., the client C in FIG. 1)

is produced using, as the dispatcher information, data including at least a personalization summarization logic (e.g., the personalization summarization logic PL1 in FIG. 2) among information to be provided from the dispatcher, the virtual human resource comprising
a task execution unit (e.g., the task execution unit 83 in FIG. 9) configured to use the plurality of internal models (e.g., the internal models PM in FIG. 2) to enable a task instruction to be issued in a form of a message readable by a human, thereby executing a predetermined task while interacting with the human.
That is, the virtual human resource capable of performing a paraphrase according to the status of the partner (the comprehension, available vocabularies and the like) uses plurality of internal models to enable a task instruction to be issued in a form of a message readable by a human. As a consequence, the virtual human resource O can achieve the communication having high mutual comprehension with the partner in the client.

A virtual human resource (e.g., the virtual human resource O in FIG. 1) to be dispatched from a dispatcher (e.g., the human resource dispatcher P in FIG. 1) to a client (e.g., the client C in FIG. 1)

is produced using, as the dispatcher information, data represented in a “semantically normalized format” or a format convertible thereto among information to be provided from the dispatcher, the virtual human resource comprising
a task execution unit (e.g., the task execution unit 83 in FIG. 9) configured to use the plurality of internal models (e.g., the internal models PM in FIG. 2) to enable a task instruction to be issued in a form of a message readable by a human, thereby executing a predetermined task while interacting with the human.
That is, the virtual human resource enabling communication based on the “visualized” intelligence in all aspects uses the plurality of internal models to enable a task instruction to be issued in a form of a message readable by a human. As a consequence, the communication having high mutual comprehension can be achieved between the virtual human resource O and the partner in the client.

A virtual human resource (e.g., the virtual human resource O in FIG. 1) to be dispatched from a dispatcher (e.g., the human resource dispatcher P in FIG. 1) to a client (e.g., the client C in FIG. 1)

is produced using, as the dispatcher information, data represented in a “semantically normalized format” or a format convertible thereto, the data including at least a personalization summarization logic (e.g., the personalization summarization logic PL1 in FIG. 2) among information to be provided from the dispatcher, the virtual human resource comprising
a task execution unit (e.g., the task execution unit 83 in FIG. 9) configured to use the plurality of internal models (e.g., the internal models PM in FIG. 2) to enable a task instruction to be issued in a form of a message readable by a human, thereby executing a predetermined task while interacting with the human.
That is, the virtual human resource can perform a paraphrase according to the status of the partner (the comprehension, available vocabularies and the like), and enables communication based on the “visualized” intelligence, which makes it possible to achieve the communication having high mutual comprehension with the partner in the client.

A virtual human resource (e.g., the virtual human resource O in FIG. 1) to be dispatched from a dispatcher (e.g., the human resource dispatcher P in FIG. 1) to a client (e.g., the client C in FIG. 1)

is produced using, as dispatcher information, data (e.g., an internal model PM in FIG. 2) including at least a plurality of internal models among information to be provided from the dispatcher,
wherein each of the plurality of internal models (e.g., an internal model PM in FIG. 2) is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship, and the virtual human resource comprises a task execution unit (e.g., the task execution unit 83 in FIG. 9) configured to set up a plan using a model produced based on the third aspect while involving self-recognition and partner recognition using models produced based on the first aspect and the second aspect (e.g., Plan in FIG. 10), execute a predetermined task while interacting with a human to achieve the plan (e.g., Do in FIG. 10), evaluate the result of the execution (e.g., Check in FIG. 10), and perform improvement based on the result of the evaluation (e.g., Action in FIG. 10).

The plurality of internal models (e.g., the internal models PM in FIG. 2)

comprises, as the model produced based on the first aspect, a first model (e.g., a psychology, emotions, and values internal model PM1 in FIG. 2) that retains human internal information including psychology, emotions, and values, in which the relationship of the information is organized to be modeled in a “semantically normalized format” or a format convertible thereto,
comprises, as the model produced based on the second aspect, a second model (e.g., a knowledge and thought internal model PM2 in FIG. 2) that retains human internal intellectual activity and information including knowledge and thought, in which the relationship of the intellectual activity and information is organized to be modeled in a “semantically normalized format” or a format convertible thereto, and
comprises, as the model produced based on the third aspect, a third model (e.g., a purpose or goal internal model PM3 in FIG. 2), in which the purpose or goal including KGI and KPI with a human individual or an organization to which the human belongs serving as a unit, and its internal relationship are organized to be modeled in a “semantically normalized format” or a format convertible thereto.
That is, since the virtual human resource capable of estimating the values of the partner, the purpose or goal of the organization to which the partner belongs, and knowledge and thought pattern can set a wide range of purposes in multiple layers, a frame problem can be avoided, and since it is possible to offer continuous and stable response to the partner in the client, high level of response can be offered. As a consequence, the virtual human resource can efficiently execute the PDCA cycle.

### EXPLANATION OF REFERENCE NUMERALS

1 . . . server, 2 . . . client terminal, 3 . . . dispatcher terminal, 51 . . . client information acquisition unit, 52 . . . human resource dispatcher information acquisition unit, 53 . . . virtual human resource production or updating unit, 54 . . . virtual human resource dispatch unit, 61 . . . virtual human resource DB, 81 . . . environment setting unit, 82 . . . training unit, 83 . . . task execution unit, 511 . . . preferred human resource information acquisition unit, 512 . . . usage form information acquisition unit, 513 . . . recruitment information/manual information acquisition unit, 521 . . . model acquisition unit 522, data acquisition unit, 523 . . . logic acquisition unit, 821 . . . knowledge category dependent training unit, 822 . . . inter-human resource information sharing unit, 831 . . . objective interpretation unit, 832 . . . subjective interpretation unit, 833 . . . generation unit, 834 . . . task instruction unit, 851 . . . semantic parsing unit, 852 . . . semantic estimation unit, 853 . . . semantic evaluation unit, 854 . . . state updating unit, 855 . . . utterance continuity control unit, 856 . . . utterance contents generation unit, 857 . . . utterance unit, 858 . . . task instruction unit, 862 . . . state updating unit, 881 . . . actuator activation unit, 882 . . . external API activation unit, 883 . . . company registration API (simple type) activation unit, 884 . . . company registration API (registered RPA type) activation unit, 885 . . . specialized staff type activation unit, 886 . . . crowdsourcing type activation unit, 887 . . . auction type activation unit

1. An information processing system that produces a virtual human resource to be dispatched from a dispatcher to a client, the system comprising:
an acquisition unit configured to acquire, as dispatcher information, data including at least a personalization summarization logic from among information to be provided from the dispatcher; and
a virtual human resource production unit configured to produce a virtual human resource using the dispatcher information.

2. An information processing system that produces a virtual human resource to be dispatched from a dispatcher to a client, the system comprising:
an acquisition unit configured to acquire, as dispatcher information, data represented in a “semantically normalized format” or a format convertible thereto from among information to be provided from the dispatcher; and
a virtual human resource production unit configured to produce a virtual human resource using the dispatcher information.

3. An information processing system that produces a virtual human resource to be dispatched from a dispatcher to a client, the system comprising:
an acquisition unit configured to acquire, as dispatcher information, data represented in a “semantically normalized format” or a format convertible thereto, the data including at least a personalization summarization logic from among information to be provided from the dispatcher; and
a virtual human resource production unit configured to produce a virtual human resource using the dispatcher information.

4. An information processing system that produces a virtual human resource to be dispatched from a dispatcher to a client, the system comprising:
an acquisition unit configured to acquire, as dispatcher information, data including at least a single or a plurality of internal models, from among information to be provided from the dispatcher; and
a virtual human resource production unit configured to produce a virtual human resource using the dispatcher information,
wherein each of the plurality of internal models is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship.

5. The information processing system according to claim 4, wherein
the single or the plurality of internal models
comprise, as the model produced based on the first aspect, a first model that retains human internal information including psychology, emotions, and values, in which the relationship of the information is organized to be modeled in a “semantically normalized format” or a format convertible thereto,
comprise as the model produced based on the second aspect, a second model that retains human internal intellectual activity and information including knowledge and thought, in which the relationship of the intellectual activity and information is organized to be modeled in a “semantically normalized format” or a format convertible thereto, and
comprises, as the model produced based on the third aspect, a third model in which the purpose or goal including KGI and KPI with a human individual or an organization to which the human belongs serving as a unit, and its internal relationship are organized to be modeled in a “semantically normalized format” or a format convertible thereto.

6. A virtual human resource to be dispatched from a dispatcher to a client that is produced using, as dispatcher information, data including at least a personalization summarization logic among information to be provided from the dispatcher, the virtual human resource comprising:
a task execution unit configured to use the plurality of internal models to enable a task instruction to be issued in a form of a message readable by a human, thereby executing a predetermined task while interacting with the human.

7. A virtual human resource to be dispatched from a dispatcher to a client that is produced using, as dispatcher information, data represented in a “semantically normalized format” or a format convertible thereto among information to be provided from the dispatcher, the virtual human resource comprising:
a task execution unit configured to use the plurality of internal models to enable a task instruction to be issued in a form of a message readable by a human, thereby executing a predetermined task while interacting with the human.

8. A virtual human resource to be dispatched from a dispatcher to a client that is produced using, as dispatcher information, data represented in a “semantically normalized format” or a format convertible thereto, the data including at least a personalization summarization logic among information to be provided from the dispatcher, the virtual human resource comprising:
a task execution unit configured to use the plurality of internal models to enable a task instruction to be issued in a form of a message readable by a human, thereby executing a predetermined task while interacting with the human.

9. A virtual human resource to be dispatched from a dispatcher to a client that is produced using, as dispatcher information, data including at least a single or a plurality of internal models among information to be provided from the dispatcher,
wherein each of the single or the plurality of internal models is produced based on one or more aspects of a first aspect related to human internal information including psychology, emotions, and values, a second aspect related to human internal intellectual activity and information including knowledge and thought, and a third aspect related to a purpose or goal including KGI and KPI with a human individual or an organization to which the human belongs serving as a unit, and its internal relationship, and
the virtual human resource comprises a task execution unit configured to set up a plan using a model produced based on the third aspect while involving self-recognition and partner recognition using models produced based on the first aspect and the second aspect, execute a predetermined task while interacting with a human to achieve the plan, evaluate the result of the execution, and perform improvement based on the result of the evaluation.

10. The virtual human resource according to claim 9, wherein the single of the plurality of internal models
comprise, as the model produced based on the first aspect, a first model that retains human internal information including psychology, emotions, and values, in which the relationship of the information is organized to be modeled in a “semantically normalized format” or a format convertible thereto,
comprise, as the model produced based on the second aspect, a second model that retains human internal intellectual activity and information including knowledge and thought, in which the relationship of the intellectual activity and information is organized to be modeled in a “semantically normalized format” or a format convertible thereto, and
comprise, as the model produced based on the third aspect, a third model, in which the purpose or goal including KGI and KPI with a human individual or an organization to which the human belongs serving as a unit, and its internal relationship are organized to be modeled in a “semantically normalized format” or a format convertible thereto.
